(19) United States
(12) Patent Application Publication
(10) Pub. No.: US 2005/0096124 A1
(43) Pub. Date: May 5, 2005

(54) Parimutuel wagering system with opaque transactions

(75) Inventor: Andrew Stronach, Aurora (CA)

Correspondence Address: Mark A. Litman & Associates, P.A.;York Business Center, Suite 205, 3209 West 76th St., Edina, MN, 55435, US

(73) Assignee: ASIP Holdings, Inc.

(21) Appl. No.: 10/958,192

(22) Filed: Oct. 4, 2004

Related U.S. Application Data
(63) Continuation-in-part of application No. 10/761,799, filed on Jan. 21, 2004.
(60) Provisional application No. 60/441,714, filed on Jan. 21, 2003.

(51) Int. Cl. A63F 13/00

(52) U.S. Cl. 463/25

(57) ABSTRACT

A seamless ledger-based wagering system is provided wherein a secure, flexible and automated database method and apparatus is used for retrieving information and accounting for wagers in an electronic wagering format. The accounting system can be a ledger wherein funds are accounted for by a financial structure (e.g., financial institution such as a bank, credit union, savings and loan, deposit account, and the like) so that funds may be transferred through an intermediate transaction (e.g., the electronic wager entered onto the account) on the ledger and committed to payment at the ultimate target of the transfer (e.g., the pari-mutuel site, and ancillary recipients of wagering monies, such as horseman's associations, totalisator companies, automated machine lessors, track association, governmental agencies and the like). As the financial records from the financial structure never ‘sees’ the wagering facility in the transaction, transferring funds or guaranteeing funds to the intermediate transaction on a ledger, the entire transaction is in compliance with state and national regulations prohibiting or limiting or rendering illegal the availability of funds in the wagering transaction or transferring funds into a wagering account.

### RELATED APPLICATIONS DATA

This application is a continuation-in-part of U.S. patent application Ser. No. 10/761,799, filed Jan. 21, 2004, which claims priority from U.S. Provisional Application Ser. No. 60/441,714, filed Jan. 21, 2003.

### BACKGROUND OF THE INVENTION

1. Field of the Invention

The present invention relates to the field of wagering, including pari-mutuel wagering on race events, and the accounting of and providing funds directly for wagering events through an on-line wagering system.

2. Background of the Art

Wagering on race events, such as horse races and dog races, typically takes the form of either fixed odds wagering or the more common pari-mutuel wagering. Fixed odds wagering is a system by which the return for a particular wager is determined in accordance with the payout odds assigned to the associated bet. Fixed odds wagering is popular from the perspective of wager recipients (e.g., betting parlors) since it places a limit on the magnitude of the payout in the event of a win. Fixed odds wagering is also popular from the perspective of players since it provides a measure of certainty on the possible payout.

Pari-mutuel wagering is a system by which a wagering pool is established for the receipt of bets, and the proceeds of the pool are divided amongst holders of winning wagers in accordance with the number and types of winning wagers and the magnitude of each wager. Pari-mutuel wagering is popular from the perspective of the wager recipients (e.g., race track owners), since the recipient typically receives a fixed percentage of the pool prior to the payout to the winning wager holders. Also, pari-mutuel wagering is popular from the perspective of the person making the wager since the return on a particular wager is proportional to the size of the wagering pool and, therefore, can exceed the fixed odds return of the bet. However, pari-mutuel wagering also suffers from a number of disadvantages.

Firstly, pari-mutuel wagering often requires detailed knowledge of betting terminology (e.g., win, place, show, exacta, triacta, etc. wager types). Secondly, pari-mutuel wagering often requires the wager placer (wageror) to be conversant with betting forms, and to have knowledge of race contestant handicapping. For example, for horse racing, successful handicapping requires a consideration of several factors, including track conditions, horse record, and jockey record for each contestant horse.

Consequently, pari-mutuel wagering may not provide wager recipients with a significant return since novices may be intimidated by the knowledge required and either make only minimal wagers or no wagers at all.

Therefore, attempts have been made to improve on the conventional pari-mutuel wagering systems to encourage wagering. For instance, AmTote International, Inc. markets video terminals which remove the need for a player to interact with a human wager recipient. The video terminal consists of a touch-sensitive CRT display, a card reader, and a central processing unit in communication with the CRT display, the card reader and a remote wagering computer for processing desired wagers. To place a wager, the player purchases a wager card, inserts the wager card into the card reader, and then selects the desired track, the desired horse(s), the wager type (e.g., win, place, show, exacta, triacta, etc.), and the amount of the wager. Although the video terminal allows the novice to conceal to a very limited extent his/her lack of familiarity with betting terminology and handicapping, it does little to encourage the novice to make wagers. Additionally, it would be desirable and enhance entertainment for advanced players.

U.S. patent application Ser. No. 09/997,288, filed Nov. 30, 2001, which application is incorporated herein by reference in its entirety, describes an automated wagering terminal that places wagers on pari-mutuel events based on handicapping algorithms and analysis of handicapping data and odds data (e.g., published odds data, track odds data, etc.). That system is quite efficient, but it would be desirable to provide a mechanism for attracting players to the use of the terminals to increase the operation utilization of the automated terminal.

In addition to the complexities of the wagering structures themselves, wagering, and particularly pari-mutuel wagering is a highly regulated industry, and there are many legal requirements, legal restrictions, and local and national laws and regulations that govern the implementation of wagering. With on-line wagering and automated OTB wagering available, additional complexities are provided. Credit card and cash card companies may have restrictions on the direct charging into accounts in race facilities, and may prevent the transfer of funds from a credit card to a wagering account. This is one of the reasons that automated teller machines (ATM's) are prominent in some wagering facilities. Players may use their credit cards or cash cards in an ATM, withdraw the cash, and then make direct wagers or place the funds directly into their accounts. This can be an inconvenient method, with time consumed that may cause a player to miss races and force the player to physically carry sums of cash from the ATM to a betting window.

A novel wagering format will be introduced by the inventors that uses live employees carrying data transmitting systems (PDA, telephones, wired systems, wireless systems, Blackberries™, laptops, etc.) through which contacts with wagering facilities can be established and wagers assisted or placed from legal wagering facilities. It would be particularly inconvenient to attempt to transfer funds for wagering through such a system or have the employee responsible for carrying cash wagers. A system for placing the wagers is needed to assist in this limiting characteristic of wagering structures.

### SUMMARY OF THE INVENTION

A seamless ledger-based wagering system is provided wherein a secure, flexible and automated database method and apparatus is used for retrieving information and accounting for wagers in an electronic wagering format. The accounting system can be a ledger wherein funds are accounted for by a financial structure (e.g., financial institution such as a bank, credit union, savings and loan, deposit account, and the like) so that funds may be transferred through an intermediate transaction (e.g., the electronic wager entered onto the account) on the ledger and committed to payment at the ultimate target of the transfer (e.g., the pari-mutuel site, and ancillary recipients of wagering monies, such as horseman's associations, totalisator companies, automated machine lessors, track association, governmental agencies and the like). As the financial records from the financial structure never ‘sees’ the wagering facility in the transaction, transferring funds or guaranteeing funds to the intermediate transaction on a ledger, the entire transaction is in compliance with state and national regulations prohibiting or limiting or rendering illegal the availability of funds in the wagering transaction or transferring funds into a wagering account.

### BRIEF DESCRIPTION OF THE FIGURES

FIG. 1 shows a combination general block, functional and flow diagram of a preferred embodiment of overall structure means and working methods of a payment system in accordance with the teachings of the present disclosed technology.

FIG. 2a shows a flowchart of a preferred embodiment of an overall process from tracing key creation to payment transaction in accordance with the teachings of the present disclosed technology.

FIG. 2b shows a flowchart of a preferred embodiment of exemplary means and methods whereby payment data flows from the payer through a network of operatives and may ultimately reach the issuer, all in accordance with the teachings of the present disclosed technology.

FIG. 2c shows a flowchart of a preferred exemplary means and methods whereby tracing is conducted and optionally trustees are kept from knowing from where and/or to where they are tracing, in accordance with the teachings of the present disclosed technology.

FIG. 2d shows a flowchart of a preferred exemplary means and methods whereby trustees allow tracing from an account identifier to actual payment transactions, in accordance with the teachings of the present disclosed technology.

FIG. 2e shows a flowchart of a preferred exemplary means and methods whereby a payer can obtain an identity from a group of identities that can be traced by a trustee, in accordance with the teachings of the present disclosed technology.

FIG. 2f shows a flowchart of a preferred exemplary means and methods whereby computational difficulty of tracing can be increased and tracing can be conducted accordingly, in accordance with the teachings of the present disclosed technology.

FIG. 2g shows a flowchart of a preferred exemplary means and methods whereby a secret seed is used to develop the parameters needed to protect unlinkability and can later be used to allow tracing of those values, in accordance with the teachings of the present disclosed technology.

FIG. 3 shows a flowchart of a preferred embodiment of a cut-and-choose protocol performed between parties denoted bank B and payer P in accordance with the teachings of the present disclosed technology.

FIG. 4a shows a flowchart of a first preferred exemplary embodiment of both a form of money and a blinded, two-trustee protocol for tracing without the trustees learning either what was traced or who it was traced to, in accordance with the teachings of the present disclosed technology.

FIG. 4b shows a flowchart of a first preferred exemplary embodiment of an alternate form of money and a single trustee, as well as an unblinded form of a tracing protocol, all in accordance with the teachings of the present disclosed technology.

FIG. 4c shows a flowchart of a first preferred exemplary embodiment of a system for convincing a payer P that a particular set of linking information is merely a permuted copy of a list developed by the trustee(s), thereby allowing a payer substantial certainty that they are linkable to an entry on the list, but substantially inability to determine which entry on the original list they are linked to, all in accordance with the teachings of the present disclosed technology.

FIG. 4d shows a flowchart of a first preferred exemplary embodiment of a system for allowing blacklisting information to be developed with knowledge of the payer account, in accordance with the teachings of the present disclosed technology.

FIG. 4e shows a flowchart of a first preferred exemplary embodiment of a system for making the work required to trace substantially as high as desired, in accordance with the teachings of the present disclosed technology.

FIG. 4f shows a flowchart of a first preferred exemplary embodiment of a system for restricting the blinding factor and also another use of the truncation function just described, both in accordance with the teachings of the present disclosed technology.

FIG. 4g shows a flowchart of a first preferred exemplary embodiment of another example of the choice of a blinding factor from a limited range corresponding to certain limited values, in accordance with the teachings of the present.

FIG. 5 shows a flowchart of a preferred embodiment of an add-record process in accordance with the teachings of the present disclosed technology, involving actions by an update terminal, a mapper, and multiple partial-databases (all of FIG. 3), which is believed to store data fragmented so that the mapper can control the access thereto, and the query terminal can perform query processes similar to the query process of FIG. 7 to retrieve (parts of) the stored information.

FIG. 6 is a block diagram showing data-objects constructed, sent, received, processed, and/or stored by the apparatus of FIG. 3 in the query process of FIG. 7, in accordance with the teachings of the present disclosed technology.

FIG. 7 shows a flowchart of a preferred embodiment of an exemplary query process in accordance with the teachings of the present disclosed technology, involving actions by an update terminal, a mapper, and two partial-databases (all of FIG. 3), which is believed to allow retrieval of information stored in the system by means of the add-record process of FIG. 5.

FIG. 8 shows a combination block and functional diagram of a preferred embodiment of a so-called mapping cascade, in accordance with the teachings of the present disclosed technology, which is believed to enhance the privacy and security offered by a system such as FIG. 17, when it replaces the mapper in that system.

FIG. 9 shows a combination block and functional diagram of a second preferred embodiment of a database system, in particular a so-called dossier-system, involving five single apparatus and one group of apparatus in accordance with the teachings of the present disclosed technology.

FIG. 10 is a block diagram showing data-objects constructed, sent, received, processed, and/or stored by the apparatus of FIG. 9 in the link-dossier operation of FIG. 11, the update-dossier operation of FIG. 12 and the query-dossier operation of FIG. 13, in accordance with the teachings of the present disclosed technology.

FIG. 11 shows a flowchart of a preferred embodiment of a link-dossier operation in accordance with the teachings of the present disclosed technology, involving actions by a local terminal, a grouper, a mapper A and a matcher (all of FIG. 9), which is believed to link an individual to his/her dossier stored in the system and supply the local terminal with a pseudonym for this individual that is used to refer to his/her dossier in subsequent update-dossier operations of FIG. 12 and query-dossier operations of FIG. 13.

FIG. 12 shows a flowchart of an embodiment of an update-dossier operation in accordance with the teachings of the present disclosed technology, involving actions by a local terminal, a grouper, a mapper B and a central-database (all of FIG. 9), which is believed to store data relating to an individual in his/her dossier using a pseudonym for this individual (obtained by means of a link-dossier operation of FIG. 1) to refer to the dossier.

FIG. 13 shows a flowchart of another embodiment of a query-dossier operation in accordance with the teachings of the present disclosed technology, involving actions by a local terminal, a grouper, a mapper B and a central-database (all of FIG. 9), which is believed to retrieve data relating to an individual from his/her dossier using a pseudonym for this individual (obtained by means of a link-dossier operation of FIG. 11) to refer to this dossier.

FIG. 14 is a block diagram showing data-objects constructed, sent, received, processed, and/or stored by the apparatus of FIG. 9 in the query-dossier operation of FIG. 13, in accordance with the teachings of the present disclosed technology.

FIG. 15 (which in content should precede FIG. 5) gives an exemplary embodiment of the present invention, FIG. 16 describes the general mapping mechanism, FIGS. 17, 18, 5, 6, 7 and 8 are part of the description of a first preferred embodiment of a database system, while the other figures are part of the description of a second preferred embodiment of a database system:

FIG. 15 shows a diagrammatic view of an exemplary embodiment of the present invention;

FIG. 16 shows a combination block and functional diagram of a preferred embodiment of the mapping mechanism performed by a mapper, in accordance with the teachings herein;

FIG. 17 shows a combination block and functional diagram of a first preferred embodiment of a database system involving a single mapper (from FIG. 16) and three groups of respectively update, query and partial-databases, in accordance with the teachings of the present invention;

FIG. 18 is a block diagram showing data-objects constructed and stored by the partial-databases of FIG. 17 in the add-record process of FIG. 5 and retrieved by those partial-databases in the query process of FIG. 7, in accordance with the teachings of the present invention;

### DETAILED DESCRIPTION OF THE INVENTION

A wagering structured environment is created that provides a seamless and opaque financial path from a wagering environment through a financial resource system to a wagering site, the wagering structured environment being connected to a user interface through which both funds may be secured and wagers placed, without establishing a direct communication or identification link from the financial resource system to the wagering site. The term “opaque” means that the financial resource system (e.g., a financial structure, such as a credit card issuer, bank, savings and loan, credit union, or any other facility that supplies or assures cash to a third party) can see or communicate with an intermediate party, company, system or server, but cannot see beyond the intermediate to determine an ultimate destination for assurance or payment of money or value. In the general environment of the invention, where money or payment is assured by the financial structure to the intermediate, and the intermediate assures money or payment to the wagering facility or wagering site, the financial structure cannot determine that a wagering facility or wagering site is an ultimate recipient of financial transfer of funds or financial value (e.g., the assurance of payment). No amount of legal on-line communication will enable the financial structure to determine that a wagering site or wagering facility is involved at any stage of the ultimate transaction. Because the financial structure cannot see through the intermediate in the transaction, the transaction is termed opaque.

The term “financial structure” is intended to be broad and inclusive of all legal sources of funds, credit, payment and payment assurance, including but not limited to banks, credit unions, savings and loans, financial cooperatives, credit card companies, credit card issuers, debit card companies, debit card issuers, loan offices, and the like. One desirable feature is that the intermediate party can operate with a level of comfort or assurance with the financial structure to safely operate in the role of a value provider or ledger controller on behalf of the user and fund transferor to the racing site or racing facility.

A simple example system for centrally storing wagering data provided by multiple race tracks will be considered. Instead of storing all data in a single database, the data is fragmented and stored as different fragments in different databases. The example system consists of two databases, one containing all the financial wagering data, and the other containing all the identifying information for the client, the sires, the financial structure, and the like.

Each new player record entered by a wagering site or financial structure into his ledger system or one or more terminals is split into two fragments: a fragment containing only wagering information, and a fragment containing identifying information (specifically at least only player identification). These fragments are sent by this terminal to an apparatus operated by a trusted third party (e.g., a special ledger administrator, financial processor, non-identifiable wagering hub, central server, central processor, account administrator, etc.) that forwards the fragments to the respective databases. Every fragment is given a unique identifier in such a way that these identifiers themselves do not reveal the correspondence between the two fragments. The correspondence between the identifiers, (and thus the correspondence between the data-fragments), is known only to the trusted third party. Bringing about this correspondence is referred to as mapping, and the apparatus handling the mapping is accordingly referred to as mapper. The correspondence is stored by the mapper.

The use of appropriate mix mechanisms ensures that the mapper cannot be bypassed. It also ensures that forwarded data can only be processed by the intended apparatus (i.e. the respective databases). Furthermore, it enables communication over unsecured, arbitrarily configured data-channels.

In the example system, although the information stored in both databases may be freely available (and can be used, for instance, for accounting on a ledger basis for the status of wagering results upon amounts identified in the wager events), the two databases together do not contain enough information to recover the wagering account/status information of an individual player. Retrieval of this information (that is de-fragmentation of the stored data) requires the cooperation of the two databases and the mapper (operated by the trusted third party). Thus, the extent to which stored data can be de-fragmented can be fully controlled by the trusted third party.

Data is retrieved from the system by submitting queries to the mapper. A possible query could be “Has this player exceeded prselected withdrawal amounts during a wagering session?”. The mapper answers this query by first having the database with the player-identifying information generate a list of fragment identifiers that all refer to the player in question. The mapper then translates this list into a list of fragment identifiers of wagering information fragments that belong to the player. The translated list is sent to the database that contains the wagering data and information records, which retrieves all related records and checks for wager amount conflicts. By masking data so it can only be read by the designated parties (by means of encryption techniques), throughout this process none of the parties operating mapper and databases have learned anything about the information stored at the other parties, other than the ultimate wager site (e.g., the track), who learned whether or not a wager has been placed by the player and the financial structure which may determine if funds have been transferred to the intermediary. The trusted third party only learns that a certain financial structure requests a query; it does not know the identity of the player, nor the nature of the query. The financial structure site does not learn that any wagering or financial data exists regarding this player or that there is any transaction relevant to the financial structure and wagering regulations (which are not being violated in this format) at this moment. The financial structure does not even learn that any wagering is ultimately occurring from transferred funds. The party operating the database storing the wagering data does not necessarily know the identity of the player visiting the user interface, except possibly by account or user identification or code. The party operating the database storing the identifying information knows the identity of the player, but does not know which wagering site this person is visiting nor the nature of the query.

The present technology also allows reduction of the frequency of access to identifying information. This frequency in itself can be sensitive information. In the example, we can hide from the party operating the database that contains the players' identifying information the number of times the players' wagering ledger based account information is accessed. The database holding the identifying information does not have to be involved in query operations. To achieve this, pseudonyms may be introduced for each player at each wagering site. These pseudonyms are used by the wagering sites' terminal instead of the player's identifying information. Different pseudonyms for the same player may be used at each wagering site. An apparatus at the trusted third party will keep track of the correspondences between all these pseudonyms (i.e., which pseudonyms belong to the same individual). Keeping track of this correspondence is referred to as grouping (of pseudonyms), and the apparatus performing this functionality is called a grouper. It is understood that mapping and grouping can be combined.

All pseudonyms relating to a person are chosen so they cannot be traced to the individual or linked to each other except by the intended party. The trusted third party does not know to which individual a set of pseudonyms belong. When a player is given a new pseudonym, the database containing the identifying information is used to match the pseudonym to the other existing pseudonyms. The apparatus performing this matching is referred to as matcher.

The introduction of pseudonyms also provides an efficient query mechanism, since the matching of identifying information (potentially a time consuming operation) is performed only once per player, prior to queries.

### ECash™ and EWallet™ Systems

E-C Logix, Inc. is a company specializing in groundbreaking financial cryptography software and services to the world's financial and e-commerce communities. Computers, advanced cryptographic mathematics, and the Internet combine to make it possible to create unforgeable, virtually theft-proof electronic computer files, called E-Cash™ Digital Depository Receipts™ (DDR's) that faithfully represent money or other valuable, fungible commodities that are safely stored in reserve accounts or other secure locations. E-Cash™ does not take the place of money—it unforgeably represents beneficial OWNERSHIP of money. By its very nature, E-Cash™ can be transacted over the Internet as easily as cash can be spent in a convenience store, and in amounts as small as one-tenth of a cent, with virtually zero overhead costs. These commercially operating systems can be specifically plugged in as the networking link among the user (player), wagering site and financial structure to perform the seamless opaque wagering structure and environment described above.

E-Cash™ by E-C Logix is a relatively new concept in monetary systems. It combines computerized convenience with security and privacy that improve on paper cash and is an order of magnitude cheaper and more reliable than the book-entry methods of exchange that it will replace. It adds value, certainty, and security to any service involving payment. And its versatility opens up a host of new markets and applications. E-Cash™ is not just a step on the way to tomorrow's payment system technology.

E-Cash™ works with payment system and service providers in all phases of electronic cash transaction systems. E-C Logix helps develop and refine the concept, and supports it through every step to final implementation.

This automated system is also capable of protecting against unauthorized use of stored data, by storing fragmented data in separate locations and/or parties, thus providing security, privacy, and compliance with privacy legislation; protecting against unauthorized (partial) de-fragmentation of stored data, by distributing data access-control, allowing an arbitrary number of parties to share data access-control, and thus providing security, privacy, and compliance with privacy legislation; providing methods and apparatus for parties within the system to enforce data access-control policies; protecting against unauthorized (partial) de-fragmentation of stored data in cases where several parties within the system collude; minimizes the amount of compromised data resulting from malicious parties gaining control over parts of the stored data; minimizes the amount of information learned by parties in the system from data storage and retrieval operations; in so-called dossier systems, protects against parties acquiring information which relates to accesses of an individual's dossiers (e.g. access frequency and access time); provides methods and apparatus for merging existing databases into a fragmented database with controlled retrieval; and, allows efficient, economical and practical apparatus and methods which fulfill the other objects of the disclosed technology.

### System Functionality

The drawing figures and the detailed descriptions provided later make a number of simplifying assumptions for concreteness and for clarity in exposition. It will be appreciated, however, that these should not be taken to limit the scope of the invention. Lines and arrows in the drawing figures represent messages, which may be held initially or delayed on their way, passed through various parties, encoded and decoded cryptographically or otherwise to provide their authenticity and/or secrecy and/or error detection and/or error recovery. Thus the particular means or methods whereby messages are transferred are not essential to the present invention, and it is anticipated that any technique may be employed in this regard.

The term “party” is used herein to indicate an entity with control over at least the secrecy of some information, usually at least one key. It is anticipated that a plurality of people may each know all or in effect part of some key, and they might be thought of collectively as a party. In other cases, a key may be substantially unknown to people, and reside in some physical device, and then the device itself or those who control it from time to time may be regarded as parties.

Assigning a variable a “random” value performs the function of creating a value that should not be readily determined by at least some party. Many means and methods are known in the art for generating such unpredictable quantities, often called keys. Some are based on physical phenomena, such as noise in semiconductors, or patterns detected in humans pushing buttons, or possibly deterministic cryptographic techniques sometimes called pseudorandom generators. It is well known in the art that these various techniques can often be combined, and that post-processing can often improve the results. Thus the particular means or methods whereby random values are derived is not essential to the present described technology, and it is anticipated that any technique may be employed in this regard.

To “convince” or “prove” something or to “transfer conviction” about something to a party are all interpreted to correspond to the notion, widely known and appreciated in the art, of a technical method or means that substantially removes doubt. Typically the removal of doubt relies on the assumption that certain computational problems are substantially intractable. It also typically accepts a probability, of a party being falsely convinced, that is preferably exponentially small in a security parameter. But these typical attributes are not necessary and can sometimes be avoided. If the party receiving conviction does not receive conviction about anything else of substantial utility, then the conviction will be said to be “separate.”

The choice of party names, and the number of parties are examples of choices made for clarity and convenience. Naturally, the inventive concepts disclosed here should not be interpreted as limited to a particular type, grouping, or multiplicity of parties nor should there be any other implications of naming conventions or the like.

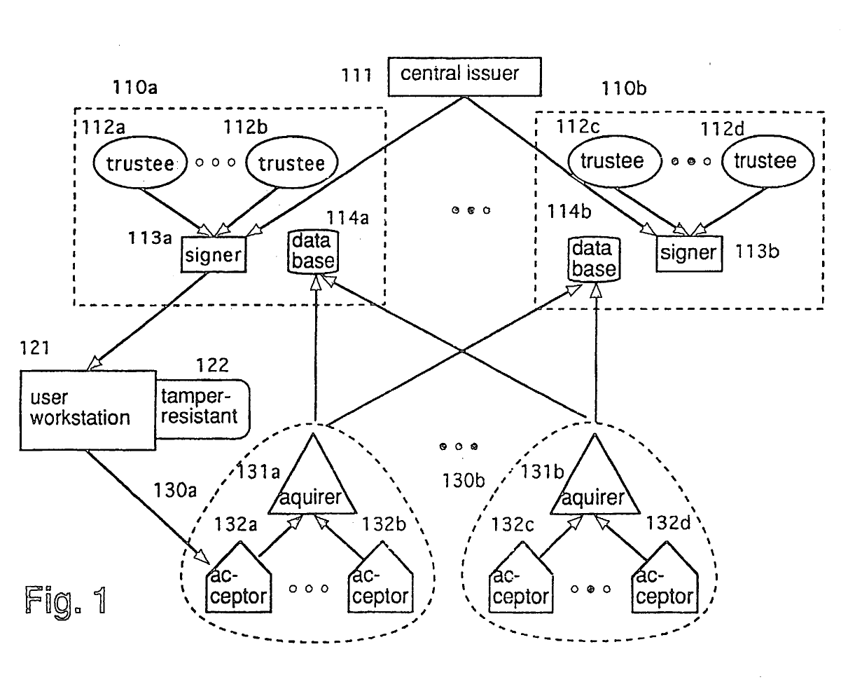

Turning now to FIG. 1, a combination general block, functional and flow diagram for a preferred embodiment will now be described in detail. It shows the overall structure means and working methods of a payment system in accordance with the teachings of the present invention. The component parts will now be considered separately.

Trustees 112a through 112d are parties maintaining secret information that can be useful in tracing. For particular information, a collection of more than one trustee may cooperate. In which case a quorum of those trustees is a subset or the full set sufficient to use the particular information. Each payer may have a different set of trustees for each different kind of tracing information or, on another extreme, there may be a single set of trustees for a whole system. The figure shows sets grouped by issuers 110, to be described, for clarity only. Other parties, such as the signer or issuer may be all or part of a trustee set. It is, however, believed desirable where practical for the trustees to be distinct from the issuers of money, as the trust relationships and functions of the two groups differ and payers should be able to choose among them separately.

Signer 113a and signer 113b, collectively signers, are the parties who make the signatures on behalf of an issuer 110 that validate money. They might typically be embodied as tamper-resistant security modules and might be stored in secure locations. The signing process may involve verification that certain tracing information is properly encoded within the money numbers being signed. For this purpose, the signers may need data from trustees that allows them to determine this but which preferably is insufficient to allow them to trace without cooperation of the trustees. Ideally, such data supplied to issuers should be supplied only occasionally and be rather compact, thereby reducing the need to process large amounts of data and to rely on the availability of the trustees for issuing money. This data may even be supplied by the trustees directly to payers, who may only provide authenticated copies of it to signers. Nevertheless, the figure shows the information flowing directly from the trustees 112 to the signers 113.

Database 114a and 114b are devices or processes that store the received payment transaction data that is returned to the issuer. The purpose of such storage may be to detect improper multiple spending of the same number. Some payment transactions may be truncated by trusted parties before they reach the issuer from which they came.

Issuer 110a and 110b are parties, such as banks, who issue money and must ultimately be responsible for honoring it later. They include the singer 113 and database 114 functions already described. They may, as indicated and already mentioned, have also an associated set of trustees, or themselves be trustees. They may receive authorization, in the form of certificates, or contribution to individual signatures from a central issuer. For instance, the central issuer may be a national bank, or international payment system, and the issuers may be banks.

Acceptors 132a through 132d are parties that receive payments directly from payers. They may test the transactions, discard, store and forward all or parts of the data selectively depending on pre-arranged rules, outcomes of tests, and communication with other parties. Although shown only providing output to a single aquirer, they may give various different outputs to multiple aquirers and/or communicate directly with issuers. Not shown for clarity are the other communication paths to the acceptors, such as those that update their rules and values needed in testing.

Aquirers 131a and 131b are parties on the way from the acceptors 131 to the issuers 110. They may form part of a hierarchy as shown, or they may more generally be part of a network. They perform such functions as aggregation of data, hiding of detail, gateway to issuers, trust/contractual relations with issuers and acceptors. They may also, for instance, also be issuer themselves. Different acquirers may process different parts of a single transaction, such as, for example, because different pieces of tracing information in the money number are to be handled in different ways.

Acquisition networks 130a and 130b are collections of parties that ultimately do cooperate in returning some payment data to issuers. There may be multiple distinct such acquisition networks, each possibly an issuer itself, or these functions may overlap in a more general way.

Tamper-resistant device 122 is computation, control, storage, and communication means presumed at least substantially difficult for a user to modify or to obtain secrets from. For instance, this might be a smart card or so-called observer issued by or on behalf of an organization, such as the central or other issuers, to the individual payer. Although not shown for clarity, it could be used directly in cooperation with both issuers and acceptors. Preferably, however, as known from “Card computer moderated systems,” and “Optionally moderated transaction systems” referenced above, it may communicate with other parties, at least at times, only through the user workstation 121.

User workstation 121 is a computing resource preferably largely under the control of the system user. Examples are personal computers, whether installed at fixed locations or portable. The issuers are not able to trust that such a device remains free from modification of its intended function or whether it can maintain secrets from users.

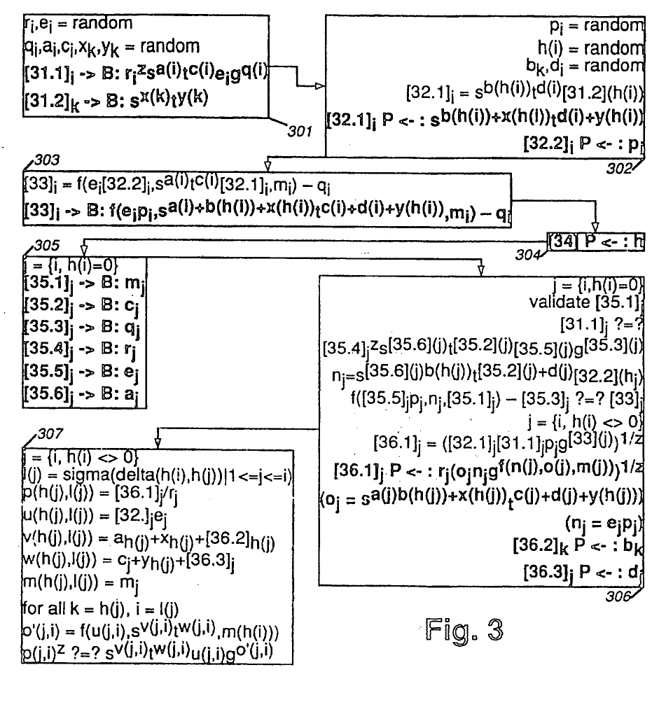

The workstation 121 may be used without a tamper-resistant device 122. In this case, the issuer can still obtain confidence in the proper form of the money numbers withdrawn, particularly with regard to the tracing information they are to contain, even if they are withdrawn in a blinded form. One way to achieve this is by protocols that convince about the structure but do not reveal tracing information. Examples of these are presented in detail later, for instance in FIG. 3.

Cooperation with tamper-resistant device 122 is believed to allow certain advantages described more fully in the last two references cited above. The tamper-resistant device may provide certification, based on its secret keys, that certain possibly blinded money numbers are properly formed. It may do this by virtue of having constructed the numbers itself, verified the construction by the workstation, or cooperatively constructed them together with the workstation. This certification may be relied on exclusively. Alternatively, the workstation only techniques described above may be combined with this technique to obtain the best of both, along the lines disclosed in the last two cited references.

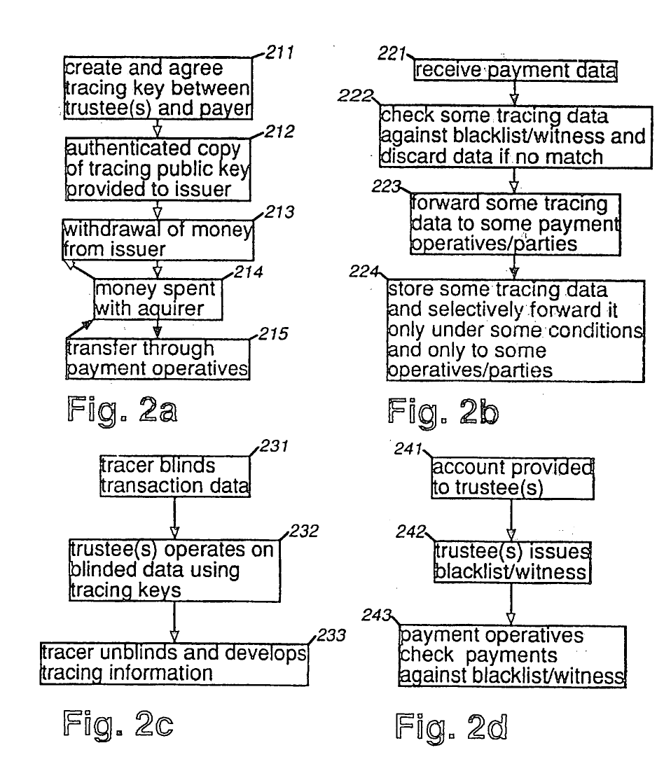

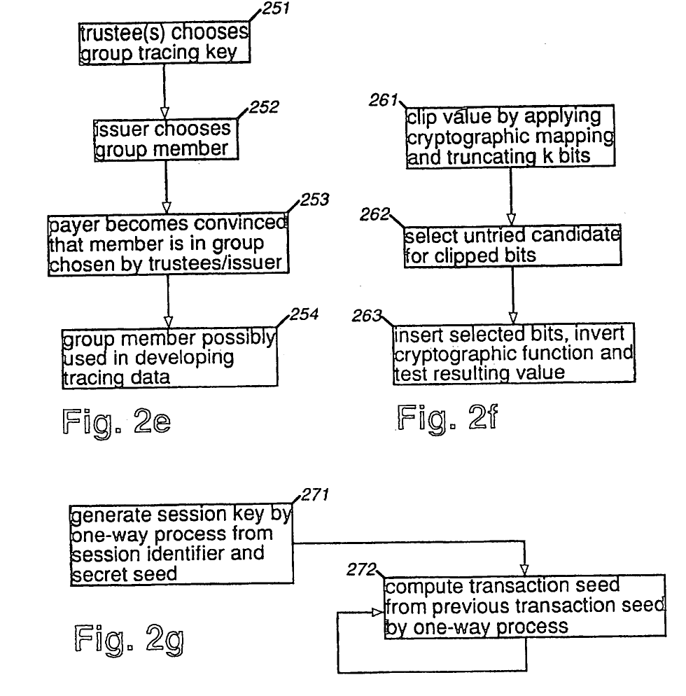

Turning now to FIG. 2, and referring specifically to FIG. 2a, a flowchart for part of a preferred embodiment will now be described in detail. It shows an overall process from tracing key creation to payment transaction iteration.

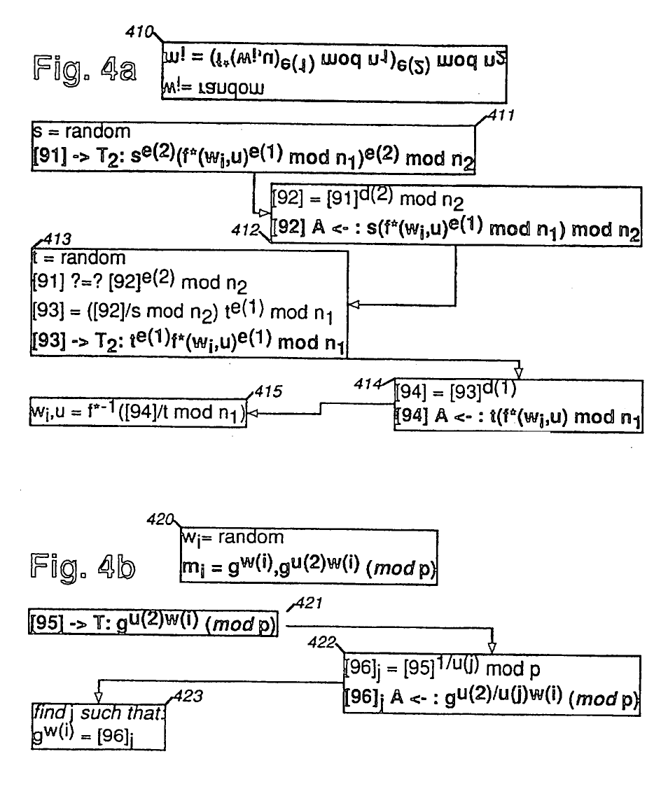

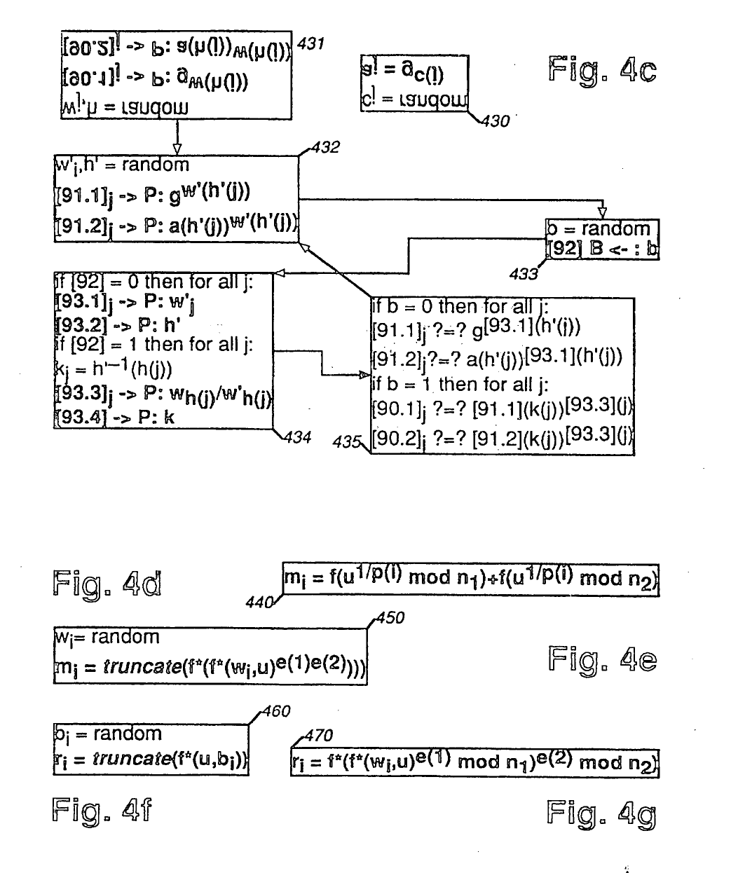

Box 211 first shows the creation and agreement on tracing keys by one or more trustees and the payer. Other parties, such as the issuer could also be involved, as will be described for instance with reference to FIG. 4c. Public tracing keys, such as in FIGS. 4a and 4b, could be created by the trustees. Certain padding values, as will be described in FIG. 4, may be created by the user. Trustees must be able to trace and payers must use the system, and therefore the two groups should agree on the tracing keys.

Box 212 indicates that the issuer should be aware of the tracing keys being used. If the issuer is not the trustee, then the issuer should, it is believed, be able to verify that the proper tracing information is present in payment signatures. This will be illustrated more fully later with reference to FIG. 4.

Box 213 is the issuing of signatures to the payer. It is believed that during this step the issuer should be able to ensure that the agreed tracing information is contained in the money withdrawn. The cut-and-choose protocol of FIG. 3, for instance, is believed to provide this function.

Box 214 portrays the spending of money with an aquirer. Some, if not all, of the tracing information is provided in the payment to the aquirer. Parts of it may be hidden or omitted as may become known to and/or accepted by the parties, as will be further described with reference to FIG. 2b. The arrow returning to box 213 is intended to indicate that during an ongoing series of payments, additional withdrawals may be required.

Box 215 stands for the transfer of payment information from the initial acceptor of payment through a network of operatives. Some paths through the operatives may lead back to the issuer, but not all payment data may be provided on each path, as will be described more fully with reference to FIG. 2b. The arrow returning to box 214 is meant to depict the possibility for multiple payments between withdrawal transactions.

Referring specifically now to FIG. 2b, a flowchart for part of another embodiment will be described in detail. It shows exemplary means and methods whereby payment data flows from the payer through a network of operatives and may ultimately reach the issuer.

Box 221 is the receipt of payment data by an acceptor of payments. How much data the acceptor requires may vary, depending, for instance, on random chance, the nature of what is sold, various relationships with other payment operatives, and so on.

Box 222 depicts the testing of the received data by the acceptor. One type of testing that can be done locally by an acceptor is simply searching for a match between the payment data received and the entries on a blacklist, as will be described more fully later with reference to FIG. 4d. Another type of testing requires computation involving witness values, as will be described more fully later, for instance with reference to FIG. 4b.

Substantial protection against clandestine and/or other improper tracing can be provided by distributing the parties that would have to cooperate to trace. Thus, having blacklists searched by potentially many acceptors of payments is believed to mean that it would be difficult to hide the extent of blacklisting from such parties, and possibly consequently from the payer community as a whole. Furthermore, as indicated, the parties may destroy all or part of the tracing information after no match occurs. In this last case, clandestine, retroactive, or tracing further down the path of the transaction data is believed to become more difficult if not substantially impractical.

Box 223 indicates that some tracing data, which might be part of the tracing data contained in a payment, may be forwarded by the initial acceptor of the payment to other payment operatives. Some of these operatives may in turn test, destroy, forward, or retain such data. And the process may go on as the data makes its way, possibly through various concurrent paths of a network, and possibly ultimately to the original issuer.

Box 224 is the holding of data by a payment operative and the selective forwarding of all or part of such data. For instance, an operative may hold on to some data, with or without forwarding it, for some period or until some event transpires. During the period the data is kept, the operative may decide to forward all or part of it to other parties, depending on various factors, such as authorization/request and the type of tracing data. Of course once the data is destroyed, the operative can no longer forward it.

Referring specifically now to FIG. 2c, a flowchart for part of a preferred embodiment will be described in detail. It shows exemplary means and methods whereby tracing is conducted and optionally trustees are kept from knowing from where and/or to where they are tracing.

Box 231 shows that a tracer party, possibly distinct from an issuer or trustee, can optionally blind the transaction or other data which is to be traced. Examples of this will be presented later in FIG. 4a.

Box 232 depicts the application of tracing keys by one or more trustees in the process of developing tracing information from transaction information. Thus, without the tracing keys, the transaction data is believed substantially impractical to develop into tracing information. Further examples of this are shown, for instance, in FIGS. 4a and 4b.

Box 233 is the optional unblinding of the tracing data and the development of the tracing information. Examples, of this process are, for instance, provided in FIG. 4a.

Referring specifically now to FIG. 2d, a flowchart for part of a preferred embodiment will be described in detail. It shows exemplary means and methods whereby trustees allow tracing from an account identifier to actual payment transactions.

Box 241 provides the account identifier to the trustees.

Box 242 indicates that the trustees develop a blacklist or witnesses. A blacklist is just searched for a match. A witness allows the acceptor of payments, not being a trustee, to perform a computational test other than simple matching, to determine if the payment is traced.

Box 243 is the checking of payment transactions by payment operatives, such as acceptors, using the blacklist or the witnesses just described. Further examples are provided in FIGS. 4a and 4b.

Referring specifically now to FIG. 2e, a flowchart for part of a preferred embodiment will be described in detail. It shows exemplary means and methods whereby a payer can obtain an identity from a group of identities that can be traced by a trustee.

Box 251 is the developing of a group of identities by one or more trustees. This is done preferably keeping secrets, on which the group is based, that will allow tracing a transaction or member of a derived group to a particular group member only by trustees.

Box 252 is the selection by the issuer of an identity within the group for use by the payer.

Box 253 is where the payer becomes convinced that the identity is among the members of the group chosen by the trustees and or the issuer.

Box 254 is the eventual possibility of development of tracing information, and eventual tracing, requiring cooperation of a quorum of relevant trustees.

Referring specifically now to FIG. 2f, a flowchart for part of another embodiment will be described in detail. It shows exemplary means and methods whereby computational difficulty of tracing can be increased and tracing can be conducted accordingly.

Box 261 is the clipping, deletion, or other restriction of information from the encrypted form of tracing information before it is used in transactions.

Box 262 presents how a tracing party is believed to need to develop possible values for the clipped values.

Box 263 is the testing of a possible clipped value by substituting such a possible value for the clipped values and then inverting the cryptographic operations in search of redundancy adequate to confirm the correctness of the possible value being tested.

Referring specifically now to FIG. 2g, a flowchart for part of another embodiment will be described in detail. It shows exemplary means and methods whereby a secret seed is used to develop the parameters needed to protect unlinkability and can later be used to allow tracing of those values.

Box 271 describes generation of a session key by a one-way process from session identifiers and a secret seed. For instance, the secret seed could be a value that the payer holds in reserve, such as by keeping it in a safe place and/or dividing it by known secret sharing techniques among a set of parties. The session parameters could be the serial number or date of the last withdrawal transaction.

Box 272 indicates an iterative process, depicted by the feedback arrow, by which a transaction seed is generated. If the value of a transaction seed were to be divulged by the payer, then all subsequent payments until the next withdrawal session could be traced. Thus, if payment information is lost by the payer, the session seed and the identifier of the last withdrawal session, and the serial number of the last known payment, can be used to reconstruct the transaction seed for the next transaction. This transaction seed could then be provided, or otherwise used, to allow tracing of any subsequent payments. Thus, after a key change, for instance, the issuer could be sure that no subsequent payments occurred and could refund the unspent lost payment amounts.

While it is believed that the notation of FIGS. 3 and 4 would be clear to those of ordinary skill in the art, it is first reviewed here for definiteness. The operations performed are grouped together into flowchart boxes. One kind of operation is an equality test. The “?=?” symbol is used to indicate such a test, and the party conducting the test terminates the protocol if the equality does not hold. (If the test is the last operation to be performed by a party during a protocol, then the success or failure of the test determines the party's success or failure with the protocol.)

Another kind of operation is that of sending a message. This is shown by a message number on the left; followed by a recipient name and an arrow (these appear for readability as either a recipient name then left pointing arrow, when the recipient is on the left; or right pointing arrow then recipient name, when the recipient is on the right); followed by a colon; finally followed by an expression denoting the actual value of the message that should be sent. (These operations are depicted in a “bold” typeface for clarity.) Square brackets are used to delimit message numbers and such an expression stands for the value of the corresponding message.

The further operation of saving a value under a symbolic name is denoted by the symbolic name on the left hand side of an equal sign and an expression on the right hand side.

Several kinds of expressions are used. One is just the word “random.” This indicates that a value is preferably chosen uniformly from an appropriate set of values (defined in the text where not obvious to those of skill in the art) and that is chosen independently of everything else in the protocol. Creation of random values has already been mentioned.

A further kind of expression involves exponentiation. All such exponentiation (unless noted otherwise) is in a finite group. When no operation is shown explicitly, multiplication in such a group is assumed. When “/” is applied between elements of such a group, the result can be calculated by first computing the multiplicative inverse of the expression on the right and then multiplying it by the expression on the left—but this operation may also be described simply as division. When the “/” is used between exponents, and if the result is a proper fraction, it indicates a corresponding root, as is well known in the art.

Turning now to FIG. 3, a flowchart for part of a preferred embodiment will now be described in detail. It shows a cut-and-choose protocol performed between parties denoted bank B and payer P. It will be appreciated that a general cut-and-choose protocol is disclosed here, and that it is believed to offer certain advantages; however, other known cut-and-choose protocols, such as those disclosed in the above referenced patent entitled “One show blind signature systems” could of course be applied as well. Other more specific protocols are also anticipated.

Box 301 first shows P choosing rᵢ and eᵢ at random. Both are base numbers in the modular arithmetic system used throughout FIG. 3. The modulus for this system has been created by B from preferably two random primes of sufficient size, as is well known in the art. A plurality of other random values is chosen modulo z, which is the preferably prime public exponent of sufficient size also chosen by B. These values are qᵢ, qᵢ, cᵢ, xₖ, and yₖ. The index j runs over the number of results that are to be obtained, which may be thought of as the number of payments that will later be possible. The index i runs over the total number of initial candidates, which is believed to need to be significantly larger than j in order to obtain the desired level of security as is well known in the art and has been investigated in detail elsewhere. (The form of h is also believed relevant in this connection and example values will be provided when h is introduced later). Now P is shown forming a first message >32.1!ᵢ and sending it to B. The message is just the product of the values rᵢ raised to the z, s raised to the aᵢ, t raised to the cᵢ, eᵢ, and g raised to the qᵢ. The values s, t, and g are simply public generators. It is believed desirable that B has chosen these and provides a proof that any one can be expressed as a power of any other one of the three. This could easily be accomplished using well known protocols, such as Chaum, Evertse, v.d. Graaf, and Perlata “Demonstrating possession of a discrete log without revealing it” CRYPTO ‘'86, Springer-Verlag, 1987, pp. 200-212. The other message shown sent by P to B in this box is simply s to the xₖ power times t to the yₖ power.

Box 302 defines the actions of B after the above mentioned two messages are received from P. First a random base number pᵢ is chosen. It will be appreciated that the index values i and j are used similarly by both parties.

Then the random map h is selected. This domain is the candidate indexes, being integers from 1 to the number of candidates. The range includes 0 as a distinguished entry and the integers from 1 to the number of payments that will result, as already mentioned for k. When a candidate index maps to 0, it will be “opened” later. All the candidates that map to a particular nonzero value will make up the check with that number. Every check is assumed for simplicity to have the same number of candidates. Example values, that are believed adequate for a substantial level of security, might be 1000 candidates, 10 per check, with a total of 80 check and 200 opened candidates. Extensive analyses of such parameters have been made and are known in the art.

Also chosen at random are bₖ and dᵢ, all residues modulo z. The first message >32.1!ᵢ to be sent by B to P is formed as a product of three terms: the already mentioned generator s, raised to the bₕ₍ᵢ₎ power; t raised to the dᵢ power; and received message >31.2! indexed by hᵢ. This message has the form shown corresponding to how it was formed with the included message multiplicatively contributing a power of s and of t. Also shown being sent are the pᵢ as message >32.2!ᵢ.

Box 303 describes how P forms the exponent request message >33!ᵢ that is sent to B. The value is formed, per candidate, modulo z as is well known, as the output of the one-way function f, having three inputs, minus the value qᵢ already mentioned. The first argument of f is the base value of the ultimate signature, eᵢ times pi received in message >32.2!ᵢ already mentioned. The second argument is the powers of s and t; s appears to the aᵢ and t to the cᵢ, with the additional s and t powers provided by B from received message >32.1!. The third argument is the money number mᵢ. Thus, the actual form sent reveals the content of >32.1!ᵢ, which was already described with reference to box 302.

Box 304 is just the sending of the entire map h from B to P. For clarity as will be appreciated, h is shown in the boxes of P, not as a message number, but in symbolic form.

Box 305 sends the opening of candidates that have an index that h maps to 0. Six values are sent per opened candidate: m, c, q, r, e, and a, in messages >35.1! through >35.6!, respectively.

Box 306 indicates first a checking of the opened candidates and then the supply of the actual roots and powers needed to obtain showable signatures. First the value of m is “validated,” which is intended to denote any sort of testing that may be appropriate, such as testing that the form has the proper linking structure, as will be described more fully later. For each j that is mapped to 0 by h, two equalities are tested. In the first, message >31.1! should equal received message >35.4! raised to the z, times s raised to the received message >35.6! times t raised to the received message >35.2! times received message >35.5! times g raised to the received message >35.3!. For the second equality, n is formed for convenience formed to collect the powers of s and t. The powers of s shown are received message >35.6! plus b. The powers of t shown are received message >35.2! plus d. Also are the contributions from message >32.1! already sent by B. Now all the messages >33! received are reconstructed as an image under f minus the corresponding message >35.3! received. The first argument for f is received message >35.5! times p. The second is n. The third is message >35.1! received.

Three values are provided to P, two for each unopened candidate and one for each check. The first, per candidate, is message >36.1!, the z'th root on the product of four terms: >32.1!, >31.1!, p, and g raised to the requested power >33!. A different use of temporary value n, and one of temporary value o are used for clarity in denoting the form of this first message sent. The second message, which is per check, is b and is sent as >36.2! (with subscript k). The third and final message, which is per candidate, is d.

Box 307 represents the putting in convenient order for storing and then the final testing of the signature by P. Each value is re-indexed to have two indices, the first for the check number and a second for the serial number of the candidate within that check. The ordering is chosen arbitrarily as preserving the check numbers and with serial numbers in the same order as the corresponding original candidate. Thus, the first value is p, which is the signature >36.1! with the blinding factor r divided out of it. The second is u, which is the base value e times p from message >32.2!. The third is the power of s, being the sum of x and b from message >36.2!. The fourth and final is the power of t, which is the sum of the corresponding c, of the y, and d from message >36.3!.

For completeness, the testing of the signature, which could be performed also when the signature is received by another party, is shown. The z'th power of the signature p itself is compared for equality with its reconstruction as a product of four terms. The first is s raised to the v; second is t raised to the w. The third is the base u, and the fourth is g raised to the image under f, which for convenience is denoted o′. To compute o′, f has been shown as applied to three arguments: u, s to the v the quantity times t to the w, and m.

Turning now to FIG. 4, and referring specifically to FIG. 4a, a flowchart for part of an embodiment will now be described in detail. It shows both a form of money and a blinded, two-trustee protocol for tracing without the trustees learning either what was traced or who it was traced to.

Box 410 first shows that the value wᵢ is chosen at random as an unknown padding to allow the concealment of the value u within the money number. Then the form of the money number is shown explicitly for clarity in a two trustee setting, where each trustee uses RSA as the trapdoor public mapping. Any other number of trustees or trap door public function(s) could, as would be obvious, be used. This form of the money number could, for instance, be entered as the value mᵢ, or as one of multiple components of that value, in a cut-and-choose, such as that of FIG. 3. Specifically, the money number is the composition of two mappings, the inner most is RSA encryption with the public key of T.sub.1 and the outer layer composes encryption with the public key of T₂, such basic operations themselves being well known in the art.

Box 411 illustrates how a first blinding of the money number is performed by tracer A using s, a random residue modulo n₁. The message sent to trustee T₁ is just the money number already described times the blinding factor s raised to the public exponent e₂.

Box 412 has T₁ decrypt the message >91! received and return this result to tracer A as message >92!.

Box 413 begins by forming a second blinding factor t, this one for use under the modulus of T₂. Then the result form T₁ may be tested simply by raising it to e₁, the public power of T₁, and checking that this results in message >91!. In forming message >93! to send to trustee T₂, the blinding by s is divided out of message >92! and the result is re-blinded with t using n₁, the modulus of T₁.

Box 414 again simply has a trustee, T₁ this time, decrypt using the corresponding secret key d₁. The input is message >93!, and the output is >94!.

Box 415 shows how received message >94! is first unblinded by dividing out t modulo n₁. Then the inverse of f* is applied, to yield the original pair, already described, containing padding wᵢ and revealing the identity of the payer u. As will be appreciated, f* is an optional and substantially invertable yet preferably cryptographic mapping that allows recovery of its arguments but is believed to distort structure, such a multiplicative structure, that might allow undesired interaction between the arguments and the signature scheme. Other uses for such a function in this position, such as for clipping, will be described later.

Referring specifically now to FIG. 4b, a flowchart for part of a preferred embodiment will now be described in detail. It shows an alternate form of money and a single trustee, as well as an unblinded form of a tracing protocol.

Box 420 displays an exemplary form of a money number represented as two residues modulo a common fixed public prime p (although any group could be used). The disguising, as in box 410, is shown by denoting the random formation of wᵢ. This value is applied as an exponent to each member of the pair of fixed values associated with the particular account. One such fixed value is simply a common public generator g. (It is anticipated, however, that specific powers could also be used here to advantage in some cases.) The other such value is that same generator raised to a value only known to the trustees. For clarity, a single value u₂ is shown, which could for instance be applied to all money numbers from this account. With multiple trustees, as would be appreciated, the value u₂ could be composed of the sum or product of contributions from multiple trustees.

Box 421 is the transmission of the second component of the money number by tracer A to trustee T. Box 422 then has T remove each of a set of possible exponents from copies of message >95! received. One exponent could, for instance, correspond to one payer account and the whole set might cover all payer accounts. To remove an exponent, the value is raised to the multiplicative inverse, modulo the order to the group, of that exponent. Thus, it is believed for all but one of the >96!ᵢ returned by T to A, the exponent will not be canceled, because it was not there originally. But for the one of the values, the exponent was there and it is canceled.

Box 423 tests all the returned values, until one is found that is equal to the first component of the money number g^{w}. In this way the money number is traced to the account corresponding to the index i of the matching message >96!.

As will be appreciated, elaboration is readily achieved. For instance, the multiple trustees as already mentioned could each remove their exponents one after the other. No fixed order, as in FIG. 4a, would be required. Blinding could be achieved, for instance, by using exponential blinding: >95! would be raised to a random power by A and the result returned by T would be raised to the inverse power. The message could still travel around through multiple trustees in any order and without, as in FIG. 4a, coming back to A between each trustee. Furthermore, each trustee could first remove the account specific exponent and put in place the same exponent. This would then allow, for instance, permuting of various such values so that they can be operated on in the same way.

Referring specifically now to FIG. 4c, a flowchart for part of a preferred embodiment will now be described in detail. It shows a system for convincing a payer P that a particular set of linking information is merely a permuted copy of a list developed by the trustee(s), thereby allowing a payer substantial certainty that they are linkable to an entry on the list, but substantially inability to determine which entry on the original list they are linked to. An example application is marking of bank notes in a limited number of categories hidden from those withdrawing the notes.

Box 430 first indicates the formation of a public list of meta-identifiers by the trustee(s). The value cⱼ is chosen at random and preferably remains confidential to the trustee(s); what can be provided to payers or even made public is aⱼ, which is set equal to a generator g in the group of public order used throughout this protocol. Thus there are n meta-identities, and j may be thought of as ranging from 1 to n. More than one trustee can supply a contribution to aⱼ, such that, for instance, the product of the contributions is taken as aⱼ; or, for example, each trustee could place a power on the accumulated value as it travels around among them.

Box 431 shows the formation of a set of identities by B. This is an optional feature that allows a non-trustee party, possibly such as the issuer, to create a permuted instance of a list of identities from the meta-list. First wⱼ is chosen as a suitable exponent. The function h maps the indices of the meta-identity list into those of the identity list; that is, it is the permutation between the meta-identities and the particular set of identities created by B. Message >90.1!ⱼ is formed as g raised to the w selected by h applied to j. Also sent with and corresponding to each of these there is a >90.2!ⱼ formed as the meta-identifier list permuted by h, each raised to the w selected by h applied to j. Thus, each identifier is a pair g and a meta-identifier, both members of the pair being hidden by being raised to the same power of w.

Box 432 begins the loop part of the convincing, that can be repeated any number of times, as indicated by the arrows. It is believed that uncertainty is halved by each iteration, and for clarity the number of iterations is not shown explicitly. In order to create a list of temporary pairs, random exponents w′ⱼ and permutation h′ are created at ransom, each essentially like its unprimed namesake. The message >91.1!ⱼ is formed as g raised to the particular w′ selected by h′ applied to j; similarly, >91.2!ⱼ is formed as α selected by h′ of j, the quantity raised to the w′ selected by h′ of j.

Box 433 receives these above described commitment messages and then issues a random challenge bit b as message >92! provided to B.

Box 434 handles one of two cases: either b is 0 or it is 1. In the first case, w′ⱼ and h′ are sent to P as messages >93.1!ⱼ and >93.2!, respectively. In the second case, a permutation kⱼ is formed as h′ inverse composed with h. Message >93.3!ⱼ is formed as wₕ₍ⱼ₎ times the multiplicative inverse of w′ₕ₍ⱼ₎. And message >93.4! is simply the mapping k.

Box 435 checks the response from B by evaluating a different pair of equalities depending on the value of b. If b is 0, then message >91.1!ⱼ received is compared for equality with g raised to the >93.1! selected by h′ of j; >91.2!ⱼ is compared with α selected by h′ applied to j, the quantity raised to the >93.1! selected by h′ applied to j. In case b is 1, >90.1!ⱼ is compared for equality with >91.1! selected by kⱼ the quantity raised to the power >93.3! selected by j; >90.2!ⱼ is compared to >91.2! selected by kⱼ the quantity to the power >93.3! selected by j. (The values k and h′ are shown for clarity with its alphabetic as opposed to its message number notation here.)

Referring specifically now to FIG. 4d, a flowchart for part of another embodiment will be described in detail. It shows a system for allowing blacklisting information to be developed with knowledge of the payer account. Box 440 shows the form of the money number mᵢ. It is shown as a modular sum, but other techniques as would be appreciated could be used, such as exclusive-or. The number of terms that must be combined is equal to the number of trustees, and they need not each work in the same way. The combination technique preferably allows any one contribution to block out and otherwise hide any other contributions, although it is anticipated that this property may be violated to some advantage in some circumstances.

One term shown is f applied to the pᵢ'th root of the universal identifier u, within the residue classes induced by the RSA composite nᵢ. The other term uses the same prime but a different modulus. The idea is that the trustee owning the modulus is able to construct all the roots on u and provide them to the payer; the bank, however, is unable to determine the roots, even though given any root opened during the cut-and-choose, the bank can verify that it is uniquely determined by its index and the payer identity u. Thus the index of the primes may preferably be taken as the candidate number. Also note that the method of combining terms allows a quorum of trustees to be required for tracing.

Referring specifically now to FIG. 4e, a flowchart for part of an embodiment will now be described in detail. It shows a system for making the work required to trace substantially as high as desired. Box 450 shows first how the payer forms a value wᵢ at random. The value mᵢ, a money number, is formed as the truncation of a quantity. This is intended to indicate that some of the information in the quantity is left out. For instance, but without limitation, a simple example would be to perform the truncation operation as the leaving out of a predetermined number of bits of the representation of its argument. Thus, in this example, for each bit left out, the amount of computation that the tracer would have to do is believed to double.

The form of the money number that is the argument of the truncation function could be anything described elsewhere here. But, for definiteness, a specific form is shown, and it is the encryption using two public keys e₁ and e₂, as indicated by their position in the exponent. The value they encrypt is shown as an image under f* of the pair wᵢ and u, the former having been chosen as random padding as already mentioned, and the latter being an identifier. The entire encryption is the argument for an outer application of f*.

If this money number is to be traced, it is believed that, provided f* is adequately strong, the most effective way to discover u should be to guess at the values of the omitted information, such as the deleted bits already mentioned. For each guess, the inverse of f* should be applied. Some redundancy could be included that would be recognizable at this point, so that the proper guess could be detected after the inversion. Alternatively, redundancy might only be recognizable only once the two encryptions are inverted, such as by the respective trustees, and the inner f* is inverted. In any case, u can be recovered by inverting the outer and then the inner f*.

Referring specifically now to FIG. 4f, a flowchart for part of an embodiment will be described in detail. It shows both a system for restricting the blinding factor and also another use of the truncation function just described. Box 460 forms a blinding factor rᵢ as an (optional) truncation of the invertable cryptographic function f* applied to an account identifier as well as a random padding value bᵢ, all as more fully already described. Thus the blinding, as denoted also by rᵢ in FIG. 3, does not have the full range of possible values. The value of the blinding factor is determined by forming the quotient of the guessed corresponding withdrawal and deposit, as is well known. Once the guessed blinding value is determined, and the truncated bits removed, then f* can be inverted and the redundancy in, for instance, the identifier u can be used to recognize the fact that a proper guess has been made.

Referring specifically now to FIG. 4g, a flowchart for part of an embodiment will be described here in detail. It shows another example of the choice of a blinding factor from a limited range corresponding to certain limited values. Box 470 depicts a second example of a restriction on the blinding factor rᵢ from FIG. 3. It will readily be appreciated that the restriction on the blinding factor is verified as part of the cut-and-choose protocol. The particular example shown uses the form of money number already described in detail for FIG. 4a. The difference being only the outer application of the f*, which is intended, as already mentioned, to inhibit any undesired interaction between the values it encompasses and those that contain it. As would be obvious to those of ordinary skill in the art, there are many essentially equivalent orders to evaluate expressions; ways to evaluate expressions; ways to order expressions, tests, and transmissions within flowchart boxes; ways to group operations into flowchart boxes; and ways to order flowchart boxes. The particular choices that have been made here are merely for clarity in exposition and are sometimes arbitrary. Also the order in which messages are generated within a box and sent may be of little or no significance.

It will also be obvious to those of ordinary skill in the art how parts of the inventive concepts and protocols herein disclosed can be used to advantage without necessitating the complete preferred embodiment. This may be more fully appreciated in light of some examples: Of course each different type of tracing can be used separately, as can each way of ensuring the tracing information is in place. Tracing by the payer, as disclosed here, could simply be used for backup purposes. Also, the protocol of FIG. 3 is a very general cut-and-choose, and could be used for credential or any other application of such protocols. Similarly, the protocol of FIG. 3c is of general utility.

Segmentation of Information Blocks

Turning to FIG. 15, an embodiment of an alternative with the present disclosed technology is shown, using existing computer hardware and operating systems, specifically configured, and extended with some specific programs. Obviously, numerous alternative configurations may be used, as well as different hardware, operating systems, database programs, physical communication channels and communication protocols.

Data is entered into the system, and also updated, by means of one of the update terminals 100. An update terminal 101 is a standard PC (with an Intel 80486 or Intel Pentium processor), running under the Microsoft Windows 95 operating system. This terminal 101 splits the data, performs the appropriate encryption, and sends the resulting data to the mapper. To connect to the mapper 130, this PC is equipped with a standard asynchronous modem 110. This modem 110 connects with a cable 111 to the public telephone network 120. When storing or updating data, the update terminal 101 dials up the mapper 130.

The mapper 130 consists of 132, a Sun Sparc™ 20, equipped with a Sybase™ database (used to store the corresponding fragment-identifiers and pseudonyms). To allow multiple terminals to connect simultaneously, the mapper 130 is equipped with 131, a modem-pool and a Transpac™ X25 ISDN data switching network, connecting the incoming lines from 120 to 132. The mapper 130 processes the message from the update terminal (by performing the necessary decryption and mapping of identifiers) and sends the data-fragments to the appropriate partial-databases of the group of partial databases 150. The mapper 130 connects to a database 151 by means of an ISDN modem 140. Data is transferred using a dedicated ISDN line 141.

The database 151 is also equipped with a modem 140. Depending on the amount of data to be stored and retrieved, and the desired response time, the database 151 can range from a standard PC (Intel Pentium processor and 32 MB of RAM), equipped with the Microsoft Windows® NT operating system, running a Microsoft SQL Server database engine, to a Sun Sparc™ 2000 station and a Sybase™ database engine. The database 151 stores the received data-fragments on a disk medium.

Data is retrieved by means of one of the query terminals 160. A query terminal 161 is similar to the update terminal 101. It transfers the query to the mapper 130. This mapper retrieves the data from the appropriate databases, and returns an answer. The query terminal connects to the mapper 130 by calling in, over the public telephone network 120, with a modem 110. All machines mentioned use DEC MessageQ to communicate.

The grouping of identifiers (pseudonyms) may additionally be performed by the mapper, or a machine configured similar to a mapper, placed in between modem pool 131 and mapper 132. In the following drawings, for reasons of clarity, the physical apparatus involved are shown in an abstract manner. In the accompanying text, they are sometimes referred to as entities or parties. Lines and arrows in the drawing figures represent the apparatus and/or methods for effecting the transfer of data, which may be held initially or delayed on their way, passed through various apparatus, encoded and decoded, cryptographically or otherwise, to provide their authenticity and/or secrecy and/or error detection and/or error recovery. In the text, the transfer of data is referred to as sending a message and receiving a message, without referring to the actual physical process. All apparatus involved in the presented embodiments have a suitable means for retaining and retrieving data, on some physical media (e.g., tape or disk). For clarity, in the text below, this is referred to store data and retrieve data, without referring to the actual physical process.

Furthermore, it is assumed that each of the parties has a means of protecting their equipment against abuse, by restricting access to the relevant apparatus to authorized persons—either physically, by locking these apparatus, or logically, by means of requiring passwords and/or storing data in an encrypted form. In the last case the decryption keys will be supplied only to authorized persons. The way this functionality is achieved can be either manual or automated, or in some mixed form.

2. The General Mapping Mechanism

Turning to FIG. 2, the general mapping mechanism performed by mapper 200 is described. The mechanism starts when the mapper receives a message 201. This message consists of n groups of three data-elements, each of the form:
ENCₚₖ_{_{—}}ₘₐₚ (Dₓ),Aₓ,Pₓ,
where n is an integer value, and x is an integer value between 1 and n. Furthermore, ENCₚₖ_{_{—}}ₘₐₚ (Dₓ) is some arbitrary data Dₓ, encrypted with the public key of the mapper, Aₓ is the addressee of the data, and Pₓ is an identifier, used by the sender of message 201 to refer to data Dₓ.

Upon receipt of this message, the mapper verifies whether it has received the identifiers P₁, . . . , Pₙ previously, by searching the first field 203 of a list of data-elements 202 in a suitable data representation physical medium. In the case P₁, . . . , Pₙ is found, in the next step of the mechanism the mapper uses the identifiers P′₁, . . . , P′ₙ stored in the second field 204 of the data-element. Otherwise, if P₁, . . . , Pₙ is not found, n unique and so far unused identifiers P′₁, . . . , P′ₙ are chosen by the mapper to be used in the next step.

In the next step, using his private key, the mapper decrypts the n pieces of encrypted data to reveal D₁, . . . Dₙ. It then sends these results in n messages (206) to the appropriate addressees (as specified in A₁, . . . , Aₙ). Each of the n messages has the following form:
(Dₓ,Aₓ,P′ₓ).
The receiver Aₓ will associate the identifier P′ₓ with the received data Dₓ. When new P′₁, . . . , P′ₙ were chosen by the mapper, the mapper adds to the list a data-element 202 containing P₁, . . . Pₙ in field 204, the identifiers P′₁, . . . , P′ₙ in field 203, and addressees Aₙ, . . . , Aₙ in field 205.

It will be obvious to a person of ordinary skill in the art that the chosen identifiers can be generated by the mapper, or be generated in cooperation with other apparatus. This fragment identifier should be chosen so it cannot be linked to the data by anything other than the mapper. In this respect, for instance, a unique, unused, randomly generated integer may be used. When multiple data-fragments are presented in one message 201 (in other words, when the value of n is greater than 1), by storing the identifiers together, the mapper records the correspondence between these fragments. This is referred to as linking identifiers. The mechanism of replacing the identifiers Pₓ with P′ₓ is referred to as mapping identifiers.

### 3. DETAILED DESCRIPTION OF A FIRST EMBODIMENT

3a. Overview

Turning to FIG. 3, the respective apparatus of a database system and their interconnections are shown. The apparatus that are used to supply and refresh information (to be) stored in the system will be referred to as update terminals. Box 300 represents one or more update terminals. Two update terminals, labeled 301 and 302, are shown here for illustrative purposes. The number of update terminals is denoted by k. It will be appreciated that the precise number of update terminals is not essential to the present inventive techniques.

200 is an instance of the mapper, as described in FIG. 2. It controls the access to all the information stored in the database system. It will be understood that although the mapper is referred to as a single entity, it need not actually be so. The mapper may actually correspond to an entire network of entities that are all in charge of controlling the access to the information stored in the system. It is envisioned that in most applications the mapper will be operated by a trusted third party. This trusted third party can be a part of the organization operating the database, but also a government body or, for example, a consumer interest group.

The apparatus that are used to store (parts of) the information will be referred to as partial-databases. Box 320 represents one or more partial-databases. Two partial-databases, labelled 321 and 322, are shown here for illustrative purposes. The number of partial-databases is denoted by m. Although a system should consist of at least two, the precise number of partial-databases is not essential to the present inventive techniques. All relevant apparatus contain data about what type of data is stored by which partial-database. Access to the data stored in partial-databases is assumed to be restricted to the respective partial-databases. It will be appreciated that access can be restricted physically—by controlling the area in which the partial-database is stored—and/or logically—by, for example but without limitation, encryption of the stored data or password protection schemes. Such access-control methods are well known, and will not be further discussed here. The goal of the separation of the system into partial-databases is that the partial-databases contain no, or very limited, information that is sensitive when considered in isolation, or even when combined.

The apparatus that are used to retrieve the information will be referred to as query terminals. Box 330 represents one or more query terminals. Two query terminals, labeled 331 and 332, are shown here for illustrative purposes. The number of query terminals is denoted by n. It may be noted that the number of query terminals is not essential to the present inventive techniques.

It is not excluded that an update terminal and a query terminal correspond to the same entity, and neither is it excluded that the same entity is represented by more than one update terminal and/or query terminal. Each of the update terminals can send information directly to the mapper through a communication channel, represented by arrows 340 and 341 for update terminals 301 and 302 respectively. Each of the partial-databases can exchange information directly with the mapper through a communication channel, shown here as 342 and 343 for partial-database 321 and 322 respectively. Each of the query terminals can exchange information directly with the mapper through a communication channel, shown here as 344 and 345 for query terminal 331 and 332 respectively. When requested by a neighbor apparatus, all apparatus will forward messages to enable apparatus that are not directly connected to exchange information. The communication channels presented here are not necessarily the physical connections between the apparatus. Messages may be routed arbitrarily, the only restriction being that messages have to travel in the right order through the apparatus relevant to the mix mechanism.

Three basic operations are supported by the system: adding a new record, updating an existing record and performing a query. It will be appreciated that, depending on the application of the invention and/or on the jurisdictional domain in which it is operated, certain legal restrictions may apply to the operations and/or results thereof. Additional restrictions may be laid down in agreements between the update terminals, the mapper and the partial-databases.

3b. The Add-Record Process

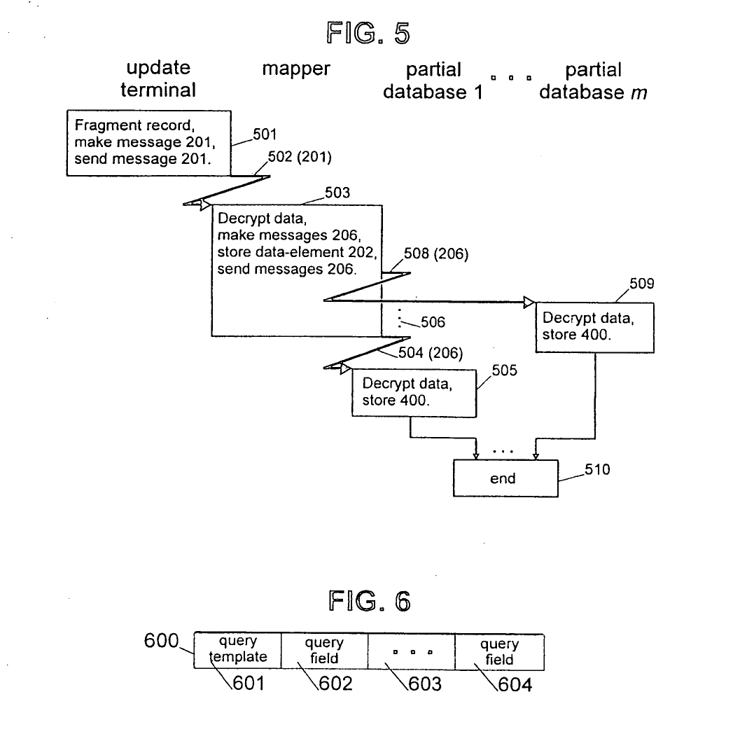

Turning now to FIG. 5, the process of adding a record, in which an update terminal 301 or 302, the mapper 200, and the partial-databases 320 participate is shown. FIG. 4, shows a data-element subjected to this process.

When one of the update terminals has new information to store it starts the process in step 501. The update terminal in question separates the input record into m data-fragments D₁, . . . , Dₘ (n of FIG. 2 equals m). We will refer to the fragmentation of single data records as vertical fragmentation. The update terminal in question furthermore assigns each of the fragments to one of the partial-databases (the addressees mentioned in FIG. 2). The way in which an input record is separated into fragments may vary between different applications of the inventive techniques, (i.e. each piece of information in the record may occur in none of the fragments, one of the fragments, several fragments or even in all fragments). It is envisioned that in some cases the separation into fragments and assignment to partial-databases will vary from record to record, but in many situations the separation and assignment will be similar for all records. Although in this preferred embodiment the data is divided over all partial-databases in the system, in other respects this division is to be considered an example, and not intended to limit the scope of the present invention. The update terminal constructs a message 201 (as described in relation to FIG. 2) by assigning fragment identifiers P₁, . . , Pₘ to the fragments, and encrypting the fragments with the public key of the mapper. It will be obvious to those of ordinary skill in the art that the update terminal can encrypt the data-fragment beforehand in such a way that the assigned partial-database can decrypt the data-fragment while some or all other parties in the system cannot decrypt the data. This prevents the mapper from collecting a copy of all data stored in the partial databases. It is envisioned that most embodiments will use such an encryption. The last action of 501 is the sending of message 201 to the mapper, in message 502, using the communication channel.

Upon receipt of 201, the mapper starts execution of step 503. As described in relation to FIG. 2, it constructs message 206, by decrypting the data-fragments, and records a data element 202. As the concluding action of step 503, the m messages of 206 are sent to the assigned partial-databases, using the respective communication channels. Of these m messages, two are shown here, 504 and 508. The other messages are depicted by 506. Only the partial-databases that correspond to messages 504 and 508 are shown, the others are omitted from the diagram for clarity.

Upon receipt of the message 504 the first partial-database starts execution of step 505. The partial-database stores a data-element 400, containing the received data-fragment Dₓ in field 401 and identifier P′ₓ in field 402. This ends step 505, after which the actions to be performed by these partial-databases in the update process are executed. The process step 509, executed by the other partial-database shown here is similar to step 505, as are the steps executed by the other databases. When all partial-databases have executed their respective steps, the process terminates at step 510.

Application of this process not only fragments the data vertically. Since each record is stored without any reference to other associated records, data is also fragmented horizontally. We refer to this database system as fully fragmented.

3c. The Record-Update Process

Updating a record works along similar lines to the process of adding a record as described in FIG. 5. It starts with an update terminal wishing to update one of the previously submitted records. The update terminal separates the new record into fragments using the same method used for separating the old record. It then forms a message 201, similar to that described above. However, instead of assigning new identifiers, the same identifiers P₁, . . . , Pₘ are used as in the add-record process for this record. When it receives the message, the mapper retrieves the associated P′₁, . . . P′ₘ and A₁, . . . , Aₘ. Using the received update fragments D′₁, . . . , D′ₘ, and the retrieved information, the mapper then constructs m update messages (206), and sends them to the respective partial-databases, the same way as described in 503. Each partial-database then searches in the data-elements 400 for the Dₓ it stored with the fragment identifier P′ₓ and updates the fragment with the received D′ₓ. Deleting a record can thus be considered a special case of updating a record.

3d. The Query Process

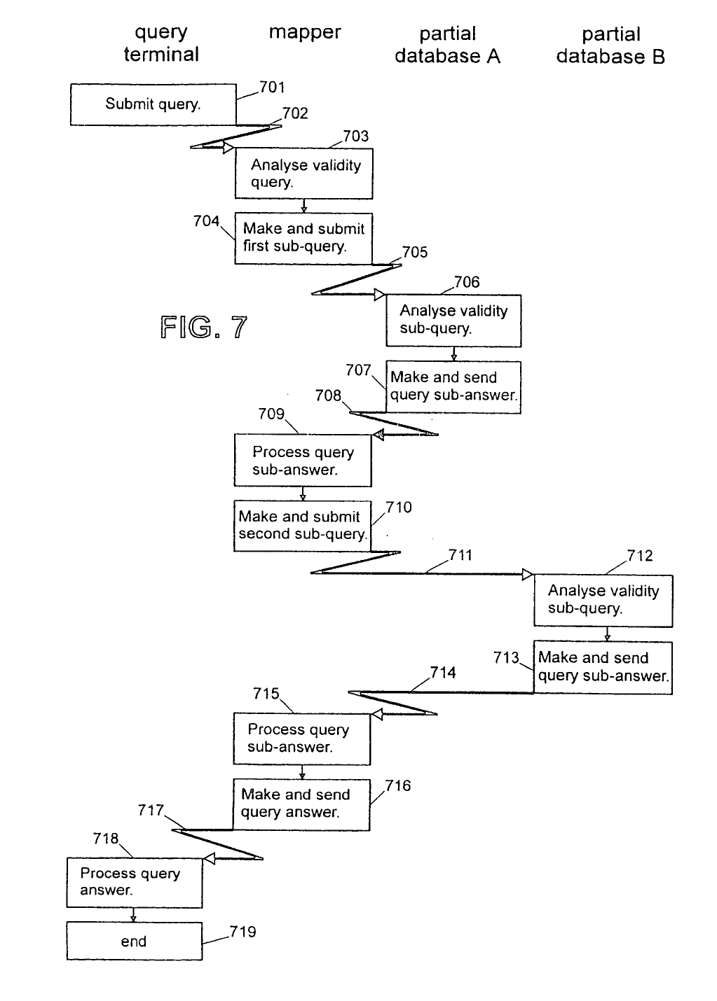

Finally, we consider query operations. We proceed by giving a general description of the process, as performed by the mapper, a query terminal and the partial-databases. FIG. 6, shows a data-element related to this process. A detailed description of an example of a query will be given later in relation to FIG. 7.

A query operation is performed by one of the query terminals 330. It also involves the mapper 200 and the partial-databases 320. The query terminal starts a query by submitting a query request to the mapper. A query request, of which the structure is shown in 600, consists of a data-independent part 601 that is called the query template, and of zero or more data-holding parts called the query fields. Two query fields, 602 and 604, are shown. The other query fields are denoted by 603. The query template consists of a question (or command), formally phrased in some query language. The query template may contain references to data stored in the query fields. The number of query fields and the type of the data in these fields are determined by the query template.

The concept of query languages is well known to persons of ordinary skill in the art. An example is however given. The query “Give the names of all men aged 99” is described by a query template with value “Give all name for which gender=1 and age=2”, in which the term shown in underlined italic describes the requested output of the query and the terms shown in italic (whether or not underlined) describe data types. The digits are placeholders for the value of query fields 1 and 2. The example query request consists of two query fields, field 1 with value “male” and field 2 with value “99”.

The contents of the query fields can be hidden from the mapper. To this end, the query terminals encrypt these fields for the relevant partial-databases. If a field is relevant to more than one partial-database, it is encrypted for each of these partial-databases separately. Given only the query template in a form readable by the mapper, the mapper may generally be assumed to be able to process the query, for a large class of queries.

When the mapper receives a query request, it first analyses the query template to determine if the query request is allowed by relevant agreements and applicable legislation. In determining which types of queries are allowed, the mapper may also takes into consideration, among possibly other things, related query requests that have been allowed in the past, and related query requests that will be allowed in the future. Finally it considers which kind of data needs to be communicated to and from the partial-databases involved. It is believed that a large class of queries can be processed in this way. In some cases it may be necessary to know the value of one or more query fields to be able to determine if a query-request is allowed. If it is undesirable that the mapper should learn the value of the query-fields, then it is envisioned that the query-request, the relevant query fields, and additional information regarding the database-system are submitted to an independent party that has no access to any of the information stored in the system, and that is trusted by both query terminal and mapper. This independent party can then determine for the mapper if the query is allowed.

The mapper responds to allowed queries by sending back a query answer. To solve a query request, the mapper processes the query template, and constructs query sub-requests. These query sub-requests are based on the data types used in the query template, the logical structure of the query template, and the fragmentation of the data in the partial-databases. Each query sub-request, like a query request 600, consists of a query template and zero or more query fields. The mapper submits these query sub-requests to the appropriate partial-databases. Each partial-database solves the received sub-query request locally (meaning: by only using locally-stored data), and sends a query sub-answer back to the mapper. Depending on the query template and the fragmentation of the data in the partial-databases, it is possible that the mapper has to construct query sub-requests using query sub-answers received as a response to previously submitted query sub-requests.

When the result of the last submitted query sub-request is received by the mapper, it constructs the final query answer, based on the data types used in the query template, the logical structure of the query template, and the received query sub-answers, and sends this answer to the query terminal.

Data in a query sub-answer can be hidden from the mapper. To this end, in the case that the data is used by the mapper in subsequent query sub-requests, the partial-databases hereto are requested to encrypt these fields for the respective partial-databases. In the case that the data is used by the mapper to construct the query answer, the partial-database is requested to encrypt the data for the appropriate query terminal. To enable the partial-database to encrypt data for a certain entity, the mapper supplies entity-identifying information to the partial-database. Encrypting data for the assumed recipient also ensures that no entity can successfully assume the identity of another entity and request data in that entity's name.

Depending on operational and legal relations between mapper and partial-database, each partial-database may decide to answer a request or not when it receives a query sub-request, based on the query sub-request, using the same method as the mapper. Also, in cases where no encryption of data was requested by the mapper, the partial-database may still decide, (again, possibly based on the query sub-request), to encrypt the data.

3e. A Query Example

Turning to FIG. 7, we will now give an example of the query process as performed in the first preferred embodiment. It will be appreciated that the example was chosen so that it can be used by a person of ordinary skill in the art as the basis for generalization to other queries.

By applying a total of p add-record processes shown in FIG. 5, the update terminal has stored p records in the system. These records hold identifying information of a set of people. The records were fragmented in two parts. One fragment, holding the name information, is stored by partial-database 321. The other fragment, holding the address information, is stored by partial-database 322. Information regarding the fragmentation (who stores what type) is public. As a result of the add processes, the mapper has stored p data-elements 202, and the partial-database 321 and 322 each have stored p data-elements 400.

In FIG. 7 the process steps executed by the apparatus involved in the example query are shown. The process starts with step 701. The query terminal first constructs the query request. We consider the following query template: “For person name=1: does the name occur in the address?”. We assume that this query is expressed correctly in the query language used by all parties, as we do for all following queries. The template is accompanied by one query field, holding two values: the value “Smith” encrypted by the query terminal 331 for partial-database 321, and the same value (“Smith”) encrypted by the query terminal 331 for partial-database 322. Next, the query template and query field are sent to the mapper 200, in message 702. Upon receipt of the message, the mapper starts execution of step 703. It analyses the validity of the query (for accordance with relevant query policy, agreements and legislation). In this example we assume that the query is allowed. The mapper continues with step 704 in which it constructs the first query sub-request. This request consist of a query template with value “Give the fragment identifier of name=1” and a query field, copied from the original query request, with value “Smith” encrypted for partial-database 321. It then sends this query sub-request to partial-database 321, in message 705. Upon receipt of this message the partial-database 321 starts the execution of step 706. It analyses the validity of the query sub-request. In this example we assume that the query sub-request is allowed. It continues with step 707 in which it constructs the query sub-answer. It decrypts the query field to reveal the value “Smith” and searches the set of locally-stored data-elements 400, until it finds a data-element with a field 401 that has the value “Smith”. We assume that it finds such a data-element. From the field 402 of this data-element it copies the fragment-identifier, say P′.sub.x, and sends it to the mapper 200 in message 708. Upon receipt of this message the mapper starts execution of step 709. It processes the query sub-answer, and stores the received fragment-identifier. Next it continues in step 710 by constructing a second query sub-request. This request consists of a query template with value “Give all fragment identifier of which name=1 occurs in address” and a query field, copied from the original query request, with value “Smith” encrypted for the partial-database 322. It then sends this query sub-request to partial-database 322, in message 711. Upon receipt of this message, the partial-database 322 starts the execution of step 712. It analyses the validity of query sub-request. In this example we assume that this query sub-request is allowed. It continues with step 713 in which it constructs the query sub-answer. It decrypts the query field to reveal the value “Smith” and searches the set of locally stored data-elements 400, until it finds a data-element that has a field 401 in which “Smith” occurs. We assume that it finds three of such data-element. From the field 402 of these data-elements it copies the fragment-identifiers, say P′₁,P′₂ and P′₃, and sends them to the mapper 200 in message 714. Upon receipt of this message the mapper 200 starts the execution of step 715. It processes the query sub-answer, and stores the received identifiers. It continues in step 716 by constructing the query answer. The mapper searches the locally-stored data-elements 202 for an occurrence of P′ₓ and one of P′₁,P′₂ and P′₃ in the same fields 204. If an occurrence is found, it can be concluded that the answer to the query is “Yes”, otherwise the answer is “No”. The query-answer is sent to query terminal 331 in message 717, and the received fragment identifiers are discarded by the mapper. Upon receipt of this message the query terminal 331 starts execution of step 718, in which it processes the query-answer. Finally, the query process terminates in step 719.

In the above exposition of the example query some assumptions are made regarding validity of request and occurrences of data in the databases. The alternative flow of the process in cases where one or more of the assumptions are not met, will be obvious to a person of ordinary skill in the art.

As illustrated in the example given above, the mapper fully controls de-fragmentation of stored data. However, it may be noted that the data can be accessed in fragmented form, without involvement of the mapper. This is no threat to protection of sensitive information offered by the system, since the data fragmentation is chosen with this in mind (preventing each partial-database from holding sensitive data). Moreover, the information stored in a partial-database may be of value in providing statistical information.

3f. Changing Data Fragmentation

As will be appreciated the fragmentation of data can be altered, when stored according to the descriptions given above. If all involved parties (that operate partial-databases and mapper) cooperate, and only then, data can be retrieved from the system de-fragmented, and subsequently stored in non fragmented form or re-fragmented differently.

It will be clear to persons of ordinary skill in the art that each party operating a partial-database, by itself, can apply the present inventive techniques to further fragment the data stored at that party.

3g. Combining Database Systems

The inventive techniques described above can be applied when merging existing databases. When databases are merged, certain relations between records in the respective databases are identified. These identified relations can subsequently be used in queries in the new database; they form the surplus value of the merged database over the two individual databases. However, for legal reasons, reasons of security and privacy or other reasons it may not be allowed or desired to merge the databases into one database in a straightforward way. These restrictions can be overcome by distributing the access-control over multiple parties (i.e., introducing one or more mappers) and storing the fragmented data as proposed above. After the new database system is started and the desired fragmentation is decided, all data from both databases is stored unaltered, but fragmented, in the new system. Both databases perform the role of update terminal, and execute the above-described add-record process for all records. Secondly, data-fragments originating from the respective databases have to be linked according to one or more relations. Hereto the mapper of the new system initiates queries over the stored fragments regarding these relations, to which the partial-databases respond in a similar way as in the query-record process described above. The responses of the partial-databases are used by the mapper to store links between the corresponding fragment-identifiers. The process, (referred to as grouping of data-fragments), of performing certain fixed queries, by the mapper, prior to queries from the query terminal, will be described in detail below. To process query-requests submitted by the query parties of the new system, the mapper will use the links that resulted from the pre-queries when constructing query sub-requests and interpreting the query sub-answers.

It will also be appreciated that databases that are constructed using the present inventive techniques can only be totally merged when all involved partial-databases and the mapper agree to such a merge.

3h. Improvements And Extensions

To prove authenticity of messages and to allow disputes to be resolved, all messages may be supplied together with digital authentication (signatures). Additionally, a digital receipt may be supplied to the sender of a message by the receiving party. Digital signatures and receipts are well-known types of public key signatures well-known in the art.

In the description of the three processes above, the update, query and partial-databases apply encryption to hide data from the mapper. If no countermeasures are taken, encrypted data may be recognized when it passes a party. Although encrypted data cannot be read, recognizing occurrences of the same data can reveal information. Various methods to hide both the content, and the occurrence of data, are known in the literature, such as for example the addition of some varying, redundant information (‘noise’) to the data before encryption, in a way that allows removal of the noise after decryption.

Instead of sending data (encrypted) via the mapper, it may be preferable in some instances, for reasons of efficiency and security, to send the data (to be hidden) over an alternative channel directly to the recipient. When, additionally, the (encrypted) data in the data fields of the above-mentioned messages is replaced by placeholders, it is believed that the same functionality as described above can be achieved.

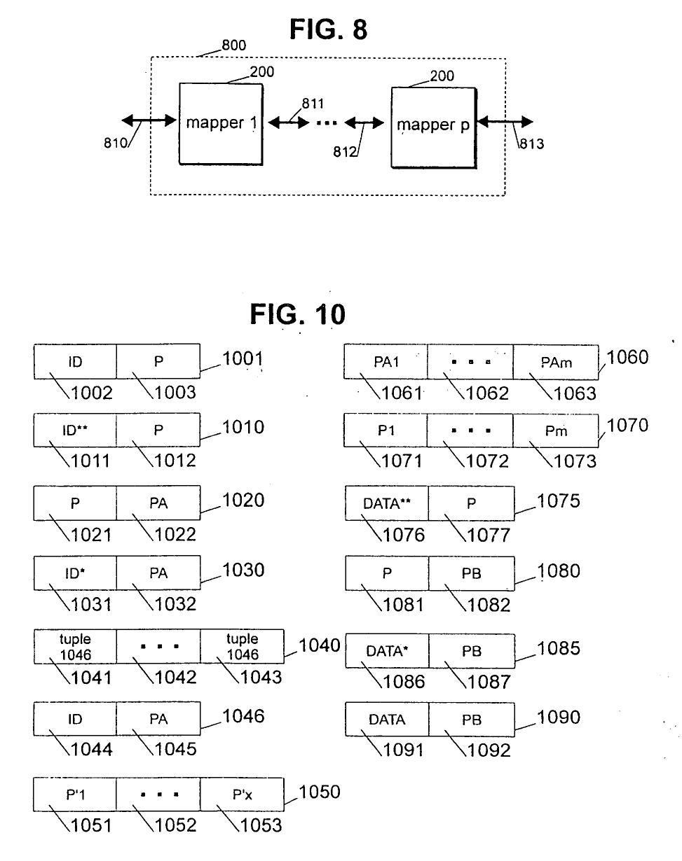

In the same way that mixes can be replaced by mix-cascades, the mapper 200 can be replaced by a mapper-cascade. FIG. 8 shows such a mapper-cascade. The box 800 represents two or more mappers 200. For clarity, only two are shown. Each mapper can communicate with its neighbors in the cascade. For clarity, only two communication channels are shown, 811 and 812. The communication channel 810 of the first mapper in the cascade corresponds to the communication channels 340,341,344 and 345 of the original (replaced) mapper. The communication channel 813 of the last mapper in the cascade correspond to the communication channels 342 and 343 of the original (replaced) mapper. The functionality of each of the mappers in the cascade is identical to the functionality the original (replaced) mapper 200 described above. It is envisioned that each mapper in a mapper-cascade is operated by a different trusted third party. The cascading of mappers allows the introduction of the desired number of data protecting parties. It will be obvious to a person of ordinary skill in the art how to extend the operations described above to a system that includes a mapper-cascade. To ensure that none of the mappers is by-passed, the data submitted by the update terminals may be encrypted successively for all respective mappers.

It will be appreciated that some efficiency improvements, obvious to those of ordinary skill in the art, can be applied. For instance, instead of sending all fragments from a single record in a single message, to identify records (when presented fragmented) record identifiers can be introduced. The correspondence between the fragment identifiers P.sub.x and P′.sub.x does not have to be stored, if the mapper constructs P′ₓ from Pₓ in a fixed, reproducible and reversible way.

### 4. DETAILED DESCRIPTION OF A SECOND EMBODIMENT

We continue with a detailed description of a second preferred embodiment of the inventive techniques, that builds on techniques described above. This embodiment is believed to be an efficient implementation of a special case of the first preferred embodiment, extended to offer additional functionality. We describe a dossier system in which dossiers on individuals are stored. In this example each dossier contains medical records relating to an individual, which are updated and used by various financial structures. It will be appreciated that the choice of a wagering resource dossier-system is arbitrary. It is chosen to expose the present inventive techniques and should not be viewed as any limit of their scope. Other applications in which the inventive techniques can be applied are easily envisioned, such as systems that store dossiers holding information other than medical information, and systems that store dossiers on entities other than individuals, for example, but without limitation, groups of individuals, organizations or legal entities.

4a. Overview

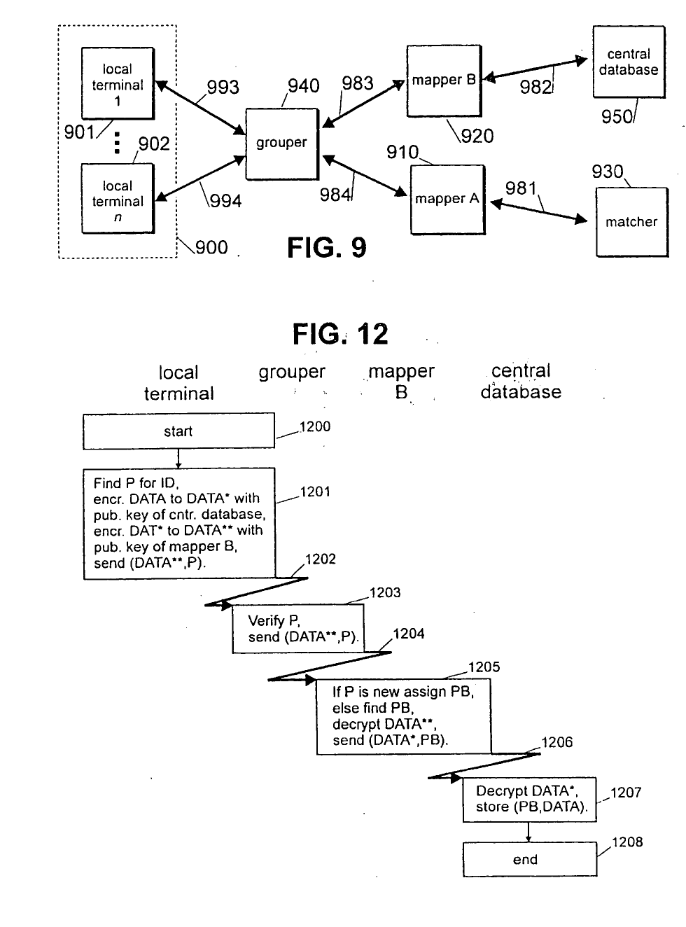

Turning now to FIG. 9, a description of the respective entities and their interconnections in a proposed medical dossier-system is given. The entities that supply, refresh and use information stored in dossiers are referred to as local terminals. Box 900 represents one or more local terminals. The number of local terminals is denoted n. Only two are shown for illustrative purposes, numbered 901 and 902. Each local terminal fulfills a role corresponding to both an update terminal 300 and a query terminal 330 (see FIG. 3).

Data access is controlled jointly by three entities. The functionality of each of these entities will be clear from the descriptions of various processes given below. The first entity 910 is referred to as mapper A, the second entity 920 is referred to as mapper B, and the entity 940 is referred to as the grouper. As will be clear from the exposition below, their joint functionality can be seen as an extension to the functionality of the mapper 200. It is envisioned that these three entities are operated by one or more trusted third parties.

In this second preferred embodiment, the stored information is again fragmented vertically. The system comprises two partial-databases, each with a distinct functionality. The first partial-database 930 (the matcher) holds individuals' identifying information (the part of a medical record that refers to the real-life identity of an individual), the other partial-database 950 (the central-database) holds only medical information (the actual medical data without reference to real-life identities). The functionality of these entities corresponds to functionality of the partial-databases 320 of FIG. 3.

Each of the n local terminals 900 can exchange messages directly with the grouper 940. For clarity, only the communication channels for local terminals 1 and n are shown, numbered 993 and 994. Mapper A 910 can exchange messages directly with matcher 930 using communication channel 981, and with grouper 940 using communication channel 984. Mapper B 920 can exchange messages directly with grouper 940 using communication channel 983, and with the central-database 950 using communication channel 982. When requested, all apparatus will forward messages to enable apparatus that are not directly connected to exchange information.

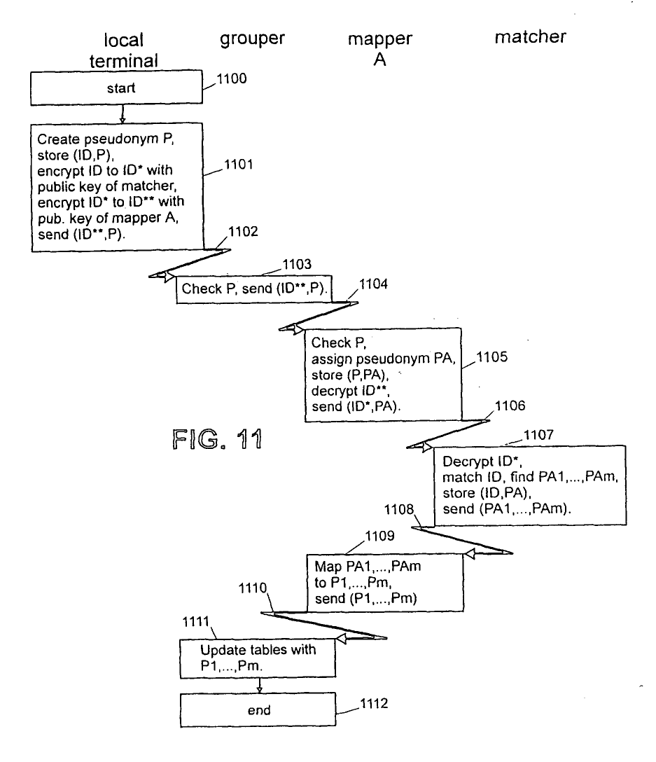

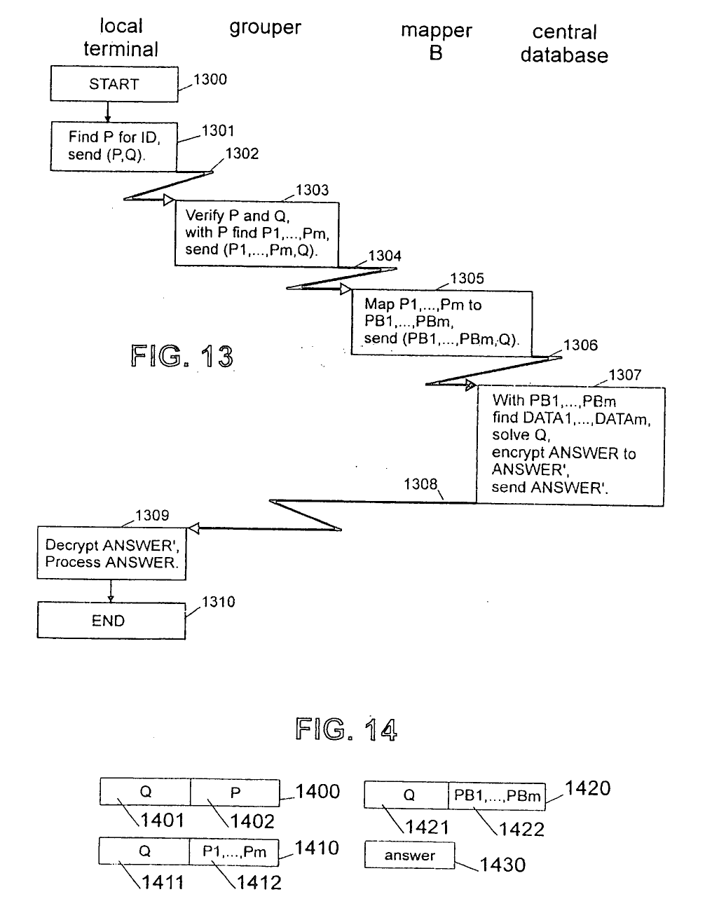

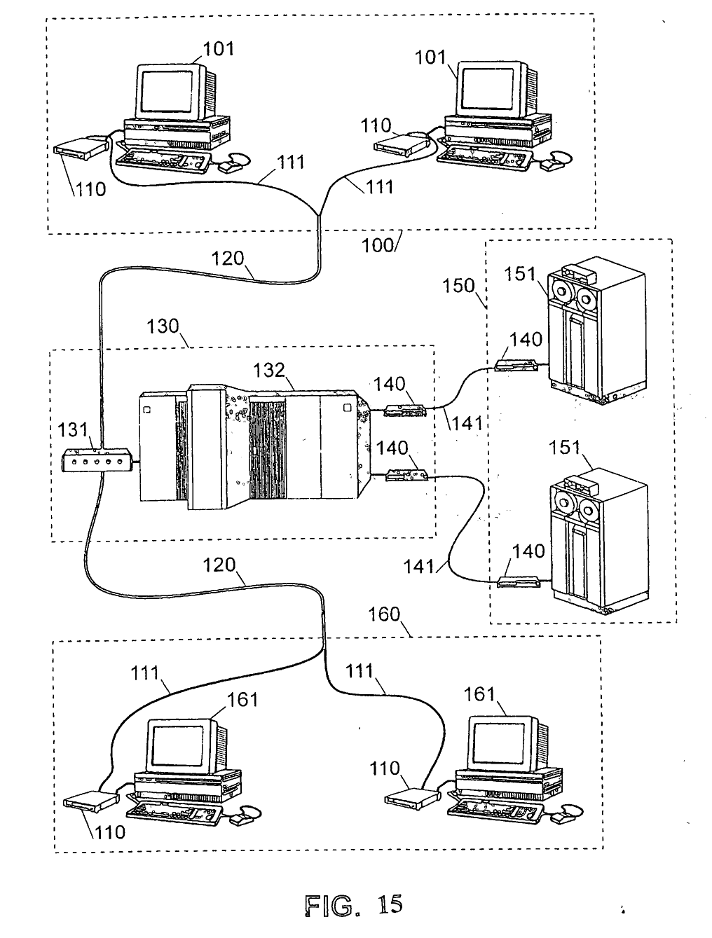

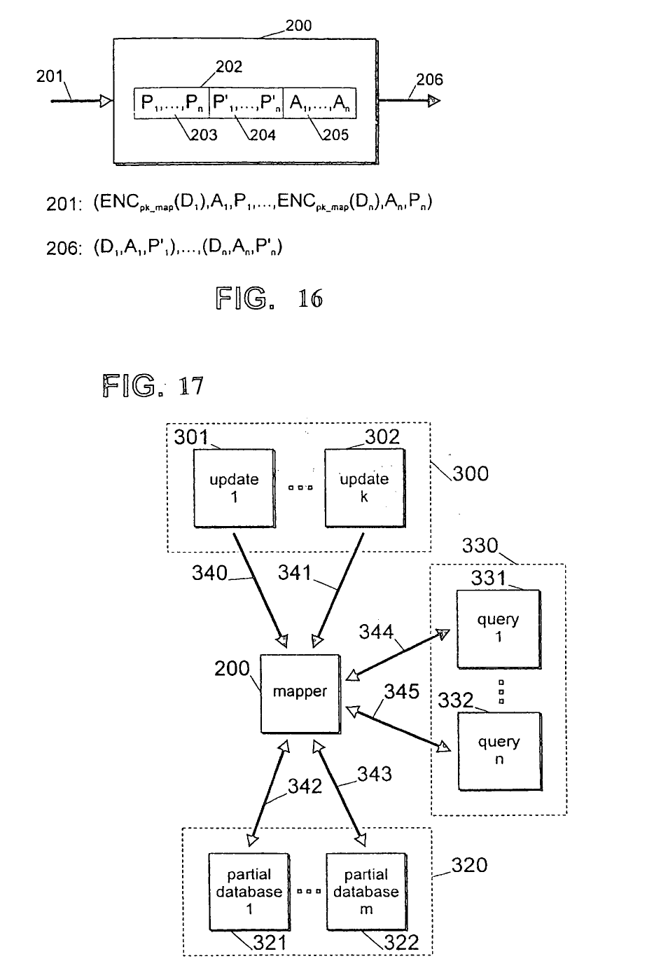

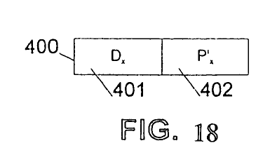

Three basic operations are supported: link-dossier, update-dossier and query-dossier, shown in FIG. 11, FIG. 12 and FIG. 13 respectively. FIG. 10 shows the data-objects related to the link-dossier and update-dossier operations. FIG. 14 shows the data-objects related to the query-dossier operation.

As already mentioned in relation to the first preferred embodiment, depending on the application of the invention and on the jurisdictional domain in which it is operated, certain legal restrictions may apply to the operations and/or results thereof. Additional restrictions may be laid down in agreements between the local terminals, the grouper, the mapper A, the mapper B, the matcher and the central-database.

4b. The Link-Dossier Operation

The local terminal has to perform the link-dossier operation for a certain individual before it can perform any other operation regarding that individual. Turning to FIG. 11, the link-dossier operation is described in detail. When a local terminal wants to create a link to the dossier of a certain individual, it starts the process at 1100. We assume that this local terminal obtained identifying information from the individual beforehand. Prior to this operation, agreements have been made within the system that define the form of acceptable identifying information. This identifying information consists of, but is not limited to: for example, the name, the address, the date of birth, the place of birth and/or the social security number of the individual. We will refer to the obtained identifying information as ID.

In step 1101, the local terminal assigns to ID a new, unique, identifier which we will refer to as pseudonym P. This pseudonym should be chosen so it cannot be linked to the identity by anything other than the local terminal. In this respect, for instance, a previously unused, randomly generated integer can be used. The local terminal constructs a data-object consisting of two fields, from now on referred to as a tuple, that has a structure shown in 1001. The field 1002 is assigned the value ID and the field 1003 is assigned the value P. It then stores this tuple. Next the local terminal constructs a data-object that has a structure shown in 1010. The field 1012 is assigned the value P. The field 1011 of this tuple is assigned the value ID**, a doubly encrypted version of ID. The value ID** is created as follows. To hide it for the grouper and mapper A ID is encrypted with the encryption key of the matcher. To ensure that mapper A is not by-passed, the result ID* is encrypted again, this time with the encryption key of the mapper A, resulting in ID**. Finally, this tuple 1010 is sent to the grouper in message 1102.

Before the current link-dossier operation started, the grouper will have stored a set of zero or more data-objects. These data-objects are of a structure shown in 1050. This is a set holding one or more pseudonyms previously accepted from one of the local terminals. For clarity, two pseudonyms are shown, 1051 and 1053. Field 1052 represents the remaining pseudonyms. Upon receipt of the message 1102 the grouper executes step 1103. It checks if the pseudonym P, taken from field 1012 of the received tuple 1010, is a new pseudonym, unique to the grouper, by verifying if it does not occur in any of the stored sets 1050. If it does occur, the operation is aborted. Otherwise, the grouper forwards the tuple 1010 to mapper A, in message 1104.

Before the current link-dossier operation started, the mapper A will have stored a set of zero or more data-objects of a structure shown in 1020. The field 1021 holds a pseudonym previously accepted from one of the local terminals. The field 1022 holds a pseudonym previously assigned by mapper A. Upon receipt of message 1104 the mapper A executes step 1105. It checks whether the pseudonym P, taken from field 1012 of the received tuple 1010, is a new pseudonym, unique to mapper A, by verifying that it does not occur in any field 1021 of all tuples 1020 stored by the mapper A. If it does occur, the operation is aborted. Otherwise, mapper A generates a new, unique pseudonym PA. Similar to the creation of pseudonym P this pseudonym should be chosen so that it cannot be linked to the identity by anything other than the mapper A. This pseudonym is linked to the received P by creating and storing a data-object 1020. The field 1021 is assigned the value P, and the field 1022 is assigned the value PA. Next, mapper A constructs a data-object of a structure shown in 1030. The field 1031 is assigned the value ID*, which mapper A re-creates from the received tuple 1010 by decrypting the value ID** of field 1011. Field 1032 is assigned the value PA. Finally, mapper A sends the tuple 1030 to the matcher in message 1106.

Before the current link-dossier operation started, the matcher has stored zero or more data-objects. These data-objects are sets of a structure shown in 1040. Each set 1040 contains zero or more tuples. Two of these tuples, 1041 and 1043, are shown for clarity. The remaining tuples are denoted by 1042. Each tuple has a structure shown in 1046, consisting of a field 1045 holding a pseudonym previously accepted from the mapper A, and a field 1044 holding corresponding identifying information previously received from one of the local terminals (via the mapper A). Upon receipt of message 1106 the matcher executes step 1107. It verifies if PA (taken from field 1032 of the received tuple 1030) is a new pseudonym, unique to the matcher, by checking if it does or does not occur in any of the pseudonym fields 1045 of all the tuples 1046 of all sets 1040 stored by the matcher. If it does occur, the operation is aborted. Otherwise, the matcher re-creates ID from message 1106, by decrypting ID* taken from field 1031 of the received tuple 1030. Next, for all stored sets 1040 the matcher compares the retrieved ID with the values of all the identifying information fields 1044 of all tuples 1046 of that set. If ID matches with a set of identifying information fields 1044, a tuple 1046 is added to that set. The identifying information field 1044 of this added tuple is assigned the value ID, and the pseudonym field 1045 is assigned the value PA. Otherwise, if ID does not match with any of the sets 1040, a new set 1040 is created, holding one tuple 1046 of which the identifying information field 1044 is assigned the value ID, and the pseudonym field 1045 is assigned the value PA. (It may be noted that identifying information does not have to be equal to match. The definition of a ‘match’ falls outside the scope of the present technology. Many matching techniques that can be automated are known in the literature. It is envisioned that for some applications manual matching may be needed in ambiguous situations.) Next, the matcher constructs a data-object of a structure shown in 1060. This is a set that holds one or more pseudonyms. For clarity, two fields are shown, 1061 and 1063. The remaining fields are denoted by 1062. The set 1060 is constructed by copying all the pseudonyms stored in the fields 1045 of all tuples 1046 into the set 1040 that contains ID. After it is constructed, set 1060 consists of m pseudonyms, denoted by PA1, . . . , PAm, all relating to ID. Finally, the matcher sends set 1060 to mapper A, in message 1108.

Upon receipt of this message the mapper A executes step 1109. It constructs a data-object of a structure shown in 1070. This is a set that holds one or more pseudonyms. For clarity two fields are shown, 1071 and 1073. The remaining fields are denoted by 1072. The set 1070, that is initially empty, is constructed as follows. For each of the pseudonyms PA1, . . . , PAm (from the received set 1060) the mapper A searches all stored tuples 1020. When it finds a tuple 1020 that holds the searched pseudonym in field 1022, it adds to set 1070 the pseudonym held in the field 1021 of this tuple. This search will result in a set 1070 holding m pseudonyms, denoted by P1, . . . , Pm. Finally, this set 1070 is sent to the grouper in message 1110.

Upon receipt of this message the grouper executes step 1111. The grouper updates its set of data-objects 1050. If pseudonym P is the only element in the received set 1070, a new set 1050 is created and stored, with one field that is assigned the value P. Otherwise, if P is not the only element in the received set 1070, the grouper searches the stored sets 1050 for a set of pseudonyms that matches the set P1, . . . , Pm, except for P. It is assumed that this set is always found in this case. This set is then replaced by a set P₁, . . . , Pm, which includes the new pseudonym P.

Step 1112 ends the operation of the link-dossier operation. With the operation described above, the local terminal that initiated the operation has created a link to the dossier stored in the system of the individual described by ID. The pseudonym P is the handle of this link. As will be clear from the detailed descriptions of the update-dossier and query-dossier operations below, updates of medical data regarding the individual, submitted to the system by the local terminal using the pseudonym P will subsequently be available to all local terminals, barring applying regulations. Also, in subsequent query-dossier operations regarding the individual submitted to the system by the local terminal using the pseudonym P, all medical data regarding the individual submitted to the system by all local terminals will be available to the local terminal, barring applying regulations.

It may be noted that an individual cannot be expected to give exactly the same ID on different occasions, for various reasons, including the fact that an ID is expected to change over time. Matching techniques are available, and well-known in the art, that are powerful enough to match various identifications of the same individual to each other, and to not match various identifications of different individuals to each other, both with a high degree of precision. Using these matching techniques, it is believed that multiple executions of the above described link-dossier operation regarding the same individual will result in linking to the same dossier, and that multiple executions of the above-described link-dossier operation regarding different individuals will not result in linking to the same dossier, both with an equally high degree of precision.

4c. The Update-Dossier Operation

For a local terminal to be able to execute an update-dossier operation regarding an individual, it first must have performed the link-dossier operation, shown in FIG. 11, regarding this individual.

Turning now to FIG. 12, the update-dossier operation will be described. This operation comprises updating the central-database by a local terminal by adding medical data to an individual's dossier. It will be appreciated that in many applications other update operations will be supported by the central-database as well (changing, merging and/or removing of data). It is believed that all types of update-operations can be performed in a way similar to the mechanism given below.

The process starts at step 1200, executed by the local terminal. It is assumed that this local terminal has obtained the right real-life identity ID of the individual, and that it wants to update this individual's medical dossier with information to which we will refer to as DATA. In step 1201 the local terminal searches the stored tuples 1001 to find the pseudonym P corresponding to ID. If a link-dossier operation has been performed previously for that ID, such P is normally found among the stored tuples. To hide it from the grouper and mapper, the local terminal encrypts DATA with the encryption key of the central-database. To ensure that mapper B is not by-passed in the update-dossier operation, the result of this encryption, DATA*, is encrypted again, this time with the encryption key of mapper B, resulting in DATA**. Next, the local terminal constructs a data-object of a structure shown in 1075. Field 1076 of this tuple is assigned value DATA**, and field 1077 is assigned the value P. Finally, the local terminal sends the tuple 1075 to the grouper 940 in message 1202.

Upon receipt of this message the grouper executes step 1203. It first verifies if P is an allowed pseudonym, by searching all stored sets 1050 for an occurrence of P. If a link-dossier operation has been performed previously for this ID, such P is normally found in the stored tuples. If no occurrence is found, the operation is aborted. Otherwise, the grouper forwards the message containing the tuple 1075 to mapper B in message 1204. It will be clear from the exposition below, that in update operations that affect data already stored in the dossier, the grouper will concatenate to the tuple 1075 (part of) the set of pseudonyms related to P, that is, (part of) the set of pseudonyms stored in the set 1050 that contains P. This extension, as will be obvious to a person of ordinary skill in the art, allows all common types of updates to a dossier.

Before execution of the update-dossier operation the mapper B will have stored a set of zero or more data-objects of a structure shown in 1080. The fields 1081 of these tuples contain pseudonyms previously received from the grouper. The fields 1082 of these tuples contain corresponding pseudonyms previously assigned by the mapper B. Upon receipt of the message 1204 the mapper B executes step 1205. It first verifies if the pseudonym P, received in message 1204, has been previously received, by searching the fields 1081 of all stored tuples 1080. If it finds a tuple with an occurrence of P, it reads the corresponding pseudonym PB from the field 1082. Otherwise, it creates and store a tuple 1080 of which the field 1081 is assigned the value P, and the field 1082 is assigned a new pseudonym PB, unique to mapper B. Similar to the creation of pseudonym P this pseudonym should be chosen so it cannot be linked to the identity by anything other than the mapper B. Next, it constructs a tuple of a structure shown in 1085. It assigns the pseudonym PB to field 1087. It then decrypts DATA**, from the received tuple 1075, and assigns the result DATA* to field 1086. Finally, it sends tuple 1085 to the central-database in message 1206.

Before execution of the update-dossier operation the central-database will have stored a set of zero or more data-objects of a structure shown in 1090. The field 1092 of this tuple contains a pseudonym previously received from the mapper B. The field 1091 of this tuple contains wagering data or wagering resource data, corresponding to the pseudonym, received during an update-dossier operations previously performed by a local terminal. Upon receipt of the message 1206, the central-database executes step 1207. It retrieves DATA by decrypting DATA*, received in tuple 1085. It then verifies if the pseudonym PB, received in message 1206, has been previously received, by searching the fields 1092 of all stored tuples 1090. If it finds a tuple with an occurrence of PB, it will add DATA to the corresponding wagering data or wagering resource data stored in the field 1091 of this tuple. Otherwise, it will construct and store a new tuple 1090, and assign the value PB to the field 1092, and the value DATA to the field 1091.

This ends the update-dossier operation (see 1208).

It will be appreciated that the data is stored at the central-database linked to a pseudonym, and that a player will have a different pseudonym at each wagering site. As a result this database has a degree of horizontal fragmentation.

4d. The Query-Dossier Operation

For a local terminal to be able to execute a query-dossier operation regarding an individual, it must first have performed the link-dossier operation, shown in FIG. 11, regarding this individual.

Turning now to FIGS. 13 and 14, the query-dossier operation is described. This operation comprises querying of an individual's wagering/ledger dossier, by one of the local terminals, a wagering site or financial structure dossier regarding an individual.

The process starts at step 1300, executed by the local terminal. It is assumed that this local terminal has obtained the real-life identity ID of the individual. The local terminal queries this individual's wagering/financial dossier by submitting a query-request to the grouper. This query-request consist of a query template and zero or more query fields. For brevity we omit these details here, and refer to the description given in relation to FIG. 7. During the query-dossier operation, the query template and respective query fields are handled in a way similar to the process described in relation to FIG. 7. The query-request is referred to as Q. In step 1301 the local terminal searches the stored tuples 1001 to find the pseudonym P corresponding to ID. If a link-dossier operation has been performed previously for that ID, such P is normally found in the stored tuples. Next, the local terminal constructs a data-object of a structure shown in 1400, and assigns the value Q to field 1401, and the value P to field 1402. (Not shown here for clarity is the hiding for the grouper and mapper of the data in the query-fields. A description of the hiding mechanism has already been given above in relation to FIG. 7.) Finally, the local terminal sends the tuple 1400 to the grouper, in message 1302.

Upon receipt of this message the grouper starts execution of step 1303. It first verifies if P is an existing pseudonym, by searching all stored sets 1050 for an occurrence of P. If one of more link-dossier operations have been performed previously for ID, one such P is normally found in the stored tuples. If no occurrence is found, the operation is aborted. Otherwise, the grouper starts analyzing the query. It first verifies the validity of the query, in a fashion similar to that described in relation to FIG. 7. It will be appreciated that, as a result of the above described link-dossier and update-dossier operations, each of the pseudonyms stored in the set 1050 that contains P corresponds to a part of the dossier on individual ID stored in the central-database by the local terminals. Based on, (among other things), which local terminal stored a part of a dossier and the type of that part, the grouper determines which parts of the dossier are relevant to the submitted query-request. It is believed that a large class of queries can be analyzed this way by the grouper. The grouper constructs a data-object of a structure shown in 1410, and assigns the value Q to the field 1411. We assume that there are m relevant parts, and refer to the corresponding pseudonyms as P₁, . . . , Pm. Field 1412 is assigned this set. Finally, the tuple 1410 is sent to mapper B in message 1304.

Upon receipt of this message the mapper B executes step 1305. We assume that it accepts all submitted query-requests. Alternatively, it can perform a validity check on the query-request as described in relation to FIG. 7. The mapper B constructs a data-object of a structure shown in 1420, and assigns the query-request Q to the field 1421. It constructs an, initially empty, set of pseudonyms by replacing all pseudonyms from the field 1412 of the received tuple 1410 with the corresponding pseudonyms. For each of P1, . . . , Pm, it searches the fields 1081 of the set of stored tuples 1080. If an occurrence of a pseudonym in a field 1081 is found, the mapper B adds the corresponding pseudonym, read from the field 1082, to the set in construction. This results in a set of m pseudonyms, referred to as PB1, . . . , PBm. This set is assigned to the field 1422 of tuple 1420. Finally, it sends the tuple 1420 to the central-database, in message 1306.

Upon receipt of this message the central-database executes step 1307. The central-database searches in the set of stored tuples 1090, to find the tuples 1090 that have as value in the field 1092, one of the pseudonyms PB1, . . . , PBm, received in message 1306. The wagering data or wagering resource data stored in the fields 1091 of these tuples is used to construct a query-answer to the query-request Q, received in message 1306. A data-object of a structure shown in 1430 is constructed to hold the query-answer. To hide the content of the query-answer for the mapper B and the grouper, it is encrypted for the local terminal, and the result is assigned to 1430. Finally, the central-database sends 1430 to the mapper B, who forwards it to the grouper, who forwards it to the local terminal. This message flow is depicted by 1308.

Upon receipt of the message 1308 the local terminal executes step 1309. It decrypts the query-answer, and processes it. Step 1310 ends the query-dossier operation. As will be clear from the description of the query-dossier operation given above, the matcher is not involved in the process. Considering that the matcher is the only entity other than the local terminal that contains identifying information, no party other than the party operating the local terminal knows the identity of the person whose dossier is queried. The information which local terminals may accumulate regarding query frequencies is limited to the queries which they submit. It is believed that, unless multiple parties collude, no party accumulates information regarding the query frequency related to an individual.

4e. Security

Since it is the object of the presented system to store records fragmented, and subsequently control de-fragmentation, the system can be considered successfully attacked when part of the records are de-fragmented without appropriate authorization. Two types of attacks against the system are envisioned.

In a static attack (part of) the stored data is used by one or more parties outside the system and/or some colluding parties within the system. Since the problem of protecting (physically or logically) a single database against unauthorized access is not particular to the present invention we will not discuss it here. However, it is believed to be more difficult to gain unauthorized access to all data in a database when the data is divided over multiple (physically or logically) different partial-databases, as in the present invention. In the case that information from the grouper or one of the mappers is not available, no data can be de-fragmented at all. It is believed that by selecting a specific number of trusted third parties to run the grouper and mappers any desired degree of protection against static attacks can be achieved.

In a dynamic attack an adversary tries to gain information by observing or modifying the operations performed by the apparatus of the system. However, the apparatus of the involved parties are considered to be protected against abuse, and messages between various apparatus are encrypted to shield their content from eavesdroppers, leaving only the observation of message-activity between various parties to the adversary. The above-referenced paper by Chaum, describes counter measures against such observations (referred to as traffic analyses). These measures include processing messages in batches and introducing dummy messages. It will be obvious to persons with ordinary skill in the art, how to modify the operations described above (link-dossier, update-dossier and query-dossier operations) to include these protection mechanisms.

4f. Improvements And Extensions

In addition to the improvements and extensions already mentioned in relation to the first preferred embodiment and security issues, the following improvements and extensions are envisioned. By regarding the mapper B 920 as both an update terminal (300, see FIG. 3) and query terminal (330, see FIG. 3), the mechanisms disclosed in the description of the first preferred embodiment can be applied to the central-database 950 of the second preferred embodiment, resulting in vertically fragmented storage of the wagering data or wagering resource data.

As will be appreciated, if a local terminal wants to use a new pseudonym for a certain individual known already to that local terminal under a different pseudonym, the local terminal may execute another link-dossier operation as described above with the new pseudonym. All future accesses by the local terminal to the wagering data or wagering resource dossier of this person can be done using either the old or the new pseudonym. By using more pseudonyms for an individual, the horizontal fragmentation of the central-database is enhanced. In principle, every update of the central-database could be done using a new pseudonym, thereby achieving a maximum degree of horizontal fragmentation.

Furthermore, the grouper may create a ‘super-pseudonym’ for each set 1050 of corresponding pseudonyms. As a consequence, each access to the central-database requires only that a single pseudonym is communicated from the grouper to the central-database through the mapper B, instead of a list of pseudonyms. Although this increases efficiency, this is believed to destroy the horizontal fragmentation in the central-database.

In certain applications it may be acceptable to remove one of the mappers, mapper A or mapper B. If both mappers are removed, no third party would be able to prevent the matcher and central-database from de-fragmenting the stored data (link the identifying information to the wagering data or wagering resource records). It is believed that removal of mapper A, and the corresponding changes obviously required in the operations described above, will not affect the described functionality and features of a system constructed in accordance with the present inventive techniques, except in the case of a collusion between the grouper and the matcher, in which the query frequency relating to an individual may be revealed. Similarly, it is also believed that removal of mapper B, and the corresponding obvious changes required in the described operations need not affect the described functionality and features of a system constructed in accordance with the present inventive techniques, except in the case of collusion between the grouper and the central-database, in which circumstances existing horizontal fragmentation in the central-database may be removed.

### She-Tips™ Performance

The She-Tips™ wagering system may be independent of the ledger-based, opaque financial structure described above, or it may be integrated with that wagering structure/financial support system. The She-Tips™ wagering system may input the wagers through conventional accounting systems through hubs, totalisator systems, direct track access, and the like, or preferably according to the benefits described above for the ledger based access system, through the ledger-based, opaque wagering system described above.

1.1 Administrators Can Remove Customer Account

A consumer account can be made inactive and certain information (credit card number, address, etc.) deleted.

For reporting, key information (mobile, transaction records) will not be deleted. The administrator can add a note describing why the consumer is being removed. Cannot remove a consumer who has unpaid transactions (i.e., if the customer exceeds their paid airtime).

Administrators register customers. An administrator shall be able to register a customer, based on information filled out in a card booklet.

1.2 Airtime Pricing

Prepaid monthly:
Chat 10 $50/10 minutes ($5/minute)
Chat 20 $90/20 minutes ($4.5/minute)
Chat 30 $120/30 minutes ($4.00/minute)
Chat 300 $1000/300 minutes ($3.33/minute)
   Overruns post-paid after the call at $5 a minute. Packages are good for 1 month from date of purchase and are automatically rebilled. Phone time will be rounded up to the next minute.
   1.3 Billing System

The billing system will pick up information from the phone system and will generate transactions for airtime. The billing system will also bill for picture viewing, tips, etc. The pricing schedule for various services (airtime rates, picture rates, etc) can be changed (under the control of an administrator). The billing system will produce reports to export data to the accounting system. The billing system will support 2 types of pricing models:
subscription based pricing
   flat-rate monthly fee for services
event-based pricing
   $/minute for speaking with a tipping agent
   $/call for listening to live races (what is this??)
      1.4 Calls to AWP Will Be Recorded

All calls to an account wagering provider will be recorded. This will be done to facilitate reconciliation and is a manual process. Consumer auto-provisioned with AWP. A user can be automatically registered (auto-provisioned) with an account wagering provider when they register with the system. Alternately, an AWP can query the system for a user's registration information (but how will we ‘authenticate’ the request so that someone doesn't use someone else's account!). Consumer can enter complaint on website. A customer should be able to enter a complaint on the website, through a form which will be emailed to an administrator. Customers must log in to access this form. There will also be an email address which they can send an email to. Users will not have to be logged in to see this email link. Consumer landing page after logging in. After consumers log in to the public website they should see a page with the ECash™ account balance, airtime remaining and have the option of topping up their account. Consumer manages ECash™ account on IVR

A consumer, using IVR prompts, manages their own account. Consumer can pick a package (Bronze, Silver, Gold, Platinum). If e-cash account balance is insufficient, system debits credit card, credits E-Cash™ account. E-Cash™ account is then used to add phone minutes to the system. Consumer shall be able to add a specified dollar amount to the E-Cash™ account (have having their credit card charged and a like amount transferred to the e-cash account). Consumer shall also be able to get account balance.

1.5 Consumer News Alerts

News alerts will be sent to consumers who have opted for them. Alerts include:
notification of events
generic messages' from the company
   1.6 Consumer Registers/Updates Profile

Consumers can register on the public website.

They will provide their personal information (address, name, etc), payment information (credit card and billing address) and pick their airtime package. Consumers must enter an email address to register. Consumer might be restricted from using different aspects of the system based on their State of residence, and origination of communication, where local laws restrict on-line or telephonic wagering. Consumers must be 18 to register on the site (will collect date of birth). Consumer may optionally have a credit card. Consumer must provide an identification transmission or data, which might include any player unique identification, such as a driver's license number, consumer must provide SSN/SIN. Credit card wagering, if information is allowed and provided, is authorized for $1 fee per transaction, which may be added through the ledger-based, opaque financial wagering structure described above.

Depending on jurisdiction, consumer may have to wait some period of time before tipping and/or wagering. Consumer requests their account be blocked. A consumer can request that their account be blocked (to prevent fraudulent use) by using the generic customer complaint form on the public website. Administrator can add a note as to why the account is being blocked. Consumers can send an email to unblock an account.

Consumer Website

The following information will be available on the public website:
Information about the service in general
   About SheTips
   Tip Service
   Wagering Service
   Multiple service levels
   Rewards Program info
   Success stories (Joe S from Idaho won $5000 using the service)
Registration of New Customers
Event Calendar (logged in or not)
Race track results (no link to DRF.com!!) (logged in)
DonBest.com links:
   Archives (like http://www.donbest.com/archives2.htm)
   Scoreboard
   Injury Reports
   Stats and Matchups
Registered Customer area consisting of:
an option to transfer money to their ecash account (topped up from credit card)
Cancel account option
Managing account information
Shopping Cart for new services (airtime packages)
Link to Web version of Tipping/Betting Machine
   1.7 Consumers Can Search for Tipping Agents

The landing page of the public website will be a flash slot-machine styled search engine which allows consumers to search for tipping agents to get through to their online pages.

The search interface allows consumers to search by hair color (blond, brunette, redhead), city, country, and by extension number.

1.8 Consumers Can Talk to Specific Tipping Agents

When a registered user calls the PBX, they will be able to enter the extension of a specific tipping agent.
If that agent is busy and has no-one waiting, that user can queue for the agent.
If the agent is not logged into the phone system, the user will be transferred to the next available agent.
   1.9 Consumers Can View Their Transactions

Consumers can get a monthly summary of their transactions, going back 18 months previous.

As well, consumers should see their currently remaining airtime along with their next billing date.

1.10 Consumers Have a Favorite Tipping Agent

for the first month, the tipping agent who signed the customer up is the customer's favorite.
after the first month, the tipping agent who the customer spends the most time on the phone with is that customer's favorite.
   1.11 Consumers Must Register

Consumers must register to interact with the system.
users must supply personal information (name, address), payment information (a credit card to bill against) and must choose an airtime bundle to register.
after registering, customer is sent a welcome email.
   1.12 Consumers Pick an AWP

The consumer will be provisioned with both e-cash and with the AWP. The system will provide consumer profile information to e-cash in XML format.

After e-cash provisions the user, it will register them with the AWP.

1.13 Consumers See Airtime Remaining

As part of their account information, consumers can see their remaining airtime.

1.14 Consumers Will Get Tips

Registered users will be able to get tips on horses for a given race (at a specific track at a specific time).

Can only get tips by paying with e-cash. Credit cards are only used to top up e-cash account.
Registered users should be able to phone a tipping agent (via their extension in the PBX) and get tips. Customers enter a password (or phone number and password if CLID cannot be determined) to talk to tipping agent through PBX.
Registered users should be able to play a flash game that will give them tips.
Kiosks should facilitate handicapping. This feature is deferred to later versions.
   1.15 Consumers Will Pay for Airtime Minutes

Users will pay a per minute airtime fee for phoning a tipping agent through the PBX.
users will pay for a minimum of 3 minutes.
users will prepay for a block of time (sold in various bundles).
a bundle will automatically be rebilled monthly.
if a prepaid account is getting “low’ on time (<5 minutes), the user will be billed immediately for an additional 15 minutes of time).
minutes left unused at the end of the month will not be carried over.
   1.16 Consumers Will Place Wagers

Registered users will be able to place wagers on a certain horse for a specific race at a certain track and time.
They will be able to wager using the IWM
They will be able to wager while chatting on the phone system by having a tipping agent transfer them to an AWP
Consumers will be able to place a wager through the flash game.
   1.17 Credit Card Business Rules

Visa and MasterCard will be accepted. American Express will not be accepted. Customer must enter SIC code for authorization.

1.18 Credit Card Validation Errors Redirect to Issuer

If there is a problem with authorizing a consumer's credit card, the data entry form will allow three attempts at getting the correct information.

After three validation errors, the consumer is directed to contact the credit card issuer to resolve the issue.

1.19 Customer Can Top Up ECash™ System Through Western Union

Customers can top up their ECash™ system accounts by going to a Western Union (and use quick-pay).

1.20 Customers Must Log into IVR

Customers will log into the IVR using their phone number and pin. The IVR will try to determine phone number from calling line id. If the customer does not have an ECash™ system account, a message will direct them to SheTips.com website.

1.21 Events Calendar

All users of the system have access to an events calendar. Administrators can add events. Tipping agents can indicate availability to work an event. Administrators can schedule a tipping agent to work at an event or can schedule them to be on standby. Consumers and tipping agents should, by default, only see events in their area (prov/state and country). Only Team Leads can see events that are not marked active or that have already taken place. Events can have more than one photo associated with them (sponsors, venue shots, etc).

1.22 Events Can Be Private

Events can be marked as private. Private events will not be shown on the public web. They will also not be pushed to the translux board.

1.23 Flash Games Will Be Branded

Flash games will be branded with a tipping agent's images.

1.24 Integrate Stats from DonBest.com

Various sports stats (scoreboard, archives, injury reports, etc) will be integrated directly into the public website. Contract with DonBest.com needs to be negotiated. Need to determine who will datamine/store the information.

1.25 IWM Associated with Tipping Agents

When tipping agent logs in to phone system, they are put in a queue for a random machine. When they log off, they lose machine or are taken out of queue. Every 20 minutes, the tipping agent associated with a machine will change.

IWMs at an event are not part of the random queue and are dedicated to tipping agents working the event. The tipping agents at the event are associated with an event machine for a number of minutes so that each tipping agent gets the same amount of time on the machine over the duration of the event.

A team lead can manually override who is associated with a machine, associating with a tipping agent with a machine until it is either manually changed or purposely put back in the random or event queues.

Machines only switch tipping agents when they are ‘idle’ (when there is no card in the machine).

1.26 IWM Management

Need to be able to track IWMs. Certain machines (laptops and IWM) have IP addresses for internet wagering only. Certain machines (laptops and IWM) have IP addresses for tipping or loading money only. Kiosks need to have an ID number. Need to be able to define the location of a machine (city, prov/state and country). Need to be able to assign a state to a machine (available, booked, broken).

1.27 My Little Black Book

Consumers will be able to view their ‘little black book’ as part of your profile page). Shows up to the last 50 tipping agents interacted with in the last month. It displays the tipping agents' pictures you've talked to or played and the time, date and location you talked/played. Clicking on the picture takes you through to the tipping agent's online game.

1.28 Payment Processing System

The payment processing system will simply apply a positive or negative charge to an account and returns the result. Based on the currency and type of account (credit card, debit card, prepaid card, etc) and currency a different payment module might be used.

1.29 Push Messages to Translux Boards

Customized messages will be delivered to translux boards.
if the tipping agent branding the kiosk is logged in, a message to that effect will be delivered to the board.
if the tipping agent associated with the kiosk is registered for any upcoming events (within 2 weeks??), a message with some event details will be pushed to the board.
will also show a tipping agent and her return for the previous day.
   1.30 Report on Issues in Trouble Ticketing Tool

Administrators should be able to generate a report on resolved and open issues in the trouble ticketing tool over a range of dates.

1.31 Report on Tipping Agent Call Taking

A report showing a given tipping agent, the number of minutes of calls that they took and the commission owed them. Administrator must input a range of dates to report on.

Transaction Report

If transaction report is viewed by a tipping agent, it shows total minutes for each month in range along with rate per minute. If transaction report is viewed by another administrator, it shows total minutes for each day in range along with rate per minute. Admins other than tipping agents can also drill down to see each call record for a given day for a given tipping agent.

Payout Report

For each payout done during the date range, payout information will be displayed as follows:

Tipping Agent Id: Payout Period: Amount: Total Minutes

All records will be kept for 18 months.

1.32 Report on Tipping Agent PBX Schedule

Team Leads will be able to report on which tipping agents are scheduled to be logged into the PBX to take calls. Team Leads can pick a range of dates to be displayed. For each hour of a given date, a list of the scheduled tipping agent aliases will be displayed. Clicking on a tipping agent alias will display their profile.

1.33 Security Levels

The website must have security such that users can only see and execute certain functions. For instance, only certain users can add events to the system, other users can simply view events.

1.34 Sponsor Ads Will Be Shown on Site

Sponsor ads will be shown on the public website.

1.35 System Will Keep a Historical Record of Tipping Agents Stats

The stats reported on the tipping agent landing page will have to be kept and be reported on (for the purposes of bonuses and incentives).

1.36 Team Lead Activates Tipping Agent

A team lead must activate a tipping agent before the agent can use the system or log in to the PBX. Activation generally happens after the tipping agent has received their welcome package and after training has taken place.

1.37 Team Lead Enters Problems in Tool

A Team Lead should be able to record problems in a tool.
those problem reports should then be accessible by:
   other Team Leads or
   a specific Tipping Agent or
   an accounting manager or
   an administrator.
should be able to mark a problem as solved.
should be able to add a solution description to the problem report.
   1.38 Team Lead Provisions Tipping Agent on Phone System

A Team Lead will be able to provision a tipping agent on the phone system. The Team Lead will register the tipping agent's phone number with the PBX. The Team Lead will register the tipping agent in the IVR software. The Mint Inc system will provision people into the Solidus database and MD-100 phone system.

1.39 Team Lead Registers/Updates Tipping Agent

A team lead can register a tipping agent on the admin website.
The tipping agent's profile information is entered into the website.
The tipping agent's pictures are uploaded to the admin website.
The tipping agent cannot use the system until they are activated.
any pictures that the team lead uploads are instantly available
a team lead can approve any pictures that the tipping agent themselves upload
   1.40 Team Lead Removes Tipping Agent

A Team Lead can remove a tipping agent. For reporting purposes, the account is not deleted, but it is completely inactive. A special pass-key must be entered to confirm removal of a tipping agent, even if the administrator has the correct security privileges.

The tipping agent cannot:
log in to the website
log into the phone system (they are removed from the PBX and the IVR)
have their photos used on the flash games nor the IWMs
   1.41 Team Leads Can Monitor PBX Logins/Schedule

Team Leads can see which tipping agents are scheduled to work at a given day/time. They can also see who is logged in at any given time and will know whether those logged in were scheduled to take calls or not. They will also see who is scheduled to take calls but is not currently logged in. If a logged in tipping agent has not viewed their tipsheet for the day, their alias will appear in brackets in the scheduling tool. Clicking on an alias in the scheduling tool will display that tipping agent's profile so that they can be contacted.

1.42 Tip Delivery System

The tip delivery system will aggregate tips (the top 4 horses for each race) from HDW and will make them available to tipping agents (ordered by time and by track). Each day a tipping agent will receive tips for a random predictive model. The system will allow downloading of a PDF tipsheet from the site.

1.43 Tipping Agent Commissions

Tipping Agents will be paid various commissions as customers use the service.
$1 per minute consumer airtime
0.01% of handle from_branded_IWM
   increases by 0.01% per event attended up to 1% (team lead manages this rate)
1% of tip value of online tips
   increases 1% for each tip to a maximum of 50%
0.01% of handle from_branded_flash game
   increases by 0.01% per event attended up to 1% (team lead manages this rate)
0.01% of all revenue for a tipping agent for a referral.
0.01% of all revenue for a tipping agent for the photographer that photographed them.
0.01% of all revenue for a tipping agent for a styling (providing clothing, etc for photo shoots) fee (who is this paid to?)
0.01% of all revenue for a tipping agent for a makeup fee.

Commissions are rounded to the nearest cent.

1.44 Tipping Agent Views PBX Schedule

A tipping agent can view their schedule for taking calls for a given day. The report will show whether they are scheduled to take calls during a specific hour or not.

1.45 Tipping Agents Can Access Tip Sheets

Tip Sheets will be made available to tipping agents on the tipping agent website.
new tip sheets will be available each morning.
tip sheets will only contain tips for that day's races.
handicapping information will be delivered in XML format by a third party (Dan).
the downloaded file is in PDF format.
the document is set up with one track per page.
each day, every tipping agent will get tips from a random predictive model.
   1.46 Tipping Agents Can Receive User Calls

Tipping agents can receive calls routed by the IVR for the purpose of providing handicapping information.
tipping agents must log into the PBX to receive calls.
the IVR will not transfer calls to a tipping agent unless they have accessed their tip sheet that day.
the system will track the time a tipping agent talks to customers for the purpose of paying a commission on the user's airtime costs.
tipping agents can transfer users to an account wagering provider to place a wager.
   user can already be registered with an AWP.
      the tipping agent can automatically transfer the user to an AWP they have previously registered with if the user specified that AWP during registration.
   or they can be transferred to an AWP for the user's jurisdiction.
      the tipping agent will transfer the user to a CSR who will then transfer the user to an AWP based on the user's jurisdiction.
         1.47 Tipping Agents Must Register

Tipping agents must register to use the system.

1.48 Tipping Agents Schedule Themselves to be on PBX

Tipping agents will schedule themselves to be logged into the PBX to take customer calls.
tipping agents book their availability to take calls in a scheduling tool.
if a tipping agent schedules time but does not log in, email and SMS alerts will be sent out.
   1.49 Tipping Agents See Stats After Logging In

After a tipping agent logs in, they will see which tipping agent was the favorite overall in the system the previous day. Top machine hits (no names) daily/monthly. Top internet hits daily/monthly. Top phone hits daily/monthly. Top signup person daily/monthly. Then show the tipping agents stats:
machine hits daily/monthly
internet hits daily/monthly
phone hits daily/monthly
signups daily/monthly
how many customers have them as their favorite (Congrats Julie Hinton, 450 customers think of you as their favorite).
   1.50 TOTE System Will Provide a SOAP Interface for Interactions

The system will interact with the TOTE using SOAP.

1.51 Trouble Ticket Issues Must Have Reference Number

All issues recorded in the trouble ticketing tool must have a reference number. One must be able to retrieve an issue based on its reference number. One should be able to search for issues related to a specific user.

1.52 Trouble Ticketing System

May need to source out, configure and host a trouble ticketing system. Initially email will be used.

1.53 Wagering Clubs

Customers are rebated on wagering, depending on how much they wager in a month:
Coal <$1000/month nada . . .
Bronze $1000/month (rebated 2% on both losing SheTips picked bets and on winning player picked bets)
Silver $2500/month (rebated 4% on both losing SheTips picked bets and on winning player picked bets)
Gold $5000/month (rebated 6% on both losing SheTips picked bets and on winning player picked bets)
Platinum $20000/month (rebated 8% on both losing SheTips picked bets and on winning player picked bets)

A player (one who places a wager) at a race event ordinarily will attempt to use individual skills, knowledge and techniques to select a wager on a race contestant to win the wager. The player will use all of the available information that players ordinarily use or believe will assist in selecting a best wager on a particular race. Players have a high degree of confidence in their handicapping skills, and are very competitive against other players. The present game and method enables the player to actually compete with an automated handicapping system, with little or no expense, and add more competitive interest to the wagering.

The player must have access to an automatic wagering system that bases candidate selection on a handicapping system (e.g., algorithms and software implemented by a processor. Such an automated handicapping, race contestant selection system is described in U.S. Pat. No. 6,722,980 (hereinafter referred to as the “Stronach Application”), which patent is incorporated herein by reference in its entirety. Handicapping may be based upon any form of information, including, but not limited to those forms of information described in the Stronach Application, such as past race results, changes in training, jockey results, changes in jockey or trainer, bullet times, changes in competition level, weight changes, changes in odds (e.g., from morning odds to near-post time odds), track conditions, late wagering, and other publicly available information. The automated wagering system may be a dedicated automated wagering terminal, a mixed individual selection and automated terminal, or personnel that have access to the automated system (e.g., a floor walker with RF access or other electronic access to an automated contestant selection system relying at least in part on handicapping selections).

The object of the method is as follows. The player may be able to receive either a active automated wager or an inactive automated wager, in addition to an individual active or inactive wager placed by the player. By active is meant that the ticket is a recognition of an actual wager on a specific event or specific contestant (e.g., a single contestant for win, place or show, and an event such as exacta, triacta, trifecta, perfecta, daily double, etc. where multiple contestant selection is required) and that the ticket may be cashed in when the selection identified on the ticket is a winning selection. Inactive means that the selection identified on the ticket cannot be cashed in, irrespective of the results of the race, yet identifies a specific wager.

The options of the player are as follows: a) the player may make an independently handicapped or random active wager on a contestant(s) in a racing event (on one or more races, as in a trifecta or daily double respectively); b) the player may elect to have the terminal and intelligence system associated therewith make an automated selection of a active wager on a contestant(s); c) the player may make both an independently handicapped (or random) active wager and an automated handicapped active wager on a contestant(s) in a racing event; d) after having performed a) or in conjunction with a), the player may make an inactive wager with the automated handicapping selection system with a special wagering relationship established between the a) pick and the d) pick; e) after having performed b) or in conjunction with b), the player may make an inactive wager with individual player handicapping and selection with a special wagering relationship established between the b) pick and the e) pick; or after, during or before having performed c), the player may elect to have a special wagering relationship established on any recordation of the wagers between the two active wagers. The term special “wagering relationship” means a comparison between the success of the two wagers, specifically where the comparison is based on at least one or more parameters selected from the group consisting of which of the two wagers produced or (in the case of inactive wagers) would have produced at least one of a higher finishing contestant(s), a higher finishing set of contestants, a higher payout on the same wager amount, and the like. The special relationship may be limited in application to circumstances where both the automated selection and individual selection both finish in the money for the particular wager, or where only the individual selection finishes in the money. The special relationship play may have gaming or wagering benefits to the player. For example, the provision of a ticket on a non-active wager to a player making individually handicapped selections may be issued on a ticket fixed to (e.g., on the same ticket) or data connected to the individually handicapped ticket. That is, the automated ticket will have a unique wagering relationship to the specific individual ticket provided to the player on the individual wager. The automated wager ticket selection may be provided on a gratis basis to a player in a promotional environment to stimulate use of the automated system. The automated ticket will be given to the player and the player will examine the automated ticket at the conclusion of the race event and determine which selection proved to be the best. In the promotional event, if the player selection outperformed the automated selection based on established criteria, then the player might be comped or rewarded with a percentage of the original player wager, such as 0.5%, 1.0%, 1.5%, 2.0%, 2.5%, 3.0%, 3.5%, 4.0%, 4.5%, 5.5% or more of the original wager. Even in a non-promotional mode, the race tracks can absorb this percentage to stimulate additional wagering. The results of the wagers will be compared at the conclusion of the race event and the tickets (automated versus individually handicapped) and the player will gain an appreciation for the success of the automatic handicapping system. This may at least promote use of the automated handicapping system, if not additional play in the special relationship wagering (SRW).

In the practice of SRW, another wagering format would be where the player makes an individually handicapped active wager, and at no additional cost or at a marginal additional cost, has the automated handicapping system identify an automated selection on the same race event, preferably on the same ticket or else on a ticket unique to the individual wager (as later explained in greater detail). If the player “wins” under the established criteria against the automated wager, the player will receive an additional award (above the return on a winning wager) that exceeds the marginal amount wagered (any return would exceed a free wager). For example, if the individually handicapped wager is for a Place bet, and the criteria for a winning event is that the individually handicapped contestant must finish at least 1^{st} or 2^{nd} and the automated handicap selection must finish at least 2^{nd} or 3^{rd}, an additional $1.00 wager on that special relationship event may pay off at 5:1 odds. That payout has the possibility of exceeding the return on the primary Place wager if the selection is a prohibitive favorite. Ties would be a push in the event that the individual selection and the handicapped selection were the same contestant(s) or if the criteria were that the payout for the individual selection must exceed the payout for the automated handicapped selection. For example, if the individual selection were for a Win bet on a contestant going off at 1:2 odds and the automated selection were for a Place bet on a contestant going off at 8:1 odds, if both wagers won, the automated place bet would pay more, and the special relationship wager could be either a loss (of the $1.00 special event wager) or a push, with the $1.00 special event wager credited to or collectable by the player.

The special event wager may also be played the player making both an individually handicapped active wager and an automated active wager that are both printed on the same ticket. Again, there might or might not be any additional wagering cost for the special relationship wager, especially where both are active wagers and the player has made two wagers on the same race event.

The race providing system generally manages and processes various racing information, particularly wagering information associated with race events held at various race event tracks. An example race providing system is Amtote International, Inc.'s totalisator system which processes racing information from or related to not only race events at which Amtote provides wagering transaction services but also race events unassociated with Amtote but for which racing information is provided through the Amtote totalisator system (e.g., racing information from or related to simulcast race events). The racing information may include race event information, such as the names and start positions of the race contestants (e.g., horses, dogs) running in each race event for which the race providing system has information, the distance of each such race event, the race event track name of each such race event, the start time of each such race event, etc. The racing information may also include odds information for each race contestant, betting pool information on the betting pool associated with each race event, handicapping information, such as the weather conditions, and the jockey name, race contestant age, win record, and number of days since the last race event for each race contestant, and/or race result information such as the race results at the end of each race event. The racing information may be any combination of the race event information, odds information, betting pool information, handicapping information, race result information and/or other information as needed for the effective operation of the at least one wagering terminal. Optionally, the racing information may also include audio and video data corresponding to some or all of the race events for which the race providing system has information.

In a typical race providing system, the racing information is generated internally within the race providing system and/or obtained from associated race event tracks and, if applicable, off-track betting locations/devices and other race providing systems. A race providing system may also receive racing information from an information provider, unassociated with a particular race event track, supplying racing information (e.g., information services provided by Equibase Company LLC). Further, the at least one wagering terminal provides racing information to the race providing system, particularly betting pool information. In an embodiment, the race providing system includes information related to a number of race events at one or more race event tracks so as to provide the at least one wagering terminal with information regarding a substantially continuous succession of race events. As will be apparent to those skilled in the art, each race event track or other information provider may instead of or in addition to providing their racing information to or through the intermediate race providing system, provide the racing information directly to the at least one wagering terminal over a connection or network. However, in an embodiment, a race providing system is used.

In another embodiment, the race providing system may comprise a system operator interface, a wagering terminal transceiver for communicating with the at least one wagering terminal, a central processing unit (CPU) 220 in communication with the system operator interface and the wagering terminal transceiver, and memory in communication with the CPU.

The system operator interface comprises a data display device, typically comprising at least one CRT display (although falt screen, plasma screens, LED screen, LCD screens and the like may be used for any display system used in the practice of the invention), for allowing a system operator to view, among other things, the racing information. The system operator interface also includes a data input device, such as a touch screen, button panel, keyboard and/or mouse, for allowing the system operator to enter control commands through the system operator interface. The control commands include commands for configuring racing information to be transmitted to the at least one wagering terminal, commands for configuring the wager processing of the race providing system, and where applicable, commands for configuring the wager type of the at least one wagering terminal.

The wagering terminal transceiver for communicating with the at least one wagering terminal is one or more mechanisms to send all or some of the racing information to the at least one wagering terminal and, where applicable, to send any other information to the at least one wagering terminal. The wagering terminal transceiver for communicating with the at least one wagering terminal is also configured to receive wagering information from the at least one wagering terminal for provision to the wagering processor. Such mechanisms may be typical communication interfaces. In an embodiment, the racing information is manipulated and formatted for sending to the at least one wagering terminal. Further, the other information sent to the at least one wagering terminal may include one or more sets of quick pick race contestant(s) and one or more least chosen race contestants for a wager type, particularly the one or more race contestants for a wager type that may yield a payout of the entire pool, both as described in more detail below.

The memory includes processor instructions for the CPU to define a quick pick race contestant(s) selector and a wager processor. The memory also includes a wager database in communication with the wager processor. As will be apparent to those skilled in the art, the memory may be non-volatile or volatile (e.g., RAM) memory or both. The wager database includes one or more wagering records that identify the network address of the at least one wagering terminal from which a wager has been placed and information regarding the wager transmitted from that at least one wagering terminal.

The wager processor is configured to receive wager information from the at least one wagering terminal (typically via the wagering terminal transceiver), to maintain the wager database with the received wager information and where applicable, to signal the appropriate at least one wagering terminal to initiate payout of winning wagers to the user of the at least one wagering terminal. Where the at least one wagering terminal is used to place pari-mutuel wagers, the wager processor is also configured to include the received wager information into the appropriate pari-mutuel pool and where applicable, obtain information on the size of the parimutuel pool for calculation of the relevant payout. Where, for example, the race providing system is connected to one or more other race providing systems, the wager processor transfers the received wager, where applicable, to the correct race providing system(s) so that the wager can be included in the appropriate parimutuel pool managed by that race providing system(s) and similarly, where applicable, obtain information on the size of the parimutuel pool from the relevant race providing system(s) for calculation of the relevant payout.

The quick pick race contestant(s) selector is used to generate one or more sets of quick pick race contestant(s) for each race event. Each set of quick pick race contestant(s) comprises one or more race contestants of a race event according to a specific wager type and is determined by a race contestant selection algorithm. The number of determined race contestants in a set of quick pick race contestant(s) primarily depends on the wager type. A set of quick pick race contestant(s) for a win, show or place wager type will comprise one race contestant. Similarly, a set of quick pick race contestant(s) for an exacta wager type will comprise two race contestants.

The race contestant selection algorithm(s) employs handicapping information and odds information to determine a set of race contestants for a particular race event according to a specific wager type. In an embodiment pertaining to horse racing, the algorithm analyzes for each race contestant of a particular race event the handicapping information including without limitation the race contestant's trainer statistics, race contestant's jockey statistics, the track condition of the race event, and the times between race events for the race contestant. Further, the algorithm analyzes for each race contestant of a particular race event the odds information, for example the difference between the “morning line” odds and current odds information for the race contestant. The quick pick value of each race contestant may then simply be a weighted value of the handicapping information and odds information associated with each race contestant. The quick pick values for the race contestants of a race event are then analyzed to determine a set of race contestants for a specific wager type for the particular race event, preferably an optimal set of race contestants to win the specific wager type for the particular race event. As will be apparent to those skilled in the art, any number of race contestant selection algorithms are possible employing handicapping information and odds information to determine a set of race contestants for a specific wager type for a particular race event.

The quick pick race contestant(s) selector may also be implemented on the at least one wagering terminal in addition to or substitute of the quick pick race contestant(s) selector provided at the race providing system. Further, the quick pick race contestant(s) selector can determine the one or more sets of quick pick race contestant(s) automatically for each race event and/or determine the one or more sets of quick pick race contestant(s) for a race event upon request from or at the at least one wagering terminal. The race event selector communicates with the racing information buffer and the wagering processor. The race event selector is configured to select race event information received from the race providing system for presentation on the display. In an embodiment, the race event selector is configured to determine and make available for display information about a next race event which is scheduled to run at all or certain of the race event tracks for which the race providing system has supplied race event information. The race event selector is also configured to determine and make available for display future race events in time order at all or certain of the race event tracks for which the race providing system has supplied race event information. If more than one race event is scheduled to run at or about the same time, the race event selector selects information about one of the race events for display (for example, choosing a race event at a more preferred race event track). In this manner, the at least one wagering terminal may continuously provide a succession of race events to a user upon which to wager. As will be appreciated, some race events can only entertain certain types of wagers. For instance, superfecta wagering may not be permitted at a certain race event. Consequently, the race event selector may select for display only those race events for which the at least one wagering terminal is configured to receive wagers.

Further, the race event selector is configured to accept a next or previous race selection command from the user interface via the wagering processor, thereby allowing the user to view information regarding a next race event or future race events. For example, the user may “scroll” back and forth through a next and other future race events by starting time by touching the “Next Race” and “Previous Race” buttons/icons, each touch of the buttons/icons causing the wagering processor to present, as applicable, updated information on the display corresponding to the “previous” or “next” race event by start time. Essentially, the user is able to view (and thus wager on) in time order a next race event and other future race events for which the at least one wagering terminal has information. In an embodiment, a next and other future race events by starting time may be the next race events by starting time found at all of the race event tracks for which the race providing system has supplied race event information. In another embodiment, a next and other future race events by starting time may be the next and other future race events at the certain current race event track which is presented on the display of the at least one wagering terminal.

The race event selector is also configured to determine and make available for display race events at different race event tracks. In this regard, the race event selector is configured to accept a next or previous race event track selection command from the user interface via the wagering processor, thereby allowing the user to view information regarding a race event at different race event tracks. For example, the user may “scroll” through future race events at different race event tracks by touching the “Next Track” and “Previous Track” buttons/icons, each touch of the button/icons causing the wagering processor to present, as applicable, updated information on the display corresponding to the future race events at “previous” or “next” race event tracks. Essentially, the user is able to view (and thus wager on) race events at different race event tracks for which the at least one wagering terminal has information. In an embodiment, the race event track (of all of the race event tracks for which the race providing system has supplied race event information) having the next starting race event is presented, along with that next race event, on the display of the at least one wagering terminal in response to a “next” race event track command. In another embodiment, the next race event track in alphabetical order (of all of the race event tracks for which the race providing system has supplied race event information) is presented, along with next starting race event at that race event track, on the display of the at least one wagering terminal in response to a “next” race event track command.

The account processor is in communication with the card read/write device, the account buffer and the wagering processor. The account processor is configured for crediting and debiting, in accordance with the amount wagered and the outcome of the elected race event, the balance of a user's account. For example, the account processor determines whether the user has introduced an electronic/magnetic-stripe card to the card read/write device, and then establishes an account for the user in the account buffer. The balance of the user's account may be stored, for example, on the electronic/magnetic-stripe card which is introduced to the card read/write device. Information about the amount wagered and the outcome of the elected race event is supplied by the wagering processor. The account processor performs basic checks to ensure that the user's account has a credit, that the account has enough credit for the amount wagered and that the card is otherwise operating properly. Information regarding some or all of these checks is communicated to the wagering processor in order to allow the wagering processor to submit a wager to the race providing system. In an embodiment, the account processor is also configured to request from the user an appropriate password or other identification information via the user interface before establishing the account for the user in the account buffer. In an embodiment, the electronic/magnetic-stripe card is specially designed and configured for the at least one wagering terminal. As will be apparent to those skilled in the art, other types of cards may be used such as credit and debit cards.

The wagering processor communicates with the quick pick race contestant(s) buffer, the racing information buffer and the account processor. The wagering processor is configured to display the race contestants of the displayed race event using the odds information stored in the racing information buffer. In an embodiment, race contestants are shown as differing shaded/color icons on the display depending on the odds information associated with the race contestants. A color palette may be provided on the at least one wagering terminal to identify the colors associated with the race contestants, namely colors ranging from favorite to longshot. In an embodiment, the color palette is provided physically on the glasswork of the housing of the at least one wagering terminal although as will be apparent to those skilled in the art, the color palette may also, for example, be provided on the display or as part of a payout table. For example, a horse icon for a favorite horse race contestant may be shown in blue while a horse icon for a lesser favorite horse race contestant may be shown in purple. In an embodiment of the at least one wagering terminal, each differing shaded/color icon is associated with a rate contestant based on the win odds associated with the race contestant. If two race contestants have the same win odds, then the amount wagered on the race contestant in the win pool (if available) is used to select the favorite. Otherwise, whichever race contestant has the lower number assignment will be considered more favorite. In another embodiment of the at least one wagering terminal, each differing shaded/color icon is associated with a race contestant based on the amount wagered on the race contestant. As will be apparent to those skilled in the art, any number of means of assigning one or more colors reflecting odds associated with a race contestant may be used.

The wagering processor may also be configured to display the potential estimated winning payout of a wager on one or more race contestants of a race event according to the wager type of or selected in the at least one wagering terminal. For example, a wagering terminal configured for or in which is selected, an exacta wager type may present on a display (e.g., a ticker-type display) a combination of race contestants (such as horse 5 and horse 3) of the race event about which information is shown on the display (e.g., a CRT or other display), that may yield a certain estimated winning payout (such as $10,000 if horse 5 and horse 3 finish in that order in first and second place). In an embodiment, the greatest potential estimated winning payout(s) (and associated race contestant(s) that need to be selected to win the estimated payout(s)) is displayed according to the wager type of or selected in the at least one wagering terminal and the race event displayed on the at least one wagering terminal. In another example, a wagering terminal configured for or in which is selected, a superfecta wheeler wager type may present on a display, the current pool total of the race event about which information is shown on the display, such that perhaps a certain unique winning wager combination of the superfecta wager type may yield a payout of the pool (“jackpot”).

The wagering processor is also configured to receive wager information from the user interface and for selecting one or more race contestants for the wager. For example, the wagering processor receives through the user interface an instruction for a wager amount, for an elected race event, which is transmitted to the race providing system together with the elected race contestants once the user instructs through the user interface the submission of the wager. In another embodiment, the at least one wagering terminal has buttons corresponding to certain wager amounts and/or combinations which when engaged by the user instruct the wagering processor the wager amount and/or combination and a play button which when engaged by the user instructs the wagering processor to submit the wager. In an embodiment, the wagering processor employs a default wager amount and/or combination, e.g., the lowest wager amount and/or the quick pick race contestants, when it is not instructed the wager amount and/or combination through the user interface but is instructed to submit the wager.

Through the user interface, the user also can manually select the one or more race contestants for a wager or select that a set of quick pick race contestant(s) as provided in the quick pick race contestant(s) buffer is used for the wager. As discussed below, the one or more sets of quick pick race contestant(s) may be supplied in a substantially continuous fashion to the wagering processor and/or as requested by the wagering processor (typically via the quick pick race contestant(s) buffer). In an embodiment, the user can manually select one or more race contestants for a wager by touching a touch-sensitive screen of the display or may select a set of quick pick race contestant(s) by pressing the “Play” button of the at least one wagering terminal. In an embodiment, the wagering processor employs one or more race contestants from a set of quick pick race contestant(s) to complete a wager if all the necessary race contestants for the wager type have not been selected but the wagering processor is instructed nevertheless to submit the wager. In this fashion, the wager will comprise the race contestant(s) selected by the user and one or more race contestant(s) from the quick pick race contestant(s) needed to complete the wager of the applicable wager type.

The wagering processor is also configured to show on the display the race contestants that have been manually elected by the user or the race contestants in a set of quick pick race contestant(s). For example, in an embodiment, the user selection of a race contestant on a touch-sensitive display causes an icon corresponding to the race contestant to change in appearance to indicate the race contestant has been selected. Similarly, the icons of quick pick race contestant(s) may change in appearance to indicate their selection.

The wagering processor is also configured to receive information regarding the sufficiency of credit in a user's account from the account processor and to provide the amount wagered and the outcome of the elected race event to the account processor for crediting and/or debiting a user's account.

The wagering processor may also be configured to provide a prize to a user upon the submission of a wager. For example, the submission of a wager may trigger, according to a prize selection algorithm, the provision of a prize to the user, for example, in the form of a credit of the user's account or a credit or other type of prize on a ticket provided from the ticket dispensing device. In an embodiment, the prize selection algorithm may simply be a random seed or else the prize selection algorithm may determine to provide a prize after every certain amount of wager submissions through the wagering terminal. In another embodiment, where the prize selection algorithm is implemented across the wagering system, the prize selection may determine to provide a prize to a particular wagering terminal after every certain amount of wager submissions through wagering terminals throughout the wagering system.

The wagering processor may also be configured to select one or more race contestants, according the applicable wager type, which represent the least chosen one or more race contestants for the wager type, particularly the one or more race contestants for the wager type that will yield a payout of the entire pool. Such selected race contestant(s) may determined using the odds information and/or betting pool information or may be provided by the race providing system. In an embodiment, a button (titled, for example, “Jackpot” button) is provided to allow the automatic selection of such one or more race contestants for a wager.

In a variation (not shown), the user interface includes a reselect button for initiating reselection of the race contestants, and the wagering processor is configured to reinitiate selection of race contestants upon receipt of the reselection command from the user interface. In this variation, the wagering processor is configured to issue a command to the race providing system to provide a one or more new sets of quick pick race contestant(s) and then to select from the one or more new sets of quick pick race contestant(s) provided by the race providing system. In this manner, the wagering processor typically selects different quick pick race contestant(s) for each actuation of the select button.

The details of the wagering process of an embodiment, as facilitated by the processing instructions of the wagering processor, are explained in greater detail below.

Turning now to another embodiment of the at least one wagering terminal may comprise a display for presenting information about the selected race events, a user interface or viewing race event information and placing wagers on an elected race event, a card read/write device for receiving an electronic or magnetic-stripe card encoded with a user's account information, a ticket dispensing device for providing a ticket comprising wager information for an elected race event and a stand-up type housing for retaining the display, the user interface, the card read/write device and the ticket dispensing device. The wagering terminal also includes a processor, as discussed above for facilitating wagering on race events. The wagering terminal may also include a speaker for playing audio associated with the wagering and race events information.

Preferably, the at least one wagering terminal according this embodiment is configured for providing a wager in only a single wager type, and the housing includes a wager description, prominently displayed on the housing, identifying the wager type using words which explain the wager type in simple betting terminology. For example, the at least one wagering terminal may be configured to provide a win, place, show, win-place-show (a win, place and show bet on a particular race contestant), exacta, triacta, superfecta, exacta and wheels, triacta and wheels and superfecta and wheels wager type. Example wager descriptions include “Pick a Winner”, “Pick Two Exact Order”, and “Pick Three Exact Order”. In an embodiment, the wager type of the at least one wagering terminal can be changed, for example, by manually configuring the at least one wagering terminal from one wager type (e.g., exacta) to another wager type (e.g., place) or by issuing a configuration change command from the race providing system to the at least one wagering terminal to cause the at least one wagering terminal to change from one wager type (e.g., exacta) to another wager type (e.g., place). Optionally, the configuration change command can be issued to the at least one wagering terminal that in its current configuration is able to process a wager type that is not available for a next race event (about which information is made available for display and wagering on the at least one wagering terminal).

The display comprises a CRT or other display for displaying information regarding the race events and ticker-tape type display for displaying select wagering information regarding the race events. Preferably, the CRT display comprises a touch-sensitive CRT display, including a touch-sensitive membrane in communication with the processor for “scrolling” between next and previous race events and race event tracks and for manually selecting race contestants for an elected race event. As will be apparent to those skilled in the art, any appropriate type of display may be used.

The user interface comprises a series of wager buttons 430, 440 for accepting wagers in certain wager (e.g., dollar) amounts and/or combinations. For example, a button may be engaged for a $1 wager amount and another button may be engaged for a $5 wager amount. The wager buttons may also represent certain wager combinations, e.g., exacta and 2 wheels. The user interface also includes a bet submission button for initiating transmission of a wager to the race providing system.

Turning to another embodiment, an at least one wagering terminal may comprise a display for presenting information about the selected race events, a user interface for viewing race event information and placing wagers on an elected race event, a card read/write device for receiving an electronic or magnetic-stripe card encoded with a user's account information, a ticket dispensing device for providing a ticket comprising wager information for an elected race event and a table-top type housing for retaining the display, the user interface, the card read/write device and the ticket dispensing device. The wagering terminal also includes a processor as discussed above for facilitating wagering on race events. The wagering terminal may also include a speaker (not shown) for playing audio associated with the wagering and race events information.

The display may comprises a CRT display for displaying information regarding the race events and preferably, the CRT display comprises a touch-sensitive CRT display, including a touch-sensitive membrane (not shown) in communication with the processor for selecting the desired wager type, for selecting the desired wager amount, for “scrolling” between next and previous race events and/or next and previous race event tracks, for manually selecting race contestants for an elected race event and for initiating transmission of a wager to the race providing system. As will be apparent to those skilled in the art, any appropriate type of display may be used.

Preferably, the at least one wagering terminal according to this embodiment is configured for providing a wager in a plurality of wager types, although as will be apparent it may be configured for a single wager type. Information presented on the display will facilitate easy selection of the wager type. For example, each time the user touches a portion of a touch-sensitive screen of the display associated with a button/icon to change the wager type of the at least one wagering terminal, the user scrolls through the various wager types offered by the at least one wagering terminal. Each time the user scrolls through the wager types offered by the at least one wagering terminal, the information regarding race events is presented according to the selected wager type. Alternatively, for example, the selection of the wager type may be performed by selecting a desired wager type in a menu presented on the display or by selection of icons corresponding to specific wager types offered by the at least one wagering terminal.

It should be understood that the configurations discussed are only an implementation for an at least one wagering terminal, and that other configurations are also envisaged. In a variation, not shown, the user interface includes a plurality of wager type buttons, each identifying a respective wager type (e.g., win, place, show, exacta, etc.), for facilitating placement of the wager according to one of a plurality of wager types.

In an embodiment of the at least one wagering terminal for a triacta wager type or the at least one wagering terminal capable of selection of a triacta wager type, a button and/or display icon may be provided for placing a $1 triacta wager amount for the three selected race contestants in the exact order as selected and another button and/or display icon may be provided for placing six $1 triacta wager amounts on the three selected race contestants in any order. Similarly, in an embodiment of the at least one wagering terminal for a superfecta wager type or the at least one wagering terminal capable of selection of a superfecta wager type, a button and/or display icon may be provided for placing a $1 superfecta wager amount for the four selected race contestants in the exact order as selected and another button and/or display icon may be provided for placing 24 $1 superfecta wager amounts on the four selected race contestants in any order.

In an embodiment of the at least one wagering terminal for an exacta and wheel wager type or the at least one wagering terminal capable of selection of an exacta and wheel wager type, a number of buttons and/or display icons may be provided for placing various combinations and amounts of wagers according to this wager type. For example, there may be provided a button and/or display icon for placing a $1 exacta wager amount for the two selected race contestants in the exact order as selected, a button and/or display icon for placing two $1 exacta wager amounts on the two selected race contestants in any order, a button and/or display icon for placing a $5 exacta wager amount for the two selected race contestants in the exact order as selected, a button and/or display icon for placing two $5 exacta wager amounts on the two selected race contestants in any order, a button and/or display icon for placing a $10 exacta wager amount for the two selected race contestants in the exact order as selected, and buttons and/or display icons each for placing X (where X is greater than or equal to two) number of $1 exacta and wheel wager amounts on the one selected exacta race contestant and the X selected wheel race contestants selected.

In another variation, the at least one wagering terminal may be a personal computer or a handheld device with all wagering functions provided on the display of the personal computer or handheld device for selection by use of a pointing device and/or designated keys on a keyboard associated with the personal computer or handheld device. In this variation, an electronic wager ticket mechanism may be provided in place of a physical wager ticket dispensing device. The electronic wager ticket mechanism would generate an electronic representation of the wager ticket that may be presented, for example, graphically on the display of the at least one wagering terminal. Further in this variation, a user may provide the relevant account information to the at least one wagering terminal instead of introducing an electronic or magnetic-stripe card to a card read/write device. For example, the user may manually enter the account information or employ any other electronic wallet or other automatic means for making the account information available to the wagering system. Many other variations of the wagering terminal will be apparent to those of ordinary skill in the art.

Another embodiment of a screen is a CRT display of a stand-up type on which there is at least one wagering terminal depicted. The screen depicts information regarding Race 1 at the Los Angeles horse race track. More particularly, race event track information (“Los Angeles”) and the race event number information (“Race 1”) are shown. The screen also depicts account balance information regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers.

Further, a number of horse head shaped icons, such as horse head icon, associated with the race contestants of the depicted race event are shown. Moreover, the race contestant start position information, such as race contestant start position information (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant changes appearance to indicate the race contestant has been selected. For example, a pick number may be presented on the display to indicate the selection of the race contestant and, where applicable, the race contestant's order in selection of a set of race contestants. In an embodiment, the user can clear the selected race contestant(s) using a “Clear Picks” button/icon in order to re-select one or more race contestants, as applicable, for a wager.

Further, the user may “scroll” through future race events at different race event tracks by touching the next and previous track buttons/icons, each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next and previous race buttons/icons, each touch of the icons causing the wagering processor to present, as applicable, updated information on the display corresponding to the “previous” or “next” race event by start time.

Another embodiment is for a screen on a CRT displaying at least one wagering terminal. The screen depicts information regarding Race 1 at the Los Angeles horse race track. More particularly, race event track information (“Los Angeles”) and the race event number information (“Race 1”) are examples of what could be shown. The screen also depicts account balance information regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers. Further, in an embodiment, a ticker-tape type display for displaying select wagering information regarding the race events, such as potential payouts for selected race event contestants for the current wager type depicted on the screen, is provided.

Further, a number of horse head shaped icons, such as horse head icon, associated with the race contestants of the depicted race event are shown. Moreover, the race contestant start position information, such as race contestant start position information (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant changes appearance to indicate the race contestant has been selected. For example, a pick number may be presented on the display to indicate the selection of the race contestant and, where applicable, the race contestant's order in selection of a set of race contestants. In an embodiment, the user can clear the selected race contestant(s) using a “Clear Picks” button/icon in order to re-select one or more race contestants, as applicable, for a wager.

Further, the user may “scroll” through future race events at different race event tracks by touching the next and previous track buttons/icons (not shown), each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next 735 and previous 740 race buttons/icons, each touch of the icons causing the wagering processor to present, as applicable, updated information on the display corresponding to the “previous” or “next” race event by start time.

As discussed above, in the tabletop type wagering terminal, the wager type presented on the display can be changed by the user by touching the “Change Game” button/icon. So, by using the “Change Game” button/icon, the user may change the display to present a “Win” wager type or scroll to any other wager type such as place, exacta, superfecta, etc. wager types offered by the at least one wagering terminal. For the “Win” wager type, for example, the screen comprises additional buttons/icons corresponding to the win wager type of the at least one wagering terminal to allow the user to select the wager amount (“$1”, “$5”, “$10”, “$20” buttons/icons) and to initiate the wager (“Play” button/icon). For other wager types, different additional buttons/icons may be provided as required by the particular wager type selected. As will be apparent to those skilled in the art, the wager type change feature may also be provided in the standup or any other type of display for the at least one wagering terminal.

A variation of the screen may also be used for a personal computer or handheld device variation of the at least one wagering terminal. In this variation, the screen could provide the ability for a user to enter account information (as discussed above) through, for example, the touching of a button/icon that initiates an account information entry dialog. Further, the screen or another screen could permit the user to view race event video corresponding to the race event displayed on the at least one wagering terminal. So, as the race event displayed on the at least one wagering terminal changes, the race event video would change to correspond to the displayed race event. Also, the screen could provide the display of information regarding electronic wager tickets (as discussed above) corresponding to wagers placed by the user of the at least one wagering terminal. For example, representations of unofficial electronic wager tickets corresponding to user wagers can be displayed at the bottom of the screen to show the outstanding user wagers. As the user's wagers become official, the representations of those unofficial electronic wager tickets could drop off the display at the bottom of the screen. Further, a monitor bets button/icon may be provided on the screen which allows the user to review the details of all unofficial and official electronic wager tickets.

Another form of wagering can be facilitated according to an embodiment of the invention. In this embodiment, the at least one wagering terminal is configured to provide a single wager type (although it may be reconfigured to a different wager type by a configuration change command). Where the at least one wagering terminal provides multiple wager types, the wagering facilitated by the wagering system according to that embodiment would query the user to select a particular wager type but would then operate according to the wagering described below. For example, the user interface may include a plurality of wager type buttons to allow the user to select a desired one of the wager types.

The account processor determines whether the user has introduced an electronic/magnetic-stripe card to the card read/write device and if so, establishes an account for the user in the account buffer if there is a credit in the account sufficient for the lowest wager amount available on the at least one wagering terminal and the card is otherwise operating properly. If the user has not introduced an electronic/magnetic-stripe card to the card read/write device, the account processor keeps determining whether a card has been introduced and the user will be unable to submit a wager or scroll through race events, e.g., the user interface is inactive, until a card is introduced. Optionally, the account processor may make available for display a warning to the user if the card is not operating properly, the user's account does not exist or there is an insufficient credit in the account. In an embodiment, the account processor of the at least one wagering terminal is configured to request from the user an appropriate password or other identification information via the user interface before establishing the account for the user in the account buffer. In an embodiment, a user may scroll through race events without having to introduce an electronic/magnetic-strip card to the card read/write device. In an embodiment, only the buttons/icons corresponding to wager amounts and combinations available for wagering in view of the balance available in the user's account and the particular race event displayed will be active. For example, available wager amount and combination buttons/icons are lighted or shown when the user has a sufficient balance for those wager amounts and/or the wager combination is possible at the displayed race event. Similarly, the inactive wager amount and combination buttons/icons are dark or not shown when the user has an insufficient balance for those wager amounts and/or the wager combination is not possible at the displayed race event.

Once a card is introduced, the race event selector of the at least one wagering terminal queries the racing information received from the race providing system, and identifies a next and other future race events, as described in more detail above, for display on the at least one wagering terminal via the wagering processor. At the outset and as the wagering pools associated with displayed race events close, the race event selector identifies a next race event for display on the at least one wagering terminal. As a user scrolls through race events by, for example, next or previous race event and/or race event track selection commands, the race event selector identifies other future race events for display on the at least one wagering terminal.

Thus, in an embodiment, a next race event is displayed on the at least one wagering terminal at the outset when a user introduces a card to the at least one wagering terminal. Thereafter, the user may scroll through race events and race events tracks but when the pool closes for a displayed race event, a further next race is displayed on the at least one wagering terminal. In essence, the race providing system provides a substantially continuous stream of racing information to the at least one wagering terminal in order to provide a substantially continuous display of information regarding a succession of race events. Further, the race providing system may also provide one or more sets of quick pick race contestant(s) as other information pertaining to the racing information in a substantially continuous fashion to the at least one wagering terminal and/or as requested by the at least one wagering terminal. Optionally, the at least one wagering terminal may receive a configuration change command to change the wager type assigned to the at least one wagering terminal.

The wagering processor makes available for display the information regarding the next and other future race event, particularly the race event track name and race event number, as identified or supplied by the race event selector. Particularly, the wagering processor makes available for display, as identified or supplied by the race event selector, next race events upon the introduction of a card to the at least one wagering terminal or as the pool for a displayed race event closes and next and other future race events scrolled through by the use of next and previous race events and race event tracks selection commands.

The wagering processor further makes available for display a number of icons corresponding to the race contestants in the displayed race event, including icons of varying shade/color to identify the different odds information associated with each race contestant. The wagering processor uses, for example, the odds information in the racing information buffer to assign varying shades/colors to the icons associated with each race contestant of the displayed race event.

The wagering processor also determines whether the user has activated a button/icon to scroll through race events and/or race event tracks i.e. the “Next Race”, “Previous Race”, “Next Track” or “Previous Track” buttons/icons. If so, the race event selector determines a next or other future race event for display and the wagering processor makes available for display information regarding the user elected next or other future race event, determined by the race event selector, resulting from the scrolling.

If an account is established, the wagering processor queries whether a wager amount has been selected (for example, via selection of one of the wager buttons). If not, the at least one wagering terminal continues to determine next and/or other future race events for display, display information regarding such race events, and present on the display information regarding elected next or other future race events resulting from the scrolling through race events and/or race event tracks. In an embodiment, the wagering processor employs a default wager amount, e.g., the lowest wager amount, when bet submission has been activated but no wager amount has been selected.

If a wager amount has been selected, the wagering processor waits for one or more race contestants to be selected by awaiting the activation of the bet submission button i.e. the “Play” button. For example, the race contestant(s) may be manually selected via touching a portion of a touch-sensitive screen of the display associated with the icon(s) of the selected race contestants (and then hits the “Play” button to submit the wager). If the user hits the “Play” button without selecting race contestants or only a partial number of the needed race contestants (not shown), the wagering processor queries the quick pick race contestant(s) buffer to derive a suitable set of quick pick race contestant(s) to complete the wager (as discussed in more detail above), in accordance with the wager type assigned to the at least one wagering terminal. If the user at any point touches a “Next Race”, “Previous Race”, etc. button/icon, the wagering is reset and the account processor waits for a new wager.

In a variation, the quick pick race contestant(s) selector is configured to determine a number of sets of quick pick race contestant(s) using a number of different race contestant selection algorithms. For example, a different race contestant selection algorithm may simply be a version of a race contestant selection algorithm giving different weights to handicapping and odds information or may be a race contestant selection algorithm using different handicapping information and/or odds information to select one or more race contestant(s). The quick pick race contestant(s) selector is configured to use a different race contestant selection algorithm whenever a reselection command is received from an at least one wagering terminal in order to provide one or more new sets of quick pick race contestant(s) to that wagering terminal.

The CPU is in communication with the system operator interface, the wagering terminal transceiver and the memory. The CPU facilitates the operation of the race providing system including executing processor instructions defining the quick pick race contestant(s) selector and the wager processor. The CPU also facilitates, where applicable, the determination of one or more least chosen race contestants for a wager type, particularly the one or more race contestants for a wager type that will yield a payout of the entire pool, as described in more detail below. Hotwalker Showdown Racing Challenge or Game uses a self-serve betting machine that has two modes of operation.

1. The first mode is where the player can choose his own
a. Race Track
b. Race Contestants
c. Dollar Amount
d. Bet Type

In any type of order

2. The second mode of operation is whereby the machine produces an Automated Pick whereby the race track, race contestants, dollar amount and bet type are chosen via a handicapping database that contains many variables, such as odds, medication, jockey weight, trainer stats, etc., basically any variable that could affect the outcome of a race. If the player selects his ticket manually by entering the four functions or steps into the machine as inputs to produce a race event ticket and if that respective ticket is a better selection than the automated selection or ticket, the player is entitled to a rebate in one embodiment of his or her bet. For example, if the player wagers a $100 on the 4^{th} race at Santa Anita on race contestant #5 to win and that race contestant wins paying $5 for a $2 ticket whereby the odds are 2½ to one or 5 to 2 and the database chooses race 4 at Suffolk Downs on race contestant #8 to show paying $3 for a $2 ticket which is 1½ to one or 3 to 2. In this showdown or challenge the player has defeated the machine and receives a 5% rebate or 5% return on his wager amount. IN this case, on a $100 wager he would receive $5 whereby the $5 would be coming out of the house or track commission. If the track receives a 10% commission on $100 wager translating into a $10 worth of takeout, half of the takeout or tax would be returned to the player since his or her $2 paid more based off of a $2 payout. One can view the rebate as insurance whereby the player can earn extra on top of the winnings which in turn neutralizes the losing tickets. If the player selects a losing ticket and database is also not successful than no rebate on the amount wagered is given. If the database or autopick ticket has a greater return than the manually player selected ticket on a minimum $1 or $2 return payout, then no rebate is rewarded to the player even though his ticket was still a winning ticket. For example, the database ticket paid $2.90 for a $1 wager and the input manually orchestrated ticket paid $2.80 for $1 wager than no rebate will be rewarded in this case since the player failed to beat the database.

One general way of describing a game that can be included within the player competition game of the present invention is as a method of providing a wagering event comprising: a player paying for at least one wager on a race event selected from the group consisting of a) a player selected wager and b) an automatically handicapped and selected wager, the player also receiving on the race event c) an automatically handicapped and selected wager when a) is selected or d) a player selected wager when b) is selected, the combination of selections a) and c) and selections b) and d) forming a special event wager, and after results of the race event, the player having the potential to receive an award dependent upon predetermined criteria having been met in results of the race event with respect to the special event wager. The player may pay for wager a) and receive selection c) without additional cost, or the player may pay for wager a) and receive selection c) with additional cost for wager c), either as a distinct and active wager or as a ghost wager used only in the special wager event. A ticket may contain both wagers, or each ticket may be coded (e.g., bar code or ticket identification code) so that the special event wager is unique to selections a), b), c) and/or d) for the individual player and players cannot “mix-and-match” different individually selected wagers and automatically selected wagers. The player may pay for wager a) and receive selection c) with additional cost for wager c) but without additional cost for entering a special event wagering game. The player may pay for wager b) and receive selection d) without additional cost or the player may pay for wager b) and receive selection d) with additional cost for wager d). The award may comprise a rebate or comp based on an amount paid by the player for a) or b). The predetermined criteria may require that at least a), b), c) or d) comprises a wager on a winning contestant(s) in the race event. The method may include that the predetermined criteria requires that the player selected wager outperforms the automatically handicapped and selected wager. For example, the predetermined criteria may require that the player selected wager outperforms the automatically handicapped and selected wager at least by a contestant(s) in the player selected wager finishing in the money and ahead of the contestant(s) in the automatically handicapped and selected wager.

A method according to the invention may also be described as providing a wagering event comprising: a player placing at least one wager through a wagering terminal on a race event selected from the group consisting of a) a player selected wager and b) an automatically handicapped and selected wager, the player also receiving on the race event c) an automatically handicapped and selected wager from a processor-based wagering system when a) is selected or d) a player selected wager when b) is selected, the combination of selections a) and c) and selections b) and d) forming a special event wager, and after results of the race event, the player having the potential to receive an award dependent upon predetermined criteria having been met in results of the race event with respect to the special event wager, the criteria comprising the player selected wager outperforming the automatically handicapped and selected wager. The criteria may require that both the player selected wager and the automatically handicapped and selected wager are winning events in race results on the race event.

The above gaming construction can use wagering games, wagering systems, wagering platforms and wagering terminals as described herein and as described in applications filed the same date as this application bearing Attorney's Docket Nos. 311.008US 1 and 311.009US 1 in the name of Andrew Stronach, which applications are incorporated herein in their entirety for the disclosure of wagering systems, apparatus, processes, software, hardware, wagering games and all other technical and business information.

The above description has used many specific examples and specific numbers in providing a non-limiting description of the invention. It should be apparent and is intended to be understood by those skilled in the art that alternatives to these specific examples may be used within the scope of the invention. The particular games and wagering systems described may be accessed, uploaded or downloaded on demand into terminals or PC's through information transmission (wired or wireless) to the wagering sites. This may be by I.P. broadcasting or multitasking with appropriate transmission security applied (e.g., encryption verification, encoding, secure lines, secure encoded signals, and the like. IP (Internet Protocol) is used to refer to a group of emerging, established and commercially available technologies that are reshaping the landscape of every industry involved with mass communications. Enabled by the IP concept, the Internet has emerged as a massive threat to TV, radio, cable, DBS and other broadcast distribution infrastructures. TCP and IP were developed by a Department of Defense (DOD) research project to connect a number of different networks designed by different vendors into a network of networks (the “Internet”). It was initially successful because it delivered a few basic services that everyone needed (file transfer, electronic mail, remote logon) across a large number of client and server systems. TCP/IP is composed of layers. IP is responsible for moving packets of data from node to node. IP forwards each packet based on a four-byte destination address (the IP number). The Internet authorities assign ranges of numbers to different organizations. The organizations assign groups of their numbers to departments. IP operates on gateway machines that move data from department to organization to region and then around the world. TCP is responsible for verifying the correct delivery of data from client to server, as data can be lost in the intermediate network. TCP adds support to detect errors or lost data and to trigger retransmission until the data is correctly and completely received.

TCP/IP is not a broadcast technology. It is a one-to-one packet-based communications protocol designed for the reliable delivery of data across interconnected networks. Digital broadcasting, on the other hand, is a one-to-many stream-based technology designed for the isochronous delivery of data across a variety of competing, largely non-interconnected networks. This is particularly applicable to wagering terminals where it is desirable to provide different wagering games to the terminals or to personal home computers or wagering sites.

Isochronous means that the data packets within a stream must be delivered on time and that the network must provide guaranteed bandwidth to support the peak bit-rate requirements of the content that is being delivered—typically audio and video streams. If the data does not arrive on time or it is corrupt, too bad—there are no second chances with real-time broadcast streams. This is uniquely critical in the wagering environment to have the information delivered in a timely manner. There are commercially available systems (e.g., SMPTE 259M (SDI) to move digital video through the routing switchers found in modern video facilities, and the MPEG-2 transport protocol is optimized for the delivery of compressed digital video streams) that are the transport layers of choice for digital cable, DBS and DTV broadcasting around the world. The benefit of IP Broadcasting is becoming obvious as the worlds of mass media broadcasting and the Internet collide. TCP/IP has become the language of peer-to-peer digital networking. It is found at the transport layer for the Ethernet networks that link computers together in offices and homes worldwide. And it is the transport layer for cable modems and digital subscriber lines, the broadband pipes that threaten to deliver mass media content on demand, to anyone, anywhere, anytime.

A number of safeguards and controls can be placed on the system of the invention to enhance security and compliance with State and National Laws and local gaming regulations. For example, it is important for the systems of the present invention to access and wager on races in multiple states, but wagers on races must be placed through in-State access ports, modules, exchanges, and other electronic or physical systems within the State to comply with local and State regulations. It would not be legal for a tipster to place the wager or for a walker in one State to actually place the wager in another state. This can be legally circumvented and all regulations and laws complied with according to a practice of the present invention. The walker or ticket promoter or tip provider promoting the automated wager and the automated wagering competition event has a portable telephone unit with direct line access or intermediate line access to the various state wagering pools, for example through a dedicated or available PBX (personal branch exchange). The system can be used to electronically place wagers on specific out-of-state race events by providing the player with direct usage, providing the player with a direct line to the out-of-state wagering site, or by providing a code or access number (internet, electronic or telephonic) so that the player places the wager. Electronic or internet or telephone access may be provided as part of the terminal itself or may be provided by the walker. For example, the player may communicate directly with the walker (the person providing the tip or automated wager suggestion or pick), even at a distal connection (which is the preferred embodiment), obtain the wagering information (the tip or automated wagering selection) and then be connected by the walker's system directly into the wagering outlet. In this way, the walker is a facilitator and does not actually place the wager. By placing the connection between the player and the wagering site through the walker's system, the wagers through that system can be tracked and the appropriate percentages from the pool paid to the walker's system.

An example of the operation of the system may be as follows. The player has registered with the walker system (a trade mark of “HOTWALKERS™” wagering system has been applied for. The player communicates directly with HOTWALKERS™ wagering system personnel, for example, a) by telephone, b) internet from home or public location, c) line connection from the wagering terminal, or other electronic or even direct verbal connection. The registered player obtains the desired wagering information and is then connected directly or indirectly to the wagering site to place a wager. By telephone, the call to the walker can be transferred through the PBX or other switching system (e.g., Ericsson Modular PBX; Nokia PBX; etc.) to an Interactive Voice Recognition system or Interactive Voice Responsive (IVR) system or Keypad Input Responsive system for placement of the wager. The HOTWALKER™ wagering system may have an interactive code so that all calls or connections made to the wagering site through the HOTWALKER™ wagering system are acknowledged, accounted for, registered, and identified for record-keeping purposes. The player may make the wager into the local wagering system. As the player is making the wager, this is a legal wager as long as the site from which the wager is being made is also a legal wagering jurisdiction.

Another set of systems can be used to assure or enforce compliance with jurisdictional wagering requirements. The phone calls can be identified by location of origin to the wagering site by either area codes (which would not work with cell phones that use their area code of registration from wherever the call is made, and so do not identify actual location of call origination) or by GPS tracking of the call (which will work with cell phones, as they can be tracked by Global Positioning Satellites). The telephone connection may have software that blocks specified area codes (where gaming or gambling is prohibited, such as Utah) or allows access to the wagering system from only area codes where gaming is allowed. Either confirmation of actual positioning may be required by GPS analysis, or when the call is identified as originating from a cell phone, GPS verification of location may be required.

An example of a direct transfer mechanism from the player to the HOTWALKER™ phone-in system to the wagering site could be as follows. The Player calls the HOTWALKER™ wagering system walker by telephone. An inquiry (with or without additional fee debiting) is made on a particular race and the information provided by the HOTWALKER™ wagering system personnel. The HOTWALKER™ wagering system personnel transfers the call (e.g., has a coded entry on the PBX or other call transferring system) directly to the wagering site, which preferably has an Interactive Voice Responsive capability or Interactive Keypad Responsive capability (that can be input through the telephone pad). The player, when connected to the wagering site then inputs the wager information to place the wager. The wager site identifies the location of the source of the wager by area code and/or GPS detection and fixing. The wager is then entered on the player's account in the HOTWALKER™ wagering system and/or the track site which accepts phone wagers, especially wagers identified by HOTWALKER™ wagering system coded entry or player account numbers and passwords. Player registration numbers on the HOTWALKER™ wagering system or in codes and passwords may require or desirably include area code identification numbers 9 e.g., the area codes themselves) to provide an initial verification of a legal site source for the wager, with the actual area code phone verification (e.g., as is available on caller ID systems or other incoming call tracking systems) and/or GPS verification used in addition to preliminary screening of the incoming wagering calls.

The HOTWALKER™ wagering system personal identification numbers and passwords may be used to enter the wagers. These can be preprogrammed into information packets (e.g., automatic dialing) in the telephone calling system or added manually. Wagers placed through this system should be tracked and an accounting system set up for assuring credit for the HOTWALKER™ wagering system adding to the pool.

Although specific examples have been provided because of underlying legal requirements in this disclosure, alternative and equivalent materials and configurations can be used in the practice of the underlying invention.

### Optional Variations on the Use of the Systems Described Herein

Comical fictitious icons or fantasy characters on gambling machines are not necessarily representative of specific real people. These made-up characters cannot promote a website or machine because these characters simply do not exist. However, celebrities do promote machines and are used for theming machines (as in video gaming apparatus). However, licensing from celebrities or well known comic characters costs a lot of money and live personalities have very busy schedules and lack of availability. Therefore, it would be ideal to have agents in large quantities to promote machines. One could post live machine promotional events on an event planning website where each agent would receive an I.D. and password in order to book themselves for events. For example, a manager would fill in event data fields on an event planning site and then upload the machine or website promo event. The marketing agent would then click the I'm available button to notify that he or she is available at such and such date to a live machine or website promotion. The event manager can then schedule the available agents for the promotion and also notify the photo server to I.P. broadcast photos of the theming agent to an I.P. address of the respective machine or website where the promotion is taking place on a specific day.

If the player would like to wager more than what is in his account, then the e-cash wallet or message will pop up in this type of instance. For example, if the player wants to wager $50 to win, but there is only $10 in his account (in this instance the player is $40 insufficient to make a wager) an e-cash message or wallet will appear.

Another type of instance where e-cash will appear is for tipping or sports information in electronic form, paper form or verbally given. In an electronic form instance a file will be sent to the player which can be displayed on screen or printed into paper format, however, before the sports information is sent electronically and e-cash message will appear ask if they would like to add money to their e-cash or electronic wallet.

In a verbal information exchange when a player is receiving sports information from a tipping or information agent, a recording will interrupt the telephone conversation and say in one example “you have one minute left to talk would you like to add money to your e-cash or electronic wallet, press #1 to add funds”.

If the player chose to press “1” in this instance funds will be added to his e-cash account or electronic wallet at that moment in time or through further interactive procedures through the telephone where more information may be needed in order to release funds to the e-cash account or electronic wallet.

1.26 Customers Can Top Up E-Cash Through Western Union, Bank Account or Credit Card or ACH or EFT or Wire Transfer.

When the credit balance is zero in the credit meter on the machine or the credit meter is zero on the internet site, a message will pop up saying would you like to add money to your e-cash account. If the player answers “yes,” the machine or internet will ask which form of payment you would like to use to up e-cash such as:

ACH—Automated Clearing House

1. Western Union
2. Credit Card
3. Money Order
4. Wire Transfer
5. Electronic Funds Transfer
   1.32 Internet Wagering Machines Associated With Tipping Agents

If a tipping agent or a person who is used for theming purposes on a wagering machine decides that he or she would like to be on a certain machine at a certain time, the tipping agent would log in a website and click-on which hours he or she would like to be on a machine. Once the agent is logged in the system will go to a photoserver or image server and extract images to be displayed at a certain I.P. address of that machine which is requesting the photos. If several agents are logged in at the same time then the agents photos will be in queue for “x” amount of time depending on the length of time each available agent is allowed on the machine. So for example if six agents are currently logged in and each theming agent appears from 10 minutes on the machine (since the machine is set to change theming agents every 10 minutes). It would take 50 minutes before the sixth agent in queue could have their images uploaded into the 3×5 wheel in one embodiment.

A machine or website according to the described technology can be re-themed every minute, hour, day or whatever time denomination is desired, preferably at or over five seconds. An administrative website can update itself if the profile of the agent profile changes and also updates the associated PBX of agent profile changes. The ability to schedule live theming for a machine or website by posting promotional events on an administrative website that schedules live attendees at the machine can be advantageous. The system may automatically schedule live theming agents through an administrative website when the agent clicks on the confirmation icon or button. The system may provide an administrative website that allows agents to search events where machine or website promotion is conducted, or a search engine that searches for machines or website promotional events.

In one embodiment by clicking on add work schedule and by also checking off or clicking on the available hours or hour you will like to be logged in or online as an agent to give sports info or race information.

By clicking on some or one or all hours, for whatever hours you choose as an agent this will activate the agent's phone (the phone could be a cell, work or home number or whatever telephone is nearest to you since the agent can update his or her profile by entering new telephone numbers which will be immediately identified by the PBX to re-route the next incoming call to the updated or current numbers entered by the agent.

Also, when a tipping agent logs in or is online ready to take live calls from players, a message will appear on a themed website of the respective agent, notifying the layer that he or she is ready to give tips on info on events.

A managerial or administrative website can send an electronic file to a machine or internet site notifying the player that he respective agent on the machine or internet is available by phone. The technology can also readily support an SMS text message to a player that is activated by a log-in mechanism, as with secure identification, password, voice recognition, photo-recognition, bio-recognition, biometrics and the like.

The system can be programmed and formatted to provide various ancillary or auxiliary functions with respect to the primary function of enabling wagering or enabling financial activity in the wagering environment. A search engine can be provided, particularly with respect to the She-Tips™ wagering system, the Hotwalker™ wagering system and any other system where live contacts (in person, by phone, by PDA, on-line, wired or wireless) are used to facilitate wagering, particularly pari-mutuel wagering in association with or integral to the present system. The search engine associated with the system may assist or alert the user in contacting specific individuals (especially particular tippers, such as the tipper originally signing on the user or any other tipper that the user may wish to contact or have notice of their on-line availability. For example, a search engine can be provided that can search for machine or website theming agents by city, state or country, as well as the individual tippers. The search engine may search for machine or website theming agents or tippers' availability to work by time availability, such as by the minute, hour, day, month, or year, and reservations for tippers services may be made in advance, with fixed costs or variable costs associated with such reserved use, even above normal tipper usage rates. If individual tipper names are not remembered, or if the user wishes to find a general type of tipper, the search engine may attempt to find agents according to hair color, wagering formulas, city, state or country, past performance records, and the like. The search engine may also be able to search for future machines or website, but only allow pre-qualified users to do so, whether by identification, security code, preferred status, comping status, or by any other preselected basis by the system.

The tipping agents should be required to login in a manner that can be ascertained by users. For example, whenever a specific agent or tipper logs in, their identifying name and features (e.g., pictures, code names, personal characteristics, etc.) are available on the search engine. It may also be desirable that when the agents/tippers login, the system will automatically send out a signal to users that this tipper/agent is now available. This service may be provided whether or not users pre-approve or enlist the service, or if they have any previous arrangement through the system with that particular tipper/agent. For example, when a user was originally signed into the system by a particular tipper/agent, logging in by that tipper/agent might send an availability alert to only those players signed in by the tipper/agent, and/or to only those players who have used that particular tipper/agent before, and/or those players who have requested notice for particular tipper/agent availability.

In order for a tipping agent to log in the PBX and take calls from customers or players, two things may be required to.

1. The agent must download his or her sports information sheet that day or before the live sports event actually takes place.

2. The agent must create a work schedule for themselves by clicking on or marking off the hours they wish to be on-line or available by phone.

Once these two procedures are completed the agent is logged in for that day and time period unless the agent decides to deactivate themselves by notifying the main hub or center by e-mail or phone in one embodiment. The system therefore should have the capability of enabling agents/tippers to log-in as an agent by downloading or printing a file which in turn notifies the PBX.

As noted earlier in the detailed description of the She-Tips™ wagering system, A team lead or manager can monitor what agents are logged in or on-line. A team lead (or leader) or manager also may have the ability to deactivate a user from being on a machine or taking routed phone calls. For example, if too many agents are logged into the system and this causes the phone system to be too busy, the team lead can schedule “S” agents to work the phones for “X” length of time. Another example of central control would be if there are six machines and 250 agents wanting their photos on a machine, the manager or team lead can in this example, schedule 60 agents, whereby each theming agent is on the machine for six minutes. (60 minutes in an hour×6 machines=360 operating minutes divided by 60=6 minutes per theming agent.) A processor therefore should be able to divide operating minutes by number of available agents to determine amount of time each agent is on a machine, and automatically assign the available times. The assignment may be randomly generated, or if there is an agent award or evaluation database, the times may be at least partially allotted on the basis of predetermined criteria, at least part of which is past performance based.

A team leader should also be able to send electronic messages or files to the themed agents website saying that the respective agents is at “Jersey Joes sports bar” promoting the machine or website. This message may appear in the form of a scrolling banner on the agents' website. The scrolling message can also say that the agent is available for “live tipping and sports info” by calling an assigned telephone or internet address, such as 1-877-Shetips, ext. 24 in one embodiment. The team leader does not have to initiate these types of messages, they (messages) can be done through SOAP (simple access object protocol) using XML in one embodiment whereby the

1. A method of providing a wagering structure enabling access to a financial structure to provide wagering funds comprising:
providing a user interface;
a user communicating through the user interface to a processing center;
the processing center communicating with both a financial structure and a wagering site, such that identification information of the wagering site and the financial structure are opaque to each other;
the financial structure assuring or providing funds to the processing center on behalf of the user; and
the processing center assuring or providing funds to the wagering site to place a wager for the user or establish a wagering account for the user;
wherein the wagering site has no information that assurance or funds for the wager for the user derived from the financial structure.

2. The method of claim 1 wherein the financial structure is selected from the group consisting of credit card companies, banks, savings and loans, credit unions, cash card companies, and debit card companies.

3. The method of claim 2 wherein the financial structure is selected from the group consisting of banks, savings and loans and credit unions.

4. The method of claim 1 wherein the user interface comprises a wagering terminal.

5. The method of claim 1 wherein the user interface comprises communication assisted by a third party to the processing center.

6. The method of claim 1 wherein the user interface further comprises a telephone or personal data system communication to a processing center that relays information electronically to a wagering hub.

7. The method of claim 1 communication is performed with an automated machine, signals communicated in the communication representing tracing signals depending on tracing key data substantially concealed by at least one trustee party apparatus; and convincing at least one party, while keeping the tracing key data secret from that party, that the tracing key data allows linking of payment data with data representing payer accounts; such that without the tracing key data of the at least one trustee party apparatus, it is not feasible to link payment transaction data with data representing payer accounts and that with the cooperation of the at least one trustee party apparatus using the tracing key data, at least under predetermined conditions, at least a predetermined linking is feasible.

8. The method of claim 7 wherein at least one party apparatus other than a trustee party apparatus is necessary to issue validated money.

9. The method of claim 7 wherein tracing participation of a predetermined number of trustee party apparatus is required.

10. The method of claim 7 wherein there is more than one tracing signal per payment.

11. The method of claim 7 at least one of said tracing signals is stored for at least a substantial time by at least one system apparatus.

12. The method of claim 7 comprising preventing at least one of said tracing signals from being forwarded from at least one system apparatus to a further system apparatus.

11. The method of claim 7 including deleting parts of a encrypted tracing signal so that search for the deleted parts is substantially needed to recover the tracing signal.

12. The method of claim 8 wherein the machine-implemented system allows the at least one trustee party apparatus to allow linking from a particular payer account to at least one particular payment transaction on a wager or to a wagering site.

13. The method of claim 1 performed in a machine-implemented blind signature system method, the method comprising:
forming at least part of one blinding signal from a restricted distribution that is dependent upon tracing information; and
convincing at least one party that at least the restricted distribution that is dependent upon tracing information substantially applies without revealing the at least part of the blinding signal to the at least one party.

14. The method of claim 13 wherein signal protocols are used for cooperation of a party apparatus obtaining a blind signature and the party apparatus issuing the blind signature that ensure a blinding value be taken from a limited range.

15. The method of claim 13 wherein the signal protocols achieve a blurred linking.

16. The method of claim 13 wherein said signal protocols allow linkability.

17. Apparatus supporting a payment system between a user interface, a financial structure and a wagering site, the improvement comprising: a system for providing a blind signature type of signal associated with electronic payment data; and a system for developing a blinding value in a reproducible computation using a seed key substantially known only to the user as an account holder party.

18. The apparatus of claim 18 comprising a communication system imparting a one-way property so that particular signal values can be given that allow computing forward blinding factors and the signal values given being such that it is substantially infeasible to use them to compute back to earlier factors.

19. A payment system apparatus that supports the method of claim 1, the apparatus comprising: a system that provides a blind signature signal associated with electronic payment data; a system that forms at least part of one blinding signature signal, instead of at random from a substantially uniform distribution, from a distribution that is subject to a predetermined restriction; and a system that convinces at least one party that at least the restriction substantially applies without revealing the at least part of the one blinding signal to the at least one party.

20. A payment system apparatus that supports the method of claim 1 comprising: a system that provides a blind signature signal associated with electronic payment data; and a system that develops a blinding value in a reproducible computation using a seed key substantially known only to an account holder party.

21. The apparatus of claim 20 comprising a system that imparts a one-way property so that particular signal values are given that allow computing further blinding factors, the signal values given being such that it is substantially infeasible to use them to compute earlier-used blinding factors.

22. A payment system method for providing funds to a wagering facilitator from a financial structure and providing funds from the financial structure to a wagering site through the wagering facilitator comprising:
providing a blind signature signal associated with electronic payment data;
forming at least part of one blinding signature signal, instead of at random from a substantially uniform distribution, from a distribution that is subject to a predetermined restriction; and
convincing at least one party that at least the restriction substantially applies without revealing the at least part of the one blinding signal to the at least one party.

23. A payment system method for providing funds to a wagering facilitator from a financial structure and providing funds from the financial structure to a wagering site through the wagering facilitator comprising:
providing a blind signature signal associated with electronic payment data; and developing a blinding value in a reproducible computation using a seed key substantially known only to an account holder party.

24. The method of claim 23 further comprising imparting a one-way property so that particular signal values are given that allow computing further blinding factors, the signal values given being such that it is substantially infeasible to use them to compute earlier-used blinding factors.

25. A method for transforming an input data object to an output data object, involving a sender, a mapper and a receiver, while hiding from the said receiver the correspondence between the said input data object and the said output data object, the method comprising the steps of:
providing funds to a wagering facilitator from a financial structure and providing funds from the financial structure to a wagering site through the wagering facilitator comprising the said sender sending a first message to the mapper, the said first message containing the input data object consisting of a first piece of data and a second piece of data and a third piece of data, the said second piece of data identifying the first piece of data and the said third piece of data identifying the said receiver;
the said mapper responding to the said first message by constructing the said output object consisting of a fourth piece of data and a fifth piece of data, the said fourth piece of data being constructed by applying a first transformation method to the said first piece of data so that the said fourth piece of data and the said first piece of data are substantially uncorrelated, and the said fifth piece of data identifying the said fourth piece of data and being constructed by applying a second transformation method to the said second piece of data so that the said fifth piece of data and the said second piece of data are substantially uncorrelated;
the said mapper sending the said output object in a second message to the receiver identified in the said third piece of data; and
the said receiver responding to the said second message by accepting it.

26. The method of claim 25, the mapper furthermore retaining the correspondence between the said input data object and the said output data object.

27. The method of claim 25 the sender furthermore constructing the said first piece of data by applying a third transformation method to a sixth piece of data so that the said first piece of data and the said sixth piece of data are substantially uncorrelated, the said first transformation method reversing the said third transformation method.

28. The method of claim 1 wherein when a wagering account of the user has insufficient funds to enable a requested wager by the user, a message is provided to the user of insufficient funds.

29. The method of claim 28 that upon input by the user to add money to the user's account, a transaction is effected between the processing center and the financial structure such that an ultimate wagering site is opaque to the financial structure.

30. The method of claim 28 that upon input by the user to add money to the user's account, a transaction is effected between the processing center and the financial structure such that no identifying information relating to a wagering site is transmitted to the financial structure.

31. The method of claim 28 wherein the signal comprises a video signal.

32. The method of claim 28 wherein the signal comprises an audio signal.

33. The method of claim 28 wherein upon providing the message, the processing center offers to initiate a transaction with the financial structure to increase the user's account balance.

34. A method of providing a wagering event through the method of claim 1 further comprising:
a player paying for at least one wager on a race event selected from the group consisting of a) a player selected wager and b) an automatically handicapped and selected wager,
the player also receiving on the race event c) an automatically handicapped and selected wager when a) is selected or d) a player selected wager when b) is selected, the combination of selections a) and c) and selections b) and d) forming a special event wager,
after results of the race event, the player having the potential to receive an award dependent upon predetermined criteria having been met in results of the race event with respect to the special event wager.

35. The method of claim 34 wherein the player pays for wager a) and receives selection c) without additional cost.

36. The method of claim 34 wherein the player pays for wager a) and receives selection c) with additional cost for wager c).

37. The method of claim 34 wherein the player pays for wager a) and receives selection c) with additional cost for wager c) but without additional cost for entering a special event wagering game.

38. The method of claim 34 wherein the player pays for wager b) and receives selection d) without additional cost.

39. The method of claim 34 wherein the player pays for wager b) and receives selection d) with additional cost for wager d).

40. The method of claim 34 wherein the award comprises a rebate or comp based on an amount paid by the player for a) or b).

41. The method of claim 34 wherein the predetermined criteria requires that at least c) or d) comprises a wager on a winning contestant(s) in the race event.

42. The method of claim 34 wherein the predetermined criteria requires that the player selected wager outperforms the automatically handicapped and selected wager at least by a contestant(s) in the player selected wager finishing in the money and ahead of the contestant(s) in the automatically handicapped and selected wager.

43. The method of claim 5 wherein the third party must log into a system and identify the third party to the system before being able to assist in communicating wagering information on the system.

44. The method of claim 43 wherein the system transmits information indicating when a specific third party has logged into the system.
